(19) United States
(12) Patent Application Publication
(10) Pub. No.: US 2005/0090383 A1
(43) Pub. Date: Apr. 28, 2005

(54) Metal complex compositions and their use as catalysts to produce polydienes

(76) Inventors: Sven K-H Thiele, Halle D-06110 (DE); Victor M Monroy, Charlotte, NC (US); Hartmut Stoye, Halle D-06110 (DE); David R Wilson, Midland, MI (US)

Correspondence Address: THE DOW CHEMICAL COMPANY;INTELLECTUAL PROPERTY SECTION, P. O. BOX 1967, MIDLAND, MI, 48641-1967, US

(21) Appl. No.: 10/489,370

(22) PCT Filed: Oct. 7, 2002
(86) PCT No.: PCT/US02/31989

(30) Foreign Application Priority Data
Oct. 12, 2001 (US) 60328935
Oct. 12, 2001 (US) 60328937
Aug. 21, 2002 (US) 60604866

(51) Int. Cl. C08F 4/02; B01J 31/00

(52) U.S. Cl. 502/152; 502/103; 526/108

(57) ABSTRACT

This invention relates to metal complex compositions, their preparation and their use as catalysts to produce polymers of conjugate dienes through polymerization of conjugated diene monomers. The used metal complex compositions are transition metal compounds in combination with an activator compound, optionally with a transition metal halide compound and optionally a catalyst modifier and optionally an inorganic or organic support material. The metal complexes comprises metals of group 3 to 10 of the Periodic System of the Elements in combination with activators, and optionally transition metal halide compounds of groups 3 to 10 of the Periodic Table of the Elements including lanthanide metals and actinide metals and optionally, catalyst modifiers, especially Lewis acids and optionally an inorganic or organic support material. More in particular the invention relates metal complex compositions, their preparation and their use as catalysts to produce homopolymers of conjugated dienes, preferably, but not limited to, through polymerization of 1,3-butadiene or isoprene.

This invention relates to metal complex compositions, their preparation and their use as catalysts to produce polymers of conjugated dienes through polymerization of conjugated diene monomers. The used metal complex compositions are transition metal compounds in combination with an activator compound, optionally with a transition metal halide compound and optionally a catalyst modifier and optionally an inorganic or organic support material. More in particular the invention relates metal complex compositions, their preparation and their use as catalysts to produce homopolymers of conjugated dienes, preferably, but not limited to, through polymerization of 1,3-butadiene or isoprene.

Metal complex catalysts for producing polymers from conjugated diene monomer(s) are known.

EP 816,386 describes olefin polymerization catalysts comprising transition metal compounds, preferably transition metals from groups IIIA, IVA, VA, VIA, VIIA or VIII or a lanthanide element, preferably titanium, zirconium or hafnium, with an alkadienyl ligand.

The catalyst further comprises an auxiliary alkylaluminoxane catalyst and can be used for polymerization and copolymerization of olefins.

Catalysts for the polymerization of 1,3-butadiene based on a lanthanide metal are described in the patent and open literature. More in particular, there are four main groups of lanthanide complexes which were investigated more intensively: lanthanide halides, cyclopentadienyl lanthanide complexes, π-allyl lanthanide compounds and lanthanide carboxylates. These metal complexes in combination with different activator compounds describe the state of the art, but are not an object of this invention.

Traditionally, lanthanide halides and carboxylates or alkoxides were used in combination with suitable activator components for polymerization reactions of conjugated dienes such as 1,3-butadiene and isoprene.

A) Lanthanide Halides

The combination of lanthanide trichloride, tribromides and triiodides with organic ligands containing nitrogen or oxygen donor atoms ([LnX₃L₃], Ln=lanthanide metal atom, X=chloride, bromide or iodide anion; L=organic ligand with an N or an O donor atom) in combination with different trialkylaluminum compounds such as triisobutylaluminum was used as a catalyst system for the polymerization of 1,3-butadiene, isoprene and piperylene at 25C (Murinov Y. I., Monakov Y. B, Inorganica Chimica Acta, 140 (1987) 25-27). Different lanthanide metal-containing lanthanide trichlorides were compared with respect to the polymerization activity and microstructure. For example, one neodymium based metal complex resulted in 94.6% cis polybutadiene and 95.0 cis-polyisoprene. It was observed that the polymerization solvent determined the polymerization activity and stereopecificity, while the catalytic activity of the lanthanide catalysts revealed strong dependence on the trialkylaluminum structure, the stereoregulating property remaining unchanged. Furthermore it was noticed that the kind of diene monomer used also strongly influenced the polydiene microstructure.

B) Lanthanide Carboxylates

A few examples using catalyst systems consisting of neodymium carboxylates and methylalumoxane (MAO) will be discussed in the following.

G. Ricci, S. Italia and C. Comitani (Polymer Communications, 32, (1991) 514-517) investigated MAO in combination with alkoxides, acetylacetonates or carboxylates of titanium, vanadium, cobalt or neodymium. It was concluded that catalysts derived from soluble transition metal compounds and MAO are, in general, more active than those obtained using simple aluminum alkyls (trialkylaluminum, dialkylaluminum chlorides and alkylaluminum dihalides) as co-catalysts. Furthermore, it was stated that the use of MAO instead of aluminum alkyls influenced the stereospecificity particularly for butadiene and isoprene. These monomers give predominantly cis polymers with MAO systems. Especially, the combination of neodymium carboxylate with aluminum alkyls e.g. triisopropylaluminum more in particulars of [Nd(OCOC₇H₁₅)₃] does not result in a substantial amount of polybutadiene at all.

The patent DE 19746266 A1 refers to a catalyst system consisting of a lanthanide compound, a cyclopentadiene and an alumoxane. The catalyst is characterized more particularly as a lanthanide alkoxide or carboxylate (e.g. neodymium versatate, neodymium octoate or neodymium naphthenate), a lanthanide complex compound with a diketone or a lanthanide halide complex containing oxygen or nitrogen donor molecules. The cyclopentadienyl compound was shown to have increased the 1,2-polybutadiene content. Therefore, one possibility to influence the polybutadiene microstructure was found using an additional diene (cyclopentadiene) component.

U.S. Pat. No. 5,914,377 resembles the aforementioned patent DE 19746266 A1 but the catalyst system includes an inert inorganic solid substrate indicating a supported catalyst system.

Though copolymerization reactions of dienes with other monomers are not an object of this invention, a few references will be mentioned to better describe the state of the art.

WO 00/04066; DE 10001025; DE 19922640 and WO 200069940 disclose a procedure for the copolymerization of conjugated diolefins with vinylaromatic compounds in the presence of a catalyst comprising one or more lanthanide compounds, preferably lanthanide carboxylates, at least one organoaluminum compound and optionally one or more cyclopentadienyl compounds. The copolymerization of 1,3-butadiene with styrene was performed in styrene, which served as solvent or in a non-polar solvent in the presence of styrene. There were no polymerization examples given using metal complexes other than lanthanide carboxylate.

Two references (Monakov, Yu. B., Marina, N. G., Savele'va, I. G., Zhiber, L. E., Kozlov, V. G., Rafikov, S. R., Dokl. Akad. Nauk. SSSR, 265, 1431, L., Ricci, G., Shubin, N., Macromol. Symp., 128, (1998), 53-61) stated that the Nd(OCOR)₃ based catalyst systems which are currently used on industrial scale as well as neodymium carboxylate halides and neodymium halides contain just about six to seven percent of catalytically active neodymium. This was attributed to two factors:
a) the reaction between trialkylaluminum and the insoluble neodymium compound is slow, because it only takes place at the surface of the neodymium compound and
b) the neodymium-carbon bond formed in the reaction of the neodymium precursor with an trialkylaluminum component is rather unstable at room temperature and decomposes to give inactive species.
c) Lanthanide complexes comprising aromatic η⁵-bond ring systems attached to the lanthanide metal such as cyclopentadienyl or substituted cyclopentadienyl or indenyl or fluorenyl lanthanide complexes).

Butadiene and isoprene were polymerized by means of bis(cyclopentadienyl)-, bis(indenyl)-or bis(fluorenyl)samarium- or neodymium chlorides or -phenylates (Cui, L., Ba, X., Teng, H., Laiquiang, Y., Kechang, L., Jin, Y., Polymer Bulletin, 1998, 40, 729-734). While all of the metal complexes mentioned in the publication polymerized isoprene, just three of them, (C₅H₉Cp)₂NdCl, (C₅H₉Cp)₂SmCl and (CH₃ Cp)₂SmO-2,6-(t-Bu)-4-(CH₃)—C₆H₂ proved to be suitable for butadiene polymerization. All of the polymerizations were carried out under use of lanthanide complex/trimethylaluminum or methylalumoxane. The highest (but still quite low) butadiene polymerization activities were found when the reactions were carried out in the presence of MAO. For example, (C₅H₉Cp)₂NdCl and MAO (Al/Nd=1000) led to an activity of 6.0·10⁻³ kg [polybutadiene] mmol⁻¹ [Nd] h⁻¹, while the combination of the neodymium complex with Me₃Al had an activity of 4.0·10⁻³ kg [polybutadiene] mmol⁻¹ [Nd] h⁻¹ (Al/Nd=100). The polybutadiene made with the help of (C₅H₉Cp)₂NdCl and MAO consisted of 72.9% cis-1,4-, 22.9% trans-1,4- and 5.1% 1,2-polybutadiene. The molecular weight amounted to 18,100.

High 1,4-cis-selectivity and a well-controlled polymerization behavior in terms of living butadiene polymerization together with high activity have been accomplished with catalyst systems based on samarocene complexes and methylalumoxane or AlR₃/[Ph₃C][B(C₆F₅)₄] combinations as co-catalyst (Kaita, S., Hou, Z., Wakatsuki, Y., Macromolecules, 1999, 32, 9078-9079). For example, a dimeric π-allylsamarium(III) complex [(C₅Me₅)₂Sm(μ-η³-CH₂CHCHCH₃)]₂, was activated for polymerization by modified methylalumoxane as co-catalyst. 98.8% cis-1,4-polybutadiene was obtained when the aforementioned catalyst system was used in toluene solution at 50° C. (catalyst activity: 1.08 kg [polybutadiene] mmol⁻¹ [Sm] h⁻¹, measured after ten minutes polymerization time). The molecular weight was as high as 730,900 (M_{w}). In place of MAO, the Al(i-Bu)₃/[Ph₃C][B(C₆F₅)₄] combination gave 95% 1,4-cis polybutadiene (M^{w}=352,500). The kind of alkylaluminum compound in the system Al(R)₃/[Ph₃C][B(C₆F₅)₄] had an evident influence on the polymer microstructure and molecular weight.

It has to be pointed out that monomeric monocyclopentadienyl lanthanide complexes are very often unstable (dissertation Kretschmer, W., Martin-Luther-Universitat Halle-Wittenberg, Halle(Saale), 1994) and thus are less suitable for butadiene polymerization experiments. Dicyclopentadienyl lanthanide complexes with the sole exception of the aforementioned samarocene complexes (Kaita, S., Hou, Z., Wakatsuki, Y., Macromolecules, 1999, 32, 9078-9079 see above) give low polymerization activities in comparison with the technically applied neodymium carboxylate systems.

d) π-allyllanthanide Complexes

The tetra(allyl)lanthanate(III) complex [Li(μ-C₄H₈O₂)_{3/2}][La(η³-C₃H₅)₄]4 prepared from lanthanum trichloride, tetraallyltin and n-butyllithium, was characterized by x-ray analysis and applied to butadiene polymerization (Taube, R., Windisch, H., J. Organomet. Chem., 1993, 445, 85-91). The tetraallyllanthanate catalyst polymerizes butadiene to yield predominantly trans-1,4-polybutadiene (82%) besides 10% 1,2- and 7% cis-1,4-polybutadiene. The polymerization activity was rather low (A=5.3*10⁻⁶ kg [polybutadiene] mmol⁻¹ [lanthanide] h⁻¹). The extraordinarily high trans-selectivity for a lanthanide catalyst and low polymerization activity was presumed to result from dissociation of the tetraallyl complex into allyllithium and tri(allyl)lanthanum (Taube, R., Windisch, H., Maiwald, S., Macromol. Symp., 1995, 89, 393-409), the real polymerization catalyst.

The lithium tetra-η³-allylneodymate complex Li[Nd(η³-C₃H₅)₄]·1.5 C₄H₈O₂ as well as lithium triallyl(cyclopentadienyl)neodymate Li[C₅H₅Nd(η³-C₃H₅)₃]·2 dioxane and lithium triallyl(pentamethylcyclopentadienyl)neodymate Li[C₅Me₅Nd(η³-C₃H₅)₃]·3 DME (dimethylglycol ether) were investigated in butadiene polymerization reactions (Taube, R., Maiwald, S., Sieler, J., J. Organometallics Chem., 1996, 513, 37-47). Only the tetra-η³-allyineodymate complex polymerized butadiene without additional activator (A=0.021 kg [BR] mmol⁻¹ [Nd] h⁻¹) and showed increased (but still low) polymerization activity when Lewis acids, as for example triethyl boron, were added (A=0.083 kg [polybutadiene] mmol⁻¹ [Nd] h⁻¹). The cyclopentadienyl-substituted neodymium complexes mentioned above were almost catalytically inactive towards butadiene. The author explained the modest polymerization activity of the lithium tetra-η³-allyineodymate complex with a dissociation to form allyllithium and tri-η³-allyl-neodymium (Nd(η³-C₃H₅)₃), the latter of which was assumed to be the real polymerization catalyst (Taube, R., Maiwald, S., Sieler, J., J. Organometallics Chem., 1996, 513, 37-47). However, in the same article, the allyllithium dioxane adduct (LiC₃H₅·dioxane) yielded the highest polymerization activity of 0.18 kg [polybutadiene] mmol⁻¹ [catalyst] h⁻¹ indicating an anionic polymerization typical for alkyllithium compounds, at least in this case.

Other monocyclopentadienyl triallyllanthanate (III) complexes of the general formula [Li(C₄H₈O₂)_{3/2}][η³-Cp′La(η³-C₃H₅)₃], (Cp′=C₅H₅, C₅Me₅, C₉H₇, C₁₃H₉) were prepared from [Li(C₄H₈O₂)_{3/2}][La(η³-C₃H₅)₄] and cyclopentadiene and used for butadiene polymerization (Taube, R., Windisch, H., J. Organometallics Chem., 1994, 511, 71-77). However, the polymerization activity was very low and just small amounts of predominantly trans-polybutadiene were formed.

Tetraallyllanthanide(III) complexes of the type [Li(μ-C₄H₈O₂)_{3/2}][Ln(η³-C₃H₅)₄] were used in combination with triethylborane used for the preparation of triallyllanthanide compounds such as the dimeric [{La(η³-C₃H₅)₃(η¹-C₄H₈O₂)}₂(μ-C₄H₈O₂)] and the polymeric [{Nd(η³-C₃H₅)₃}(μ-C₄H₈O₂)]ₙ (Taube, R., Windisch, H., Maiwald, S., Hemling, H., Schumann, H., J. Organomet. Chem., 1996, 513, 49-61). When these compounds were heated at 50° C. for two hours, the dioxane-free lanthanum or neodymium complexes were formed. Triallylneodymium polymerized butadiene without a Lewis acid and gave predominantly trans-1,4-polybutadiene (94%; A=0.011 kg [polybutadiene] mmol⁻¹ [Nd] h⁻¹). When an equimolar amount of EtAlCl₂ or Et₂AlCl was added, the stereoselectivity turns to favor cis-1,4-polybutadiene (90%) and the activity increased (A=0.148 kg [polybutadiene] mmol⁻¹ {[Nd] h⁻¹). When 30 equivalents of methylalumoxane were added to the toluene solution of the neodymium complex at 50° C., the activity increased by three- or four-fold. In addition, if the solvent was changed from toluene to hexane, which does not coordinate to the metal center, the polymerization activity reached 0.93 kg [polybutadiene] mmol⁻¹ [Nd] h⁻¹ at room temperature. The addition of Et₂AlCl and EtAlCl₂ or MAO presumably effects the formation of 1,4-cis-polybutadiene (maximum 94% cis-polybutadiene).

Allylneodymium complexes have been substituted at the C1 and C2 positions of the allyl substituent as described in EP 0919573 A1 (Chem. Abstr. 1999, 313, 5700). All these allyl complexes showed similar polymerization activities. For example, bis(neopentyl-methallyl)neodymium chloride polymerized butadiene in the presence of MAO with an activity of 1620 kg [polybutadiene] mmol⁻¹ [Nd] h⁻¹ to give 96.1% cis-1,4-polybutadiene (M_{w}=463,000, M_{w}/Mₙ=1.7). The polymerization activity of the unsubstituted diallylneodymium chloride/methylalumoxane combination was of the same order (A=1680 kg [polybutadiene] mmol⁻¹ [Nd] h⁻¹), but led to a higher molecular weight (M_{w}=922,000, M_{w}/Mₙ=1.8). However, just a small amount (2.8 g) of polybutadiene was recovered as result of this polymerization experiment.

One allylneodymium complex, Nd(allyl)₂Cl*2 MgCl₂*4 THF, prepared from allylmagnesium chloride and neodymium trichloride, was combined with methylalumoxane (MAO) or tetraisobutylalumoxane (TIBAO) or trialkylaluminum compounds (L., Ricci, G., Shubin, N., Macromol. Symp., 128, (1998), 53-61). The resulting catalyst system was applied to butadiene and isoprene polymerization reactions and compared with the neodymium carboxylate/methylalumoxane or trialkylaluminum catalyst system. Generally, the catalyst activities of neodymium carboxylate, Nd(OCOR)₃, based catalyst systems were lower than the one of the allylneodymium complex catalyst system, Nd(allyl)₂Cl*2 MgCl₂*4 THF/aluminum based activator. Catalyst systems based on neodymium carboxylate, Nd(OCOR)₃, contained just about six to seven percent of catalytically active neodymium. This was attributed to two factors which already have been explained above. In addition, it was found that Nd(allyl)₂Cl*2 MgCl₂*4 THF in combination with MAO gave higher polymerization activities than those obtained with triisobutylaluminum and proved to be 30 times more active than the commercial catalyst system Nd(OCOC₇H₁₅)₃/(i-C₄H₉)₃Al/(C₂H₅)₂AlCl. The best polymerization activity using Nd(allyl)₂Cl*2MgCl₂*4 THF in combination with MAO gave 8.1 kg polybutadiene/mmol [neodymium] hr. There are no indications regarding polymer microstructure or average molecular weight in this reference.

Lanthanum(η³-allyl) halide complexes of the type La(η³-C₃H₅)₂X*2 THF (X=Cl, Br, I) can be activated with methylalumoxane (MAO) to yield butadiene polymerization catalysts for the 1,4-cis-polymerization of butadiene with increasing activity and cis selectivity in the following order: La(η³-C₃H₅)₂Cl*2 THF<La(η³-C₃H₅)₂Br*2 THF<La(η³-C₃H₅)₂I*2 THF (Taube, R., Windisch, H., Hemling, H., Schuhmann, H., J. Organomet. Chem., 555 (1998) 201-210). For example, the combination of La(η³-C₃H₅)₂I*2 THF and MAO produces mainly cis-1,4-polybutadiene (95% cis-polybutadiene) with an activity of 0.81 kg [polybutadiene]/mmol [Nd] hr. It should be pointed out that the catalyst solution, which is the result of the combination of the lanthanum allyl halide complex and methylalumoxane, has to be stored at temperatures as low as −25° C.

Triallylneodymium dioxane adduct [Nd(η³-C₃H₅)₃*C₄H₈O₂)] combined with methylalumoxane or hexaisobutylalumoxane (HIBAO) gave a catalyst system used for butadiene polymerization reactions (Maiwald, S., Weissenborn, H., Windisch, H., Sommer, C., Müller, G., Taube, R., Macromol. Chem. Phys., 198, (1997) 3305-3315). The catalyst activities of the malority of the described polymerization reactions (toluene, 50° C.) were between 5.5-8.1 kg [polybutadiene]/mmol[Nd] hr. The content of 1,4-polybutadiene ranged from 31% to 84% and the average molecular weight (Mw) from 72,000 to 630,000. It has to be noted that the two components [Nd(η³-C₃H₅)₃*C₄H₈O₂)] and MAO had to be shaken for 12 to 16 hrs at a temperature ranging from −25° to −35° C. to form an efficient polymerization catalyst. This information demonstrates again the thermolability of allyllanthanide based catalyst systems and also indicates the need for an aging time to obtain an efficient catalyst.

In Patent EP 878489 A1 (Chem. Abstr. 125, (1996) 331273a), allyl lanthanide complexes of the formula [(C₃R¹₅)ᵣM¹(X)₂₋ᵣ(D)ₙ]⁺[M²(X)ₚ(C₆H_{5-q}R²_{q})₄₋ₚ]⁻(M¹=element number 21, 39,57 to 71; M²=element of group IIIb of the periodic table of the elements; D=donor ligand; X=anion) are used alone or in combination with one or more of the following components: scavenger compound of the formula M³R³_{z} (M³=metal of group IIa or IIIb), solid inorganic or organic particle for the polymerization of conjugated dienes in the gas phase. Alternatively, the allyl lanthanide compound (C₃R¹₅)ₛM¹(X)₃₋ₛ(D)ₙ can be combined with M²(X)ₘ(C₆H_{5-q}R²_{q})₃₋ₘ or [(D)ₙH][M²(X)ᵣ(C₆H_{5-q}R³_{q})₄₋ᵣ] (M², X, D as defined before, m is a number between 0 and 2, s is a number between 1 and 3) and used for the polymerization of conjugated dienes in the gas phase.

Other examples using supported metal complexes will be mentioned to better describe the state of the art.

In DE 19512116 A1 and WO 96/31544, allyl lanthanide compounds of the general formula (C₃R₅)ₙMX₃₋ₙ and an aluminum organic compound are supported on an inert inorganic solid (specific surface area greater than 10 m²/g, pore volume 0.3 to 15 mL/g). However, only silica-supported metal complexes were demonstrated as catalysts for the polymerization of conjugated dienes. In addition, nothing is stated about the molecular weight of the polydiene with the exception of the Mooney viscosity.

Various methods for the preparation of silica-supported 1,3-butadiene polymerization catalysts comprising allylneodymium complexes and methylalumoxane activators were discussed in the open literature by J. Giesemann et al. (Kautsch. Gummi Kunstst., 52 (1999) 420-428). This article described the optimization of the polymerization activity and of the cis-polybutadiene content. The molecular weight of the recovered polybutadiene was not determined and the investigation was limited to silica as support material.

Supported allyl complexes of the rare earth metals of the type (C₃R₅)ₙMX₃₋ₙ (X=halide, —NR₂, —OR, —O₂CR) have been claimed for gas phase diene polymerization in patent DE 19512116 A1. For example, the trisallyineodymium dioxane complex {(C₃H₅)₃M·1.5 dioxane} on methylalumoxane-pretreated silica produced 96.5% cis-polybutadiene with a low activity of 0.0335 kg [polybutadiene) g⁻¹ [catalyst] h⁻¹ bar⁻¹. The polymerization was performed at 80° C. and at a pressure of 475 mbar. The Mooney viscosity amounted to ML_{1+4′}(100° C.)=147 ME.

Patent DE 19512116 A1 claims a catalyst system consisting of an allyl compound of the lanthanides, an organoaluminum compound and an inert solid inorganic material for polymerization of conjugated dienes in the gas phase. The formula of the allyl compound of the lanthanides is (C₃R₅)ₙMX₃₋ₙ (X=Cl, Br, I, NR₂, OR, RCO₂, C₅HₘR₅₋ₘ, C₅Hₘ(SiR₃)₅₋ₘ, C₁-C₆-alkyl, trityl, C₁₂H₁₂, RS, N(Si(CH₃)₃)₂; M=lanthanide metal).

Reference WO 96/31543 claims catalyst combinations consisting of an lanthanide metal complex, an alumoxane and an inert inorganic solid (specific surface bigger than 10 m²/g, pore volume 0.3 to 15 ml/g). The lanthanide metal complex is defined as alcoholate, as carboxylate or as a complex compound of lanthanide metals with diketons. Also in this patent exclusively silica supported metal complexes were demonstrated as catalyst for the polymerization of conjugated dienes. With the exception of the Mooney viscosity nothing is stated about the molecular weight of the polydiene.

Reference U.S. Pat. No. 5,914,377 resembles aforementioned WO 96/31543 but the catalyst composition includes an additional Lewis acid.

In U.S. Pat. No. 6,001,478 a polymer consisting of polybutadiene, polyisoprene or a copolymer of butadiene and isoprene is claimed which contains an inert particulate material, which preferably is carbon black, silica or mixtures thereof. As catalyst for the preparation of the polymers cobalt, nickel or rare earth metal carboxylates or halides, especially neodymium carboxylates, halides, acetylacetonates or alkoholates or allylneodymium halides or mixtures of these metal complexes were used in combination with methylalumoxane, modified methylalumoxane, dialkylaluminum halides, trialkylalumium compounds or boron trifluoride and inert materials such as carbon black and silica. Also titanium halides and alkoxides are mentioned in the patent as possible precatalysts. It has to be noted, that the inert particulate material is not mentioned in the patent to function as support material for the catalyst.

Patent US95/14192 describes the process of preparation of supported polymerization catalysts using support materials, alumoxanes and transition metals. Typically, the preparation method of silica/methylalumoxane carriers and the methylalumoxane content was changed to optimize the resulting catalyst for olefin polymerization and copolymerization reactions. Group 4 metal complexes are preferably used in combination with alumoxane treated support materials.

Reference DE 1301491 describes catalysts for the polymerizaton of 1,3-dienes consisting of transition metal chelat complexes derived from 1,3-thiocarbonyl compounds, which were precipitated on support materials. The metal complexes contain cobalt, rhodium, cerium, titanium, ruthenium and copper metals.

Patent WO 97/32908 refers to a organosilicon dendrimer supported olefin polymerization catalyst based on a group 4 metal (titanium, zirconium or hafnium). The activation of the catalyst occurs with an alumoxane or organoborate activator. Next to other α-olefins 1,3-butadiene and isoprene belong to the preferred monomers.

DE 19835785 A1 refers to RₙCpTiCl₃ complexes which were used in combination with activator compounds such as alumoxanes and organic or inorganic carrier materials to form catalysts for diene polymerization. However, there is no example given in this patent using an organic or inorganic carrier material containing catalyst.

WO 98/36004 claims RₙMXₘ complexes (M metal of group 4 of the periodic table of the elements) in combination with cocatalysts preferably methylalumoxane and inorganic or organic carrier materials as catalyst for the polymerization of dienes. The metal complex preferably is referred to cyclopentadienyltitanium fluorides.

Reference U.S. Pat. No. 5,879,805 represents a butadiene polymerization catalyst system consisting of a cobalt compound, a phosphine or xanthogene or thioisocyanide compound and an organoaluminum compound such as methylalumoxane. Inert particulate material is employed in the polymerization. The inert particulate material is not mentioned in the patent to function a support material for the catalyst.

Though copolymerization reactions of dienes with other monomers are not an object of this invention, a few references will be mentioned to better describe the state of the art.

Alkenyl complexes of lanthanide metals in combination with organo aluminum compounds such as aluminoxanes, organoborates or organoboron compounds were claimed in patent DE 19926283 A1 as catalysts for the polymerization of conjugated dienes in a vinyl aromatic compound containing polymerization solvent. The two examples demonstrated the polymerization of 1,3-butadiene in styrene or in styrene containing toluene using a catalyst system consisting of tris(allyl)neodymium dioxane adduct and methylalumoxane. In both cases the polymerization reaction led to butadiene-styrene copolymers. Therefore, this patent deals with copolymerization reactions. However copolymerization reactions are not an object of this invention.

Though trisallyl lanthanide complexes, more particularly triallyl neodymium complexes, give high polymerization activities and also different polybutadiene microstructures or molecular weights under different conditions (chosen catalyst precursor and activator used), there is an important disadvantage of this class of metal complexes. Taube et al. (Taube, R., Windisch, H., Maiwald, S., Hemling, H., Schumann, H., J. Organomet. Chem., 1996, 513, 49-61) stated that triallyl compounds are extremely oxygen and moisture sensitive. In addition, neutral and dry triallyl lanthanide complexes can not be stored at room temperature or elevated temperatures. It is mentioned in the same article that triallyl neodymium and triallyl lanthanum have to be stored at low temperature such as −30° C. (Maiwald, S., Weissenborn, H., Windisch, H., Sommer, C., Müller, G., Taube, R., Macromol. Chem. Phys., 198, (1997) 3305-3315). In addition, triallyl neodymium compounds require an aging step. This aging step has to be performed at low temperatures such as −20 to −30° C.

e) Neodymiumamide Complexes

U.S. Pat. No. 6,197,713 B1 claims lanthanide compounds in combination with Lewis acids, the Lewis acid being selected from the group consisting of halide compounds such as BBr₃, SnCl₄, ZnCl₂, MgCl₂, *n Et₂O or selected from the group of organometallic halide compounds whose metal is of group 1, 12, 13 and 14 of the Periodic System of the elements and a halide of an element of group 1, 12, 13, 14 and 15 of the Periodic System. The lanthanide compounds are represented by the following structures: Ln(R¹CO₂)₃, Ln(OR¹)₃, Ln(NR¹R²)₃, Ln(PR¹R²)₃, Ln(−OPO(OR)₂)₃, Ln(—OSO₂(R))₃ and Ln(SR¹)₃ wherein R, R¹ and R² are selected from alkyl, cycloalkyl and aryl hydrocarbon substituents having 1 to 20 carbon atoms. Though there are metal compounds claimed in this patent comprising a lanthanide—nitrogen or lanthanide—phosphorous bond, none of these metal complexes was used in any of the given examples. Neodymium phosphate, neodymium acetate or neodymium oxide represented the lanthanide source in the examples of patent U.S. Pat. No. 6,197,713 B1. The disadvantage of catalyst systems containing metal carboxylates was already discussed above. Though it is not mentioned in the claims of the patent, the catalyst systems described before were applied to the polymerization of 1,3-butadiene. It must be pointed out that the catalyst systems mentioned in patent U.S. Pat. No. 6,197,713 B1 do not include the activator compounds according to this invention and, in addition, that the examples for the lanthanide component used as the catalyst component in patent U.S. Pat. No. 6,197,713 B1 differ from this invention.

The neodymium amide complex, Nd{N(SiMe₃)₂}₃, which has been applied to the polymerization of 1,3-butadiene by Boisson et al. (Boisson, C., Barbotin, F., Spitz, R., Macromol. Chem. Phys., 1999, 200, 1163-1166). The neodymium complex Nd{N(SiMe₃)₂)₃ was prepared from neodymium trichloride and lithium bis(trimethylsilyl)amide (LiN(SiMe₃)₂)(see D. C. Bradley, J. S. Ghotra, F. A. Hart, J. Chem. Soc., Dalton Trans. 1021 (1973). The ternary system neodymium tris(bis(trimethylsilyl)amide]/triisobutylaluminum {(i-Bu)₃Al}/diethylaluminum chloride polymerized butadiene at 70° C. in toluene or heptane as solvent. The microstructure of the polybutadiene obtained was found to be highly cis-1,4. Both stereochemistry and the catalyst activity strongly depend on the (Et)₂AlCl/Nd{N(SiMe₃)₂}₃ ratio (optimal ratio is about 2). The best polymerization activity listed in the reference amounted to 1.35 kg [polybutadiene] mmol⁻¹ [Nd] h⁻¹ and the resulting polybutadiene contained 97.6% cis units (trans 1.6%)! The GPC curves show a bimodal distribution, which indicates the presence of two different catalytically active centers during the polymerization process (M_{w}/Mₙ=4). This example demonstrates that simple tricoordinated neodymium compounds without any aromatic ligands can lead to good polymerization results and stereoselectivities.

However, there was no effort made to use different activator compounds or activator compound mixtures to purposely change (tune) the polymer microstructure and molecular weight. In addition, because of the sensitivity of the (Et)₂AlCl/Nd{N(SiMe₃)₂}₃ ratio the aforementioned catalyst system does not appear to be very attractive for commercial use. Furthermore, there is no mention regarding the average molecular weight of the polymer or the molecular weight distribution. The polymer conversions are between 19.8 and 60.8% in the best case and thus are in need of improvement. In addition, the polymerization activity of the above mentioned catalyst system towards conjugated dienes such as butadiene has to be improved in order to be useful in industrial applications.

WO 98/45039 presents methods for making a series of amine-containing organic compounds which are used as ligands for complexes of metals of groups 3 to 10 of the periodic system of the elements and the lanthanide metals. Several general structures of metal complexes are claimed in combination with a second component (co-catalyst). In addition, some general structures of amines and also a few specific examples are taught in the patent, which may be used as ligands for metal complexes. It is mentioned in the patent, that the metal complexes, when combined with a co-catalyst, are catalysts for the polymerization of olefins.

It has to be pointed out that aside from a few zirconium and titanium complexes such as [bis(2,6-dimethylphenylamino)diphenylsilane]zirconium dichloride tetrahydrofuran, bis[bis(2,6-dimethylphenylamino)diphenylsilane]titanium, [bis(2,6-dimethylphenylamino)diphenylsilane]titanium dichloride and bis(decafluorodiphenylamido)bis(benzyl)zirconium no specific metal complexes were claimed in this patent. In addition, the second component was not defined at all and there were no definitions of suitable monomers, the resulting polymer, the catalyst preparation or the polymerization process in patent WO 98/45039.

It should be pointed out that the knowledge of the molecular weight and molecular weight distribution of the polymer as well as the microstructure of the polydiene part, for example the cis-1,4-, trans-1,4- and 1,2-polybutadiene ratio in case of polybutadiene, is crucial for the preparation of polymers with desired properties. Though a few of the patents mentioned above describe some characteristics of the polydiene obtained, little effort was made to change the polymer microstructure and the molecular weight purposely to obtain polymers with different properties.

It would be valuable to recognize that metal complex (precatalyst)/co-catalyst mixtures have a dominant effect on the polymer structure. The microstructure of the polydienes and the molecular weight could be tuned by selecting suitable precatalysts and co-catalysts and by choice of method for the preparation of the catalyst. The patents mentioned before also do not indicate if and in which extend the polymer properties can be altered by exchanging the carrier material or by changing the preparation of the supported catalyst. Therefore, it is important to know about the properties of polymers made with catalysts based on different carrier materials. It would be valuable to recognize, that carrier materials have a similar dominant effect on the polymer structure than activators and the chosen metal complexes. The microstructure of the polydienes could be tuned by selecting and suitable treating of the support material. In addition, there is a need for catalyst precursors and catalysts which are stable in a dry state and in solution at room temperature and at higher temperatures so that these compounds may be more easily handled and stored. In addition, it would be desirable to have catalyst components that could be directly injected into the polymerization reactor without the need to “age” (stir, shake or store) the catalyst or catalyst components for a longer period of time. Especially for a solution polymerization process, liquid or dissolved catalyst or catalyst components are more suitable for a proper dosing into the polymerization vessel. Furthermore, it is highly desirably to have a highly active polymerization catalyst for conjugated dienes which is stable and efficient in a broad temperature range for a longer period without deactivation. It also would be beneficial if the molecular weight of the polydiene could be regulated.

Polydiene homopolymers produced in a process for the polymerization of only one type of conjugated diene monomer under use of metal complexes comprising metals of group 3 to 10 of the Periodic System of the Elements in combination with activators, and optionally transition metal halide compounds of groups 3 to 10 of the Periodic Table of the Elements including lanthanide metals and actinide metals and optionally, catalyst modifiers, especially Lewis acids and optionally an inorganic or organic support material as well as said process of polymerization are objects of the invention. More particularly, the metal complexes or supported metal complexes used for the synthesis of homopolymers are based on lanthanide metal, scandium, yttrium, vanadium, chromium, cobalt or nickel metal and the support material is an inorganic or organic material. Even more particularly, diene monomers such as, but not limited to, 1,3-butadiene and isoprene are homopolymerized using metal complexes comprising lanthanide metals in combination with activators and optionally transition metal halide compounds containing metals of group 3 to 10 of the Periodic Table of the Elements including lanthanide metals and optionally, one or more Lewis acid(s) or using metal complexes comprising lanthanide metals in combination with activators, a support material and optionally transition metal halide compounds containing metals of group 3 to 10 of the Periodic Table of the Elements including lanthanide metals and optionally, one or more Lewis acid(s). Even more particularly, the metal complexes or supported metal complexes used for the synthesis of homopolymers are based on neodymium and the support material for example may be, but is not limited to silica, charcoal (activated carbon), clay or expanded clay material, graphite or expanded graphite, layered silicates or alumina.

An object of this invention is a process for the preparation of metal complexes which are useful in forming catalyst compositions for the polymerization of olefinic monomers, especially diene monomers, more especially conjugated diene monomers.

Objects of this invention are supported metal complex catalyst compositions which are useful in the polymerization of olefinic monomers, especially diene monomers, more especially conjugated diene monomers, and a process for the preparation of the same.

Objects of this invention are combinations of two or more metal complex/activator component/support material containing catalyst systems which are useful in the polymerization of olefinic monomers, especially diene monomers, more especially conjugated diene monomers.

Further objects of the invention are metal complexes which are useful in forming catalyst compositions for the polymerization of olefinic monomers, especially diene monomers, more especially conjugated diene monomers.

Yet a further object of the invention is a process for the preparation of catalyst compositions which are useful in the polymerization of olefinic monomers, especially diene monomers, more especially conjugated diene monomers.

Even further objects of the invention are catalyst compositions for the polymerization of olefinic monomers, especially diene monomers, more especially conjugated diene monomers.

A further object of the invention is a process for the polymerization of olefinic monomers, especially diene monomers, more especially conjugaged diene monomers which uses said catalyst or supported catalyst compositions.

A further object of the invention are polymers, especially polydienes, more especially polymers of conjugated dienes produced using said catalyst or supported catalyst compositions.

Monomers containing conjugated unsaturated carbon-carbon bonds, especially one type of conjugated diene monomers are polymerized giving polydienes using a catalyst composition comprising a) a metal complex containing a metal of groups 3-10 of the Periodic System of the Elements, the lanthanides or actinides, b) an activator compound for the metal complex and c) optionally, a transition metal halide compound, d) optionally, a catalyst modifier, preferably a Lewis acid and e) optionally, an inorganic or organic support material. Further objects of the invention are combinations of two or more catalyst compositions chosen from metal complex/activator component-containing catalyst compositions, metal complex/activator component/Lewis acid-containing catalyst compositions, metal complex/activator/transition metal halide compound component-containing catalyst compositions, and metal complex/activator component/transition metal halide compound/Lewis acid-containing catalyst compositions.

Preferably, the metal complex contains one of the following metal atoms:
a lanthanide metal, scandium, yttrium, vanadium, chromium, cobalt or nickel, even more preferably a lanthanide metal. Even more preferably the metal complexes used for the synthesis of homopolymers are based on neodymium.

Metal complexes containing metal-carbon, metal-nitrogen, metal-phosphorus, metal-oxygen, metal-sulfur or metal-halide belong to the type of complexes of the invention. Preferably, the metal complex does not contain allyl, benzyl or carboxylate ligands such as octoate or versatate ligands.

The metal complex according to the invention has one of the following formulas
MR′ₐ[N(R¹R²)]_{b}[P(R³R⁴)]_{c}(OR⁵)_{d}(SR⁶)ₑX_{f}[(R⁷N)₂Z]_{g}[(R⁸P)₂Z₁]ₕ[(R⁹N)Z₂(PR¹⁰)]ₗ[ER″ₚ]_{q}[(R¹³N)Z₂(NR¹⁴R¹⁵)]ᵣ[(R¹⁶P)Z₂(PR¹⁷R¹⁸)]ₛ[(R¹⁹N)Z₂(PR²⁰R²¹)]ₜ[(R²²P)Z₂(NR²³R²⁴)]ᵤ[(NR²⁵R²⁶)Z₂(CR²⁷R²⁸)]ᵥ I)
M′_{z}{MR′ₐ[N(R¹R²)]_{b}[P(R³R⁴)]_{c}(OR⁵)_{d}(SR⁶)ₑX_{f}[(R⁷N)₂Z]_{g}[(R⁸P)₂Z₁]ₕ[(R⁹N)Z₂(PR¹⁰)]ₗ[ER″ₚ]_{q}[(R¹³N)Z₂(NR¹⁴R¹⁵)]ᵣ[(R¹⁶P)Z₂(PR¹⁷R¹⁸)]ₛ[(R¹⁹N)Z₂(PR²⁰R²¹)]ₜ[(R²²P)Z₂(NR²³R²⁴)]ᵤ[(CR²⁷R²⁸)Z₂(NR²⁵R²⁶)]ᵥ}_{w}X_{y}
wherein
M is a metal from one of Groups 3-10 of the Periodic System of the Elements, the lanthanides or actinides;
Z, Z¹, and Z₂ are divalent bridging groups joining two groups each of which comprise P or N, wherein Z, Z₁, and Z₂ independently selected are (CR¹¹₂)ⱼ or (SiR¹²₂)ₖ. or (CR²⁹₂)ₗO(CR³⁰₂)ₘ or (SiR³¹₂)ₙO(SiR³²₂)ₒ or a 1,2-disubstituted aromatic ring system wherein R¹¹, R¹², R²⁹, R³⁰, R³¹ and R³² independently selected are hydrogen, or are a group having from 1 to 80 nonhydrogen atoms which is hydrocarbyl, halo-substituted hydrocarbyl or hydrocarbylsilyl, and wherein
R′, R¹, R², R³, R⁴, R⁵, R⁶, R⁷, R⁸, R⁹, R¹⁰, R¹³, R¹⁴, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸ independently selected are all R groups or are hydrogen, or are a group having from 1 to 80 nonhydrogen atoms which is hydrocarbyl, halo-substituted hydrocarbyl, hydrocarbylsilyl or hydrocarbylstannyl;
[ER″ₚ] is a neutral Lewis base ligating compound wherein
E is oxygen, sulfur, nitrogen, or phosphorus;
R″ is hydrogen, or is a group having from 1 to 80 nonhydrogen atoms which is hydrocarbyl, halo-substituted hydrocarbyl or hydrocarbylsilyl and
p is 2 if E is oxygen or sulfur; and p is 3 if E is nitrogen or phosphorus;
q is a number from zero to six;
X is halide (fluoride, chloride, bromide, or iodide);
M′ is a metal from Group 1 or 2;
N, P, O, S are elements from the Periodic Table of the Elements;
b, c are zero, 1, 2, 3, 4, 5 or 6;
a, d, e, f are zero, 1 or 2;
g, h, i, r, s, t, u, v are zero, 1, 2 or 3;
j, k, l, m, n, o are zero, 1, 2, 3 or 4;
w, y, z are numbers from 1 to 1000;
the sum of a+b+c+d+e+f+g+h+i+r+s+t+u+v is less than or equal to 6;
   and wherein the metal complex may contain no more than one type of ligand selected from the following group: R′, (OR⁵), and X.

That means for example that the metal complex must not contain the following ligands: R′ and (OR⁵) ligands or R′ and X ligands or (OR⁵) and X at the same time.

The oxidation state of the metal atom M is 0 to +6.

Preferably, the metal M is one of the following: a lanthanide metal, scandium, yttrium, vanadium, chromium, cobalt or nickel.

Even more preferably, the metal M is one of the following: a lanthanide metal or vanadium metal and even more preferably a lanthanide metal and even more preferably neodymium.

Preferably the sum of a+b+c+d+e+g+h+i+r+s+t+u+v is 3, 4 or 5 and j, k, f, l, m, n, o are 1 or 2.

More preferably only one of a, b, c, d, e, g, h, i, r, s, t, u, v is not equal to zero; j, k, f, l, m, n, o are 1 or 2 and p, q, w, y are as defined above.

Even more preferably, all of the non-halide ligands of the metal complex according to the invention having either formula 1) or formula 2) are the same, that is, only one of a, b, c, d, e, g, h, i, r, s, t, u, v is not equal to zero;
j, k, f, I, m, n, o are 1 or 2;
p, q, w, y are as defined above; and
R¹ is identical to R²; R³ is identical to R⁴; R¹⁴ is identical to R¹⁵; R²⁵ is identical to R²⁶; R²⁷ is identical to R²⁸.

Even more preferably the ligands on the metal center are [N(R¹R²)]_{b}; [P(R³R⁴)]_{c}, (OR⁵)_{d,}, (SR⁶)ₑ, [(R⁷N)₂Z]_{g}, [(R⁸P)₂Z₁]ₕ, [(R⁹N)Z₂(PR¹⁰)]ᵢ, [(R¹³N)Z₂(NR¹⁴R¹⁵)]ᵣ, [(RP)Z₂(PR¹⁷₂)]ₛ, [(RN)Z₂(PR²⁰₂)]ₜ, [(RP)Z₂(NR²³₂)]ᵤ, [(NR²⁵R²⁶)Z₂(CR²⁷R²⁸)]ᵥ.

Exemplary, but not limiting, structures of metal complexes of the invention include M[N(R)₂]_{b}; M [P(R)₂]_{c}; M[(OR)_{d}(N(R)₂)_{b}]; M[(SR)ₑ(N(R)₂)_{b}]; M[(OR)_{d}(P(R)₂)_{c}]; M[(SR)ₑ(P(R)₂)_{c}]; M[(RN)₂Z]_{g}X_{f}; M[(RP)₂Z₁]ₕX_{f}; M[(RN)Z₂(PR)]ᵢX_{f}; M′_{z}{M[N(R)₂]_{b}X_{f}}_{w}X_{y}; M′_{z}{M[P(R)₂]_{c}X_{f}}_{w}X_{y}; M′_{z}{M[(RN)₂Z]_{g}X_{f}}_{w}X_{y}; M′_{z}{M[(RP)₂Z₁]ₕX_{f}}_{w}X_{y}; M′_{z}{M[(RN)Z₂(PR)]ᵢX_{f}}_{w}X_{y}; M[(RN)₂Z]_{g}X_{f}[ER″ₚ]_{q}; M′_{z}{M[(RN)₂Z]_{g}X_{f})_{w}Xₗ[ER″ₚ]_{q}; M′_{z}{M[(RP)₂Z₁]ₕX_{f}}_{w}X_{y}[ER″ₚ]_{q}; M[(RN)Z₂(N(R¹⁴)₂)]ᵣX_{y}; M[(RP)Z₂(P(R¹⁷)₂)]ₛX_{y}; M[(RN)Z₂(P(R²⁰)₂)]ₜX_{y}; M[(RP)Z₂(N(R²³)₂)]ᵤX_{y}; M[(CR²⁷₂)Z₂(NR₂)]ᵥX_{y}

wherein M, R, X, Z, Z₁, Z₂, M′, E, R″, R¹⁴, R¹⁷, R²⁰, R²³, R²⁷ b, c, d, e, f, g, h, i, m, p, q, r, s, t, u, v, w and y are as previously defined.

Preferred structures include the following:
Nd[N(R)₂]₃; Nd[P(R)₂]₃; Nd[(OR)₂(NR₂)]; Nd[(SR)₂(NR₂)]; Nd[(OR)₂(PR₂)]; Nd[(SR)₂(PR₂)]; Nd[(RN)₂Z]X; Nd[(RP)₂Z]X; Nd[(RN)Z(PR)]X; M′{Nd[(RN)₂Z]₂}; M′{Nd[(RP)₂Z]₂}; M′{Nd[(RN)Z(PR)]₂}; M′₂{NdR₂X₂}X; M′₂{Nd[N(R)₂]_{b}X_{f}}X; M′₂{Nd[P(R)₂]_{c}X_{f}}X; M′₂{Nd[(RN)₂ Z]X_{f}}X; M′₂{Nd[(RP)₂ Z]X_{f}}X; M′₂(Nd[(RN)Z(PR)]X_{f}}X; M′₂{Nd[(RN)₂Z]₂}X; M′₂{Nd[(RP)₂Z]₂}X; M′₂{Nd[(RN)Z(PR)]₂}X, Nd[(RN)Z(N(R¹⁴)₂)]₃; Nd[(RP)Z(P(R¹⁷)₂)]₃; Nd[(RN)Z(P(R²⁰)₂)]₃; Nd[(RP)Z(N(R²³)₂)]₃; Nd[(C(R²⁷)₂)Z(NR₂)]₃
   wherein
Z is (CR₂)₂, (SiR₂)₂, (CR₂)O(CR₂), (SiR₂)O(SiR₂) or a 1,2-disubstituted aromatic ring system; R, R¹⁴, R¹⁷, R²⁰, R²³, R²⁷ independently selected is hydrogen, alkyl, benzyl, aryl, silyl, stannyl; X is fluoride, chloride or bromide; b, c is 1 or 2; f is 1 or 2; M′ is Li, Na, K and
   wherein M, R, X and Z are as previously defined.

Exemplary, but not limiting, metal complexes of the invention are:
Nd[N(Si Me₃)₂]₃, Nd[P(SiMe₃)₂]₃, Nd[N(SiMe₂Ph)₂]₃, Nd[P(SiMe₂Ph)₂]₃, Nd[N(Ph)₂]₃, Nd[P(Ph)₂]₃, Nd[N(SiMe₃)₂]₂F, Nd[N(SiMe₃)₂]₂Cl, Nd[N(SiMe₃)₂]₂Cl(THF)ₙ, Nd[N(SiMe₃)₂]₂Br, Nd[P(SiMe₃)₂]₂F, Nd[P(SiMe₃)₂]₂Cl, Nd[P(SiMe₃)₂]₂Br, {Li{Nd[N(SiMe₃)₂]Cl₂}Cl}ₙ, {Li{Nd[N(SiMe₃)₂]Cl₂}Cl(THF)ₙ}ₙ, {Na{Nd[N(SiMe₃)₂]Cl₂}Cl}ₙ, {K{Nd[N(SiMe₃)₂]Cl₂}Cl}ₙ, {Mg{{Nd[N(SiMe₃)₂]Cl₂}Cl}₂}ₙ, {Li{Nd[P(SiMe₃)₂]Cl₂}Cl}ₙ, {Na{Nd[P(SiMe₃)₂]Cl₂}Cl}ₙ, {K{Nd[P(SiMe₃)₂]Cl₂}Cl}ₙ, {Mg{{Nd[P(SiMe₃)₂]Cl₂}Cl}₂}ₙ, {K₂{Nd[PhN(CH₂)₂NPh]Cl₂}Cl}ₙ, {K₂{Nd[PhN(CH₂)₂NPh]Cl₂}Cl(O(CH₂CH₃)₂)ₙ}ₙ, {Mg{Nd[PhN(CH₂)₂NPh]Cl₂}Cl}ₙ, {Li₂{Nd[PhN(CH₂)₂NPh]Cl₂}Cl}ₙ, {Na₂{Nd[PhN(CH₂)₂NPh]Cl₂}Cl}ₙ, {Na₂{Nd[PhN(CH₂)₂NPh]Cl₂}Cl(N Me₃)ₙ}ₙ, {Na₂{Nd[Me₃SiN(CH₂)₂NSiMe₃]Cl₂}Cl}ₙ, {K₂{Nd[Me₃SiN(CH₂)₂NSiMe₃]Cl₂}Cl}ₙ, {Mg{Nd[Me₃SiN(CH₂)₂NSiMe₃]Cl₂}Cl}ₙ, (Li₂{Nd[Me₃SiN(CH₂)₂NSiMe₃]Cl₂}Cl}, {K₂{Nd[Ph P(CH₂)₂PPh]Cl₂}Cl}ₙ, {Mg{Nd[PhP(CH₂)₂PPh]Cl₂}Cl}ₙ, {Li₂{Nd[PhP(CH₂)₂PPh]Cl₂}Cl}ₙ, {Na₂{Nd[PhP(CH₂)₂PPh]Cl₂}Cl}ₙ, {Na₂{Nd[Me₃SiP(CH₂)₂P SiMe₃]Cl₂}Cl}ₙ, {K₂{Nd[Me₃SiP(CH₂)₂P SiMe₃]Cl₂}Cl}ₙ, {Mg{Nd[Me₃SiP(CH₂)₂P SiMe₃]Cl₂}Cl}ₙ, {Li₂{Nd[Me₃SiP(CH₂)₂P SiMe₃]Cl₂}Cl}ₙ, Nd[N(Ph)₂]₂F, Nd[N(Ph)₂]₂Cl, Nd[N(Ph)₂]₂Cl(THF)ₙ, Nd[N(Ph)₂]₂Br, Nd[P(Ph)₂]₂F, Nd[P(Ph)₂]₂Cl, Nd[P(Ph)₂]₂Br, {Li{Nd[N(Ph)₂]Cl₂}Cl}ₙ, {Na{Nd[N(Ph)₂]Cl₂}Cl}ₙ, {K{Nd[N(Ph)₂]Cl₂}Cl}ₙ, {Mg{{Nd[N(Ph)₂]Cl₂}Cl}₂}ₙ, {Li{Nd[P(Ph)₂]Cl₂}Cl}ₙ, {Na{Nd[P(Ph)₂]Cl₂}Cl}ₙ, {K{Nd[P(Ph)₂]Cl₂}Cl}ₙ, (Mg{{Nd[P(Ph)₂]Cl₂}Cl}₂}ₙ, {K₂{Nd[Ph N(Si(CH₃)₂)₂NPh]Cl₂}Cl}ₙ, {Mg{Nd[PhN(Si(CH₃)₂)₂NPh]Cl₂}Cl}ₙ, {Li₂{Nd[PhN(Si(CH₃)₂)₂NPh]Cl₂}Cl}ₙ, {Na₂{Nd[PhN(Si(CH₃)₂)₂NPh]Cl₂}Cl}ₙ, {Na₂{Nd[Me₃SiN(Si(CH₃)₂)₂NSiMe₃]Cl₂}Cl}ₙ, {K₂{Nd[Me₃SiN(Si(CH₃)₂)₂NSiMe₃]Cl₂}Cl}ₙ, {Mg{Nd[Me₃SiN(Si(CH₃)₂)₂NSiMe₃]Cl₂}Cl}ₙ, {Li₂{Nd[Me₃SiN(Si(CH₃)₂)₂NSiMe₃]Cl₂}Cl}, {K₂{Nd[PhP(Si(CH₃)₂)₂PPh]Cl₂}Cl}ₙ, {Mg{Nd[PhP(Si(CH₃)₂)₂PPh]Cl₂}Cl}ₙ, {Li₂{Nd[PhP(Si(CH₃)₂)₂PPh]Cl₂}Cl}ₙ, {Na₂{Nd[PhP(Si(CH₃)₂)₂PPh]Cl₂}Cl₂}ₙ, K₂{Nd[PhN(CH₂)₂NPh]₂}Cl; Na₂{Nd[PhN(CH₂)₂NPh]₂}Cl; Li₂{Nd[PhN(CH₂)₂NPh]₂}Cl; K₂{Nd[((CH₃)₃Si)N(CH₂)₂N(Si(CH₃)₃)]₂}Cl; Na₂{Nd[((CH₃)₃Si)N(CH₂)₂N(Si(CH₃)₃)]₂}Cl; Li₂{Nd[((CH₃)₃Si)N(CH₂)₂N(Si(CH₃)₃)]₂}Cl; K₂{Nd[PhN(Si(CH₃)₂)₂NPh]₂}Cl; Na₂{Nd[PhN(Si(CH₃)₂)₂NPh]₂}Cl; Li₂{Nd[PhN(Si(CH₃)₂)₂NPh]₂}Cl; K₂{Nd[((CH₃)₃Si)N(Si(CH₃)₂)₂N(Si(CH₃)₃)]₂}Cl; Na₂{Nd[((CH₃)₃Si)N(Si(CH₃)₂)₂N(Si(CH₃)₃)]₂}Cl; Li₂{Nd[((CH₃)₃Si)N(Si(CH₃)₂)₂N(Si(CH₃)₃)]₂}Cl; K₂{Nd[PhP(CH₂)₂PPh]₂}Cl; Na₂{Nd[PhP(CH₂)₂PPh]₂}Cl; Li₂{Nd[PhP(CH₂)₂PPh]₂)Cl; K₂{Nd[((CH₃)₃Si)P(CH₂)₂P(Si(CH₃)₃)]₂}Cl; Na₂{Nd[((CH₃)₃Si)P CH₂)₂P(Si(CH₃)₃)]₂}Cl; Li₂{Nd[((CH₃)₃Si)P(CH₂)₂P(Si(CH₃)₃)]₂}Cl; K₂{Nd[PhP(Si(CH₃)₂)PPh]₂}Cl; Na₂{Nd[PhP(Si(CH₃)₂)PPh]₂}Cl; Li₂{Nd[PhP(Si(CH₃)₂)PPh]₂}Cl; K₂{Nd[((CH₃)₃Si)P(Si(CH₃)₂)P(Si(CH₃)₃)]₂}Cl; Na₂{Nd[((CH₃)₃Si)P(Si(CH₃)₂)P(Si(CH₃)₃)]₂}Cl; Li₂{Nd[((CH₃)₃Si)P(Si(CH₃)₂)P(Si(CH₃)₃)]₂}Cl; Nd[((CH₃)N)(CH₂)₂(N(CH₃)₂)]₃; Nd[(PhN)(CH₂)₂(N(CH₃)₂)]₃; Nd[((CH₃)N)(CH₂)₂(N(CH₃)(Ph))]₃; Nd[((CH₃)N)(CH₂)₂(N(Ph)₂)]₃; Nd[((CH₃CH₂)N)(CH₂)₂(N(CH₃)₂)]₃; Nd[((CH₃CH₂)N)(CH₂)₂(N(CH₃)(Ph))]₃; Nd[((CH₃CH₂)N)(CH₂)₂(N(Ph)₂)]₃; Nd[((CH₃)P)(CH₂)₂(P(CH₃)₂)]₃; Nd[(PhP)(CH₂)₂(P(CH₃)₂)]₃; Nd[((CH₃)P)(CH₂)₂(P(CH₃)(Ph))]₃; Nd[((CH₃)P)(CH₂)₂(P(Ph)₂)]₃; Nd[((CH₃CH₂)P)(CH₂)₂(P(CH₃)₂)]₃; Nd[((CH₃CH₂)P)(CH₂)₂(P(CH₃)(Ph))]₃; Nd[((CH₃CH₂)P)(CH₂)₂(P(Ph)₂)]₃; Nd[2-((CH₃)₂N)(C₆H₄)-1-(CH₂)]₃, Nd[2-((CH₃CH₂)₂N)(C₆H₄)-1-(CH₂)]₃, Nd[2-((CH₃)₂CH)₂N)(C₆H₄)-1-(CH₂)]₃, Nd[2-(Ph₂N)(C₆H₄)-1-(CH₂)]₃, Nd[2-((CH₃))N(C₆H₄)-1-(CH₂)]₃, Nd[2-(((CH₃)(CH₂)₁₇)(CH₃)N)(C₆H₄)-1-(CH₂)]₃, Nd[2-((CH₃)₂N)-3-((CH₃)(CH₂)₁₇)(C₆H₄)-1-(CH₂)]₃, Nd[2-((CH₃)₂N)-4-((CH₃)(CH₂)₁₇)(C₆H₄)-1-(CH₂)]₃, 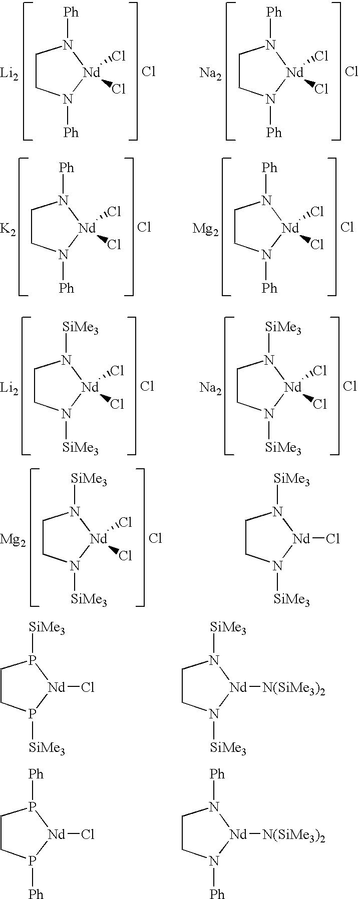
   wherein (C₆H₄) is a 1,2-substituted aromatic ring and Me is methyl, Ph is phenyl, THF is tetrahydrofuran, DME is dimethoxyethane and n is a number from 1 to 1000.

The metal complexes of the invention may be produced by contacting a metal salt compound with an appropriate ligand transfer reagent. Preferably the metal salt compound is a salt of an inorganic ligand such as halide, sulfate, nitrate, phosphate, perchlorate; or is a salt of an organic ligand such as carboxylate or acetylacetonate. Preferably the metal salt compound is a metal halide compound, carboxylate or acetylacetonate compound, more preferably a metal chloride.

Ligand transfer reagents may be metal salts of the ligand to be transferred, wherein the metal is selected from Groups 1 or 2. Preferably the ligand transfer reagent has one of the following formulas:
M′R′_{y}, M′[N(R¹R²)]_{y′}, M′[P(R³R⁴)]_{y′}, M′[(OR⁵)]_{y′}, M′[(SR⁶)]_{y′}, M′_{z′}[(R⁷N)₂Z], M′_{z′}[(R⁸P)₂Z₁],
M′_{z′}[(R⁹N)Z₂(PR¹⁰)], M′[(R¹³N)Z₂(NR¹⁴R¹⁵)]_{y′}, M′[(R¹⁶P)Z₂(PR¹⁷R¹⁸)]_{y′},
M′[(R¹⁹N)Z₂(PR²⁰R²¹)]_{y′}, M′[(R²²P)Z₂(NR²³R²⁴)]_{y′}, M′[(NR²⁵R²⁶)Z₂(CR²⁷R²⁸)]_{y′}.
wherein
Z, Z₁, Z₂, R′, R¹, R², R³, R⁴, R⁵, R⁶, R⁷, R⁸, R⁹, R¹⁰, R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸ are defined as above; M′ is a metal from Group 1 or 2 or is MgCl, MgBr, Mgl and y′ and z′ are one or two.

Alternatively, the ligand transfer reagent may be the combination of the neutral, that is the protonated form of the ligand to be transferred with a proton scavenger agent, wherein the ligand transfer reagent has one of the following formulas:
HN(R¹R²), HP(R³R⁴), H(OR⁵), H(SR⁶), [(HR⁷N)₂Z], [(HR⁸P)₂Z₁],
[(HR⁹N)Z₂(HPR¹⁰)], [(HR¹³N)Z₂(NR¹⁴R¹⁵)], [(HR¹⁶P)Z₂(PR¹⁷R¹⁸)],
[(HR¹⁹N)Z₂(PR²⁰R²¹)], [(HR²²P)Z₂(NR²³R²⁴)],
wherein
Z, Z₁, Z₂, R¹, R², R³, R⁴, R⁵, R⁶, R⁷, R⁸, R⁹, R¹⁰, R¹³, R¹⁴, R¹⁵, R¹⁶, R¹⁷, R¹⁸, R¹⁹, R²⁰, R²¹, R²², R²³, R²⁴ are defined as above.

The proton scavenger agent preferably is a neutral Lewis base, more preferably an alkyl amine, such as triethylamine, pyridine, or piperidine.

The process to produce the complexes of the invention may be carried out in the presence of a neutral Lewis base ligating compound [ER″ₚ] wherein ER″ and p are defined as above, for example, diethyl ether, tetrahydrofuran, dimethylsulfide, dimethoxyethane, triethylamine, trimethylphosphine, pyridine, trimethylamine, morpholine, pyrrolidine, piperidine, and dimethylformamide.

More preferably, metal complexes are objects of this invention which result from the reaction of neodymium halide compounds, especially neodymium chloride compounds, such as neodymium trichloride, neodymium trichloride dimethoxyethane adduct, neodymium trichloride triethylamine adduct or neodymium trichloride tetrahydrofuran adduct with one of the following metal compounds:
Na₂[PhN(CH₂)₂NPh], Li₂[PhN(CH₂)₂NPh], K₂[PhN(CH₂)₂NPh], Na₂[PhP(CH₂)₂PPh], Li₂[PhP(CH₂)₂PPh], K₂[PhP(CH₂)₂PPh], Mg[PhN(CH₂)₂NPh], (MgCl)₂[PhN(CH₂)₂NPh], Mg[PhP(CH₂)₂PPh]Na₂[PhN(CMe₂)₂NPh], Li₂[PhN(CMe₂)₂NPh], K₂[PhN(CMe₂)₂NPh], Na₂[PhP(CMe₂)₂PPh], Li₂[PhP(CMe₂)₂PPh], K₂[PhP(CMe₂)₂PPh], Mg[PhN(CMe₂)₂NPh], (MgCl)₂[PhN(CMe₂)₂NPh], Mg[PhP(CMe₂)₂PPh]Na₂[Me₃SiN(CH₂)₂NSiMe₃], Li₂[Me₃SiN(CH₂)₂NSiMe₃], K₂[Me₃SiN(CH₂)₂NSiMe₃], Mg[Me₃SiN(CH₂)₂NSiMe₃], (MgCl)₂[Me₃SiN(CH₂)₂NSiMe₃], Na₂[Me₃SiP(CH₂)₂PSiMe₃], Li₂[Me₃SiP(CH₂)₂PSiMe₃], K₂[Me₃SiP(CH₂)₂PSiMe₃], Mg[Me₃SiP(CH₂)₂PSiMe₃], (MgCl)₂[Me₃SiP(CH₂)₂PSiMe₃], Na₂[Me₃SiN(CMe₂)₂NSiMe₃], Li₂[Me₃SiN(CMe₂)₂NSiMe₃], K₂[Me₃SiN(CMe₂)₂NSiMe₃], Mg[Me₃SiN(CMe₂)₂NSiMe₃], (MgCl)₂[Me₃SiN(CMe₂)₂NSiMe₃], Na₂[Me₃SiP(CMe₂)₂PSiMe₃], Li₂[Me₃SiP(CMe₂)₂PSiMe₃], K₂[Me₃SiP(CMe₂)₂PSiMe₃], Mg[Me₃SiP(CMe₂)₂PSiMe₃], (MgCl)₂[Me₃SiP(CMe₂)₂PSiMe₃], Li[2-((CH₃)₂N)(C₆H₄)-1-(CH₂)], Li[2-((CH₃CH₂)₂N)(C₆H₄)-1-(CH₂)], Li[2-((CH₃)₂CH)₂N)(C₆H₄)-1-(CH₂)], Li[2-(Ph₂N)(C₆H₄)-1-(CH₂)], Li[2-((CH₃))N(C₆H₄)-1-(CH₂)], Li[2-(((CH₃)(CH₂)₁₇)(CH₃)N)(C₆H₄)-1-(CH₂)], Li[2-((CH₃)₂N)-3-((CH₃)(CH₂)₁₇)(C₆H₄)-1-(CH₂)]₃ᵢ, Li[2-((CH₃)₂N)-4-((CH₃)(CH₂)₁₇)(C₆H₄)-1-(CH₂)], MgCl[2-((CH₃)₂N)(C₆H₄)-1-(CH₂)], MgCl[2-((CH₃CH₂)₂N)(C₆H₄)-1-(CH₂)], MgCl[2-((CH₃)₂CH)₂N)(C₆H₄)-1-(CH₂)], MgCl[2-(Ph₂N)(C₆H₄)-1-(CH₂)], MgCl[2-((CH₃))N(C₆H₄)-1-(CH₂)], MgCl[2-(((CH₃)(CH₂)₁₇)(CH₃)N)(C₆H₄)-1-(CH₂)], MgCl[2-((CH₃)₂N)-3-((CH₃)(CH₂)₁₇)(C₆H₄)-1-(CH₂)]₃ᵢ, MgCl[2-((CH₃)₂N)-4-((CH₃)(CH₂)₁₇)(C₆H₄)-1-(CH₂)].

The formula weight of the metal complex preferably is lower than 2000, more preferably lower than 800.

The reaction system optionally contains a solid material, which serves as support material for the activator component and/or the metal complex. The diene component(s) are preferably 1,3-butadiene or isoprene.

The carrier material can be chosen from one of the following materials
Clay
Silica
Charcoal (activated carbon)
Graphite
Expanded Clay
Expanded Graphite
Carbon black
Layered silicates
Alumina
   Clays and layered silicates are, for example, but not limited to, magadiite, montmorillonite, hectorite, sepiolite, attapulgite, smectite, and laponite.

Supported catalyst systems of the invention may be prepared by several methods. The metal complex and optionally the cocatalyst can be combined before the addition of the support material. The mixture may be prepared in conventional solution in a normally liquid alkane or aromatic solvent. The solvent is preferably also suitable for use as a polymerization diluent for the liquid phase polymerization of an olefin monomer. Alternatively, the cocatalyst can be placed on the support material followed by the addition of the metal complex or conversely, the metal complex may be applied to the support material followed by the addition of the cocatalyst. The supported catalyst maybe prepolymerized. In addition, third components can be added during any stage of the preparation of the supported catalyst. Third components can be defined as compounds containing Lewis acidic or basic functionalities exemplified by, but not limited to compounds such as N,N-dimethylaniline, tetraethoxysilane, phenyltriethoxysilane, bis-tert-butylhydroxy toluene(BHT) and the like. After treating the support material with one or more of the aforementioned components (metal complex, activator or third component) an aging step may be added. The aging may include thermal, UV or ultrasonic treatment, a storage period and/or treatment with low diene quantities.

There are different possibilities to immobilize catalysts. Some important examples are the following:

The solid-phase immobilization (SPI) technique described by H. C. L. Abbenhuis in Angew. Chem. Int. Ed. 37 (1998) 356-58, by M. Buisio et al., in Microporous Mater., 5 (1995) 211 and by J. S. Beck et al., in J. Am. Chem. Soc., 114 (1992) 10834, as well as the pore volume impregnation (PVI) technique (see WO 97/24344) can be used to support the metal complex on the carrier material. The isolation of the impregnated carrier can be done by filtration or by removing the volatile material present (i.e., solvent) under reduced pressure.

The ratio of the supported metal complex to the support material usually is in a range of from about 0.5 to about 100,000, more preferably from 1 to 10000 and most preferably in a range of from about 1 to about 5000.

The metal complex (supported or unsupported) according to the invention can be used, without activation with a cocatalyst, for the polymerization of olefins. The metal complex can also be activated using a cocatalyst. The activation can be performed during a separate reaction step including an isolation of the activated compound or can be performed in situ. The activation is preferably performed in situ if, after the activation of the metal complex, separation and/or purification of the activated complex is not necessary.

The metal complexes according to the invention can be activated using suitable cocatalysts. For example, the cocatalyst can be an organometallic compound, wherein at least one hydrocarbyl radical is bound directly to the metal to provide a carbon-metal bond. The hydrocarbyl radicals bound directly to the metal in the organometallic compounds preferably contain 1-30, more preferably 1-10 carbon atoms. The metal of the organometallic compound can be selected from group 1, 2, 3, 12, 13 or 14 of the Periodic Table of the Elements. Suitable metals are, for example, sodium, lithium, zinc, magnesium and aluminum and boron.

The metal complexes of the invention are rendered catalytically active by combination with an activating cocatalyst. Suitable activating cocatalysts for use herein include halogenated boron compounds, fluorinated or perfluorinated tri(aryl)boron or -aluminum compounds, such as tris(pentafluorophenyl)boron, tris(pentafluorophenyl)aluminum, tris(o-nonafluorobiphenyl)boron, tris(o-nonafluorobiphenyl)aluminum, tris[3,5-bis(trifluoromethyl)phenyl]boron, tris[3,5-bis(trifluoromethyl)phenyl]aluminum; polymeric or oligomeric alumoxanes, especially methylalumoxane (MAO), triisobutyl aluminum-modified methylalumoxane, or isobutylalumoxane; nonpolymeric, compatible, noncoordinating, ion-forming compounds (including the use of such compounds under oxidizing conditions), especially the use of ammonium-, phosphonium-, oxonium-, carbonium-, silylum-, sulfonium-, or ferrocenium-salts of compatible, noncoordinating anions; and combinations of the foregoing activating compounds. The foregoing activating cocatalysts have been previously taught with respect to different metal complexes in the following references: U.S. Pat. Nos. 5,132,380, 5,153,157, 5,064,802, 5,321,106, 5,721,185, 5,350,723, and WO-97/04234, equivalent to U.S. Ser. No. 08/818,530, filed Mar. 14, 1997.

The catalytic activity of the metal complex/cocatalyst (or activator) mixture according to the invention may be modified by combination with an optional catalyst modifier. Suitable optional catalyst modifiers for use herein include hydrocarbyl sodium, hydrocarbyl lithium, hydrocarbyl zinc, hydrocarbyl magnesium halide, dihydrocarbyl magnesium, especially alkyl sodium, alkyl lithium, alkyl zinc, alkyl magnesium halide, dialkyl magnesium, such as n-octyl sodium, butyl lithium, neopentyl lithium, methyl lithium, ethyl lithium, diethyl zinc, dibutyl zinc, butyl magnesium chloride, ethyl magnesium chloride, octyl magnesium chloride, dibutyl magnesium, dioctyl magnesium, butyl octyl magnesium. Suitable optional catalyst modifiers for use herein also include neutral Lewis acids, such as C₁₋₃₀ hydrocarbyl substituted Group 13 compounds, especially (hydrocarbyl)aluminum- or (hydrocarbyl)boron compounds and halogenated (including perhalogenated) derivatives thereof, having from 1 to 20 carbons in each hydrocarbyl or halogenated hydrocarbyl group, more especially triaryl and trialkyl aluminum compounds; such as triethyl aluminum and tri-isobutyl aluminum, alkyl aluminum hydrides, such as di-isobutyl aluminum hydride alkylalkoxy aluminum compounds, such as dibutyl ethoxy aluminum, and halogenated aluminum compounds, such as diethyl aluminum chloride, diisobutyl aluminum chloride, ethyl octyl aluminum chloride, ethyl aluminum sesquichloride, ethyl cyclohexyl aluminum chloride, dicyclohexyl aluminum chloride, dioctyl aluminum chloride, tris(pentafluorophenyl)aluminum and tris(nonafluorobiphenyl)aluminum.

Especially desirable activating cocatalysts for use herein are combinations of neutral optional Lewis acids, especially the combination of a trialkyl aluminum compound having from 1 to 4 carbons in each alkyl group with one or more C₁₋₃₀ hydrocarbyl-substituted Group 13 Lewis acid compounds, especially halogenated tri(hydrocarbyl)boron or -aluminum compounds having from 1 to 20 carbons in each hydrocarbyl group, especially tris(pentafluorophenyl)borane or tris(pentafluorophenyl)alumane, further combinations of such neutral Lewis acid mixtures with a polymeric or oligomeric alumoxane, and combinations of a single neutral Lewis acid, especially tris(pentafluorophenyl)borane or tris(pentafluorophenyl)alumane, with a polymeric oligomeric alumoxane. A benefit according to the present invention is the discovery that the most efficient catalyst activation using such a combination of tris(pentafluorophenyl)borane/alumoxane mixture occurs at reduced levels of alumoxane. Preferred molar ratios of the metal complex:tris(pentafluorophenylborane:alumoxane are from 1:1:1 to 1:5:5, more preferably from 1:1:1.5 to 1:5:3. The surprising efficient use of lower levels of alumoxane with the present invention allows for the production of diene polymers with high catalytic efficiencies using less of the expensive alumoxane cocatalyst. Additionally, polymers with lower levels of aluminum residue, and hence greater clarity, are obtained.

Suitable ion-forming compounds useful as cocatalysts in one embodiment of the present invention comprise a cation which is a Bronsted acid capable of donating a proton, and a compatible, noncoordinating anion. As used herein, the term “noncoordinating” means an anion or substance which either does not coordinate to the metal containing precursor complex and the catalytic derivative derived therefrom, or which is only weakly coordinated to such complexes thereby remaining sufficiently labile to be displaced by a Lewis base such as olefin monomer. A noncoordinating anion specifically refers to an anion which when functioning as a charge-balancing anion in a cationic metal complex does not transfer an anionic substituent or fragment thereof to said cation thereby forming neutral complexes. “Compatible anions” are anions which are not degraded to neutrality when the initially formed complex decomposes and are noninterfering with desired subsequent polymerization or other uses of the complex.

Preferred anions are those containing a single coordination complex comprising a charge-bearing metal or metalloid core which anion is capable of balancing the charge of the active catalyst species (the metal cation) which may be formed when the two components are combined. Also, said anion should be sufficiently labile to be displaced by olefinic, diolefinic and acetylenically unsaturated compounds or other neutral Lewis bases such as ethers or nitrites. Suitable metals include, but are not limited to, aluminum, gold and platinum. Suitable metalloids include, but are not limited to, boron, phosphorus, and silicon. Compounds containing anions which comprise coordination complexes containing a single metal or metalloid atom are, of course, well known and many, particularly such compounds containing a single boron atom in the anion portion, are available commercially.

Preferably such cocatalysts may be represented by the following general formula:
(L*−H)_{d}⁺A^{d-}
wherein:
L* is a neutral Lewis base;
(L*−H)⁺ is a Bronsted acid;
A^{d-} is a noncoordinating, compatible anion having a charge of d−, and
d is an integer from 1 to 3.

More preferably A^{d-} corresponds to the formula:
[M*Q₄];
wherein:
M* is boron or aluminum in the +3 formal oxidation state; and
Q independently each occurrence is selected from hydride, dialkylamido, halide, hydrocarbyl, halohydrocarbyl, halocarbyl, hydrocarbyloxide, hydrocarbyloxy substituted-hydrocarbyl, organometal substituted-hydrocarbyl, organometalloid substituted-hydrocarbyl, halohydrocarbyloxy, halohydrocarbyloxy substituted hydrocarbyl, halocarbyl-substituted hydrocarbyl, and halo-substituted silylhydrocarbyl radicals (including perhalogenated hydrocarbyl-perhalogenated hydrocarbyloxy- and perhalogenated silythydrocarbyl radicals), said Q having up to 20 carbons with the proviso that in not more than one occurrence is Q halide. Examples of suitable hydrocarbyloxide Q groups are disclosed in U.S. Pat. No. 5,296,433.

In a more preferred embodiment, d is one, that is, the counter ion has a single negative charge and is A−. Activating cocatalysts comprising boron which are particularly useful in the preparation of catalysts of this invention may be represented by the following general formula:
(L*−H)+(BQ₄)⁻;
wherein:
L* is as previously defined;
B is boron in a formal oxidation state of 3; and
Q is a hydrocarbyl-, hydrocarbyloxy-, fluorinated hydrocarbyl-, fluorinated hydrocarbyloxy-, or fluorinated silylhydrocarbyl-group of up to 20 nonhydrogen atoms, with the proviso that in not more than one occasion is Q hydrocarbyl. Most preferably, Q is each occurrence a fluorinated aryl group, especially, a pentafluorophenyl or nonafluorobiphenyl group.

Illustrative, but not limiting, examples of boron compounds which may be used as an activating cocatalyst in the preparation of the improved catalysts of this invention are tri-substituted ammonium salts such as: trimethylammonium tetraphenylborate, tri(n-butyl)ammonium tetraphenylborate, methyldioctadecylammonium tetraphenylborate, triethylammonium tetraphenylborate, tripropylammoniurn tetraphenylborate, tri(n-butyl)ammonium tetraphenylborate, methyltetradecyloctadecylammonium tetraphenylborate, N,N-dimethylanilinium tetraphenylborate, N,N-diethylanilinium tetraphenylborate, N,N-dimethyl(2,4,6-trimethylanilinium)tetraphenylborate, N,N-dimethyl anilinium bis(7,8-dicarbundecaborate)cobaltate (III), trimethylammonium tetrakis(pentafluorophenyl)borate, methyldi(tetradecyl)ammonium tetrakis(pentafluorophenyl)borate, methyldi(octadecyl)ammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl(2,4,6-trimethylanilinium) tetrakis(pentafluorophenyl)borate, trimethylammonium tetrakis(2,3,4,6-tetrafluorophenyl)borate, triethylammonium tetrakis(2,3,4,6-tetrafluorophenyl)borate, tripropylammonium tetrakis(2,3,4,6-tetrafluorophenyl)borate, tri(n-butyl)ammonium tetrakis(2,3,4,6-tetrafluorophenyl) borate, dimethyl(t-butyl)ammonium tetrakis(2,3,4,6-tetrafluorophenyl)borate, N,N-dimethylanilinium tetrakis(2,3,4,6-tetrafluorophenyl)borate, N,N-diethylanilinium tetrakis(2,3,4,6-tetrafluorophenyl)borate, and N,N-dimethyl-(2,4,6-trimethylanilinium)tetrakis-(2,3,4,6-tetrafluorophenyl)borate; dialkyl ammonium salts such as: di(octadecyl)ammonium tetrakis(pentafluorophenyl)borate, di(tetradecyl)ammonium tetrakis(pentafluorophenyl)borate, and dicyclohexylammonium tetrakis(pentafluorophenyl)borate; tri-substituted phosphonium salts such as: triphenylphosphonium tetrakis(pentafluorophenyl)borate, methyldi(octadecyl)phosphonium tetrakis(pentafluorophenyl) borate, and tri(2,6-dimethylphenyl)phosphonium tetrakis(pentafluorophenyl)borate.

Preferred are tetrakis(pentafluorophenyl)borate salts of long chain alkyl mono- and disubstituted ammonium complexes, especially C₁₄-C₂₀ alkyl ammonium complexes, especially methyldi(octadecyl)ammonium tetrakis (pentafluorophenyl)borate and methyldi(tetradecyl)ammonium tetrakis(pentafluorophenyl)borate, or mixtures including the same. Such mixtures include protonated ammonium cations derived from amines comprising two C₁₄, C₁₆ or C₁₈ alkyl groups and one methyl group. Such amines are available from Witco Corp., under the trade name Kemamine™ T9701, and from Akzo-Nobel under the trade name Armeen™ M2HT.

Examples of the most highly preferred catalyst activators herein include the foregoing trihydrocarbylammonium-, especially, methylbis(tetradecyl)ammonium- or methylbis(octadecyl)ammonium-salts of: bis(tris(pentafluorophenyl)borane)imidazolide, bis(tris(pentafluorophenyl)borane)-2-undecylimidazolide, bis(tris(pentafluorophenyl)borane)-2-heptadecylimidazolide, bis(tris(pentafluorophenyl)borane)-4,5-bis(undecyl)imidazolide, bis(tris(pentafluorophenyl)borane)-4,5-bis(heptadecyl)imidazolide, bis(tris(pentafluorophenyl)borane)imidazolinide, bis(tris(pentafluorophenyl)borane)-2-undecylimidazolinide, bis(tris(pentafluorophenyl)borane)-2-heptadecylimidazolinide, bis(tris(pentafluorophenyl)borane)-4,5-bis(undecyl)imidazolinide, bis(tris(pentafluorophenyl)borane)-4,5-bis(heptadecyl)imidazolinide, bis(tris(pentafluorophenyl)borane)-5,6-dimethylbenzimidazolide, bis(tris(pentafluorophenyl)borane)-5,6-bis(undecyl)benzimidazolide, bis(tris(pentafluorophenyl)alumane)imidazolide, bis(tris(pentafluorophenyl)alumane)-2-undecylimidazolide, bis(tris(pentafluorophenyl)alumane)-2-heptadecylimidazolide, bis(tris(pentafluorophenyl)alumane)-4,5-bis(undecyl)imidazolide, bis(tris(pentafluorophenyl)alumane)-4,5-bis(heptadecyl)imidazolide, bis(tris(pentafluorophenyl)alumane)imidazolinide, bis(tris(pentafluorophenyl)alumane)-2-undecylimidazolinide, bis(tris(pentafluorophenyl)alumane)-2-heptadecylimidazolinide, bis(tris(pentafluorophenyl)alumane)-4,5-bis(undecyl)imidazolinide, bis(tris(pentafluorophenyl)alumane)-4,5-bis(heptadecyl)imidazolinide, bis(tris(pentafluorophenyl)alumane)-5,6-dimethylbenzimidazolide, and bis(tris(pentafluorophenyl)alumane)-5,6-bis(undecyl)benzimidazolide. The foregoing activating cocatalysts have been previously taught with respect to different metal complexes in the following reference: EP 1 560 752 A1.

Another suitable ammonium salt, especially for use in heterogeneous catalyst systems is formed upon reaction of a organometal compound, especially a tri(C₁₋₆ alkyl)aluminum compound with an ammonium salt of a hydroxyaryltris(fluoroaryl)borate compound. The resulting compound is an organometaloxyaryltris(fluoroaryl)borate compound which is generally insoluble in aliphatic liquids. Examples of suitable compounds include the reaction product of a tri(C₁₋₆ alkyl)aluminum compound with the ammonium salt of hydroxyaryltris(aryl)borate. Suitable hydroxyaryltris(aryl)borates include the ammonium salts, especially the foregoing long chain alkyl ammonium salts of:
(4-dimethylaluminumoxy-1-phenyl)tris(pentafluorophenyl)borate, (4-dimethylaluminumoxy-3,5-di(trimethylsilyl)-1-phenyl) tris(pentafluorophenyl)borate, (4-dimethylaluminumoxy-3,5-di(t-butyl)-1-phenyl)tris(pentafluorophenyl)borate, (4-dimethylaluminumoxy-1-benzyl)tris(pentafluorophenyl)borate, (4-dimethylaluminumoxy-3-methyl-1-phenyl)tris(pentafluorophenyl)borate, (4-dimethylaluminumoxy-tetrafluoro-1-phenyl)tris(pentafluorophenyl)borate, (5-dimethylaluminumoxy-2-naphthyl)tris(pentafluorophenyl)borate, 4-(4-dimethylaluminumoxy-1-phenyl)phenyltris(pentafluorophenyl)borate, 4-(2-(4-(dimethylaluminumoxyphenyl)propane-2-yl)phenyloxy) tris(pentafluorophenyl)borate, (4-diethylaluminumoxy-1-phenyl)tris(pentafluorophenyl)borate, (4-diethylaluminumoxy-3,5-di(trimethylsilyl)-1-phenyl)tris(pentafluorophenyl)borate, (4-diethylaluminumoxy-3,5-di(t-butyl)-1-phenyl)tris(pentafluorophenyl)borate, (4-diethylaluminumoxy-1-benzyl)tris(pentafluorophenyl)borate, (4-diethylaluminumoxy-3-methyl-1-phenyl)tris(pentafluorophenyl)borate, (4-diethylaluminumoxy-tetrafluoro-1-phenyl)tris(pentafluorophenyl)borate, (5-diethylaluminumoxy-2-naphthyl)tris(pentafluorophenyl)borate, 4-(4-diethylaluminumoxy-1-phenyl)phenyltris(pentafluorophenyl)borate, 4-(2-(4-(diethylaluminumoxyphenyl)propane-2-yl)phenyloxy) tris(pentafluorophenyl)borate, (4-diisopropylaluminumoxy-1-phenyl)tris(pentafluorophenyl)borate, (4-diisopropylaluminumoxy-3,5-di(trimethylsilyl)-1-phenyl)tris(pentafluorophenyl)borate, (4-diisopropylaluminumoxy-3,5-di(t-butyl)-1-phenyl)tris(pentafluorophenyl)borate, (4-diisopropylaluminumoxy-1-benzyl)tris(pentafluorophenyl)borate, (4-diisopropylaluminumoxy-3-methyl-1-phenyl)tris(pentafluorophenyl)borate, (4-diisoproylaluminumoxy-tetrafluoro-1-phenyl)tris(pentafluorophenyl)borate, (5-diisopropylaluminumoxy-2-naphthyl)tris(pentafluorophenyl)borate, 4-(4-diisopropylaluminumoxy-1-phenyl)phenyltris(pentafluorophenyl)borate, and 4-(2-(4-(diisopropylaluminumoxyphenyl)propane-2-yl)phenyloxy) tris(pentafluorophenyl)borate.

Especially preferred ammonium compounds are methyldi(tetradecyl)ammonium(4-diethylaluminumoxy-1-phenyl) tris(pentafluorophenyl)borate, methyldi(hexadecyl)ammonium(4-diethylaluminumoxy-1-phenyl)tris(pentafluorophenyl)borate, methyldi(octadecyl)ammonium(4-diethylaluminumoxy-1-phenyl) tris(pentafluorophenyl)borate, and mixtures thereof. The foregoing complexes are disclosed in U.S. Pat. Nos. 5,834,393 and 5,783,512.

Another suitable ion-forming, activating cocatalyst comprises a salt of a cationic oxidizing agent and a noncoordinating, compatible anion represented by the formula:
(Ox^{e+})_{d}(A^{d-})ₑ, wherein
Ox^{e+} is a cationic oxidizing agent having a charge of e+;
d is an integer from 1 to 3;
e is an integer from 1 to 3; and
A^{d-} is as previously defined.

Examples of cationic oxidizing agents include: ferrocenium, hydrocarbyl-substituted ferrocenium, Pb⁺² or Ag⁺. Preferred embodiments of A^{d-} are those anions previously defined with respect to the Bronsted acid containing activating cocatalysts, especially tetrakis (pentafluorophenyl)borate.

Another suitable ion-forming, activating cocatalyst comprises a compound which is a salt of a carbenium ion and a noncoordinating, compatible anion represented by the formula:
@⁺A⁻
wherein:
@⁺ is a C₁₋₂₀ carbenium ion; and
A⁻ is a noncoordinating, compatible anion having a charge of −1. A preferred carbenium ion is the trityl cation, especially triphenylmethylium.

Preferred carbenium salt activating cocatalysts are triphenylmethylium tetrakis(pentafluorophenyl)borate, triphenylmethylium tetrakis(nonafluorobiphenyl)borate, tritolylmethylium tetrakis(pentafluorophenyl)borate and ether substituted adducts thereof.

A further suitable ion-forming, activating cocatalyst comprises a compound which is a salt of a silylium ion and a noncoordinating, compatible anion represented by the formula:
R₃Si⁺A⁻
wherein:
R is C₁₋₁₀ hydrocarbyl; and
A⁻ is as previously defined.

Preferred silylium salt activating cocatalysts are trimethylsilylium tetrakis(pentafluorophenyl)borate, trimethylsilylium tetrakis(nonafluorobiphenyl)borate, triethylsilylium tetrakis(pentafluorophenyl)borate and other substituted adducts thereof.

Silylium salts have been previously generically disclosed in J. Chem Soc. Chem. Comm., 1993, 383-384, as well as Lambert, J. B., et al., Organometallics, 1994, 13, 2430-2443. The use of the above silylium salts as activating cocatalysts for addition polymerization catalysts is claimed in U.S. Pat. No. 5,625,087.

Certain complexes of alcohols, mercaptans, silanols, and oximes with tris(pentafluorophenyl)borane are also effective catalyst activators and may be used according to the present invention. Such cocatalysts are disclosed in U.S. Pat. No. 5,296,433.

The activating cocatalysts may also be used in combination. An especially preferred combination is a mixture of a tri(hydrocarbyl)aluminum or tri(hydrocarbyl)borane compound having from 1 to 4 carbons in each hydrocarbyl group with an oligomeric or polymeric alumoxane compound.

The molar ratio of catalyst/cocatalyst employed preferably ranges from 1:10,000 to 10:1, more preferably from 1:5000 to 10:1, most preferably from 1:2500 to 1:1. Alumoxane, when used by itself as an activating cocatalyst, is preferably employed in large molar ratio, generally at least 50 times the quantity of metal complex on a molar basis. Tris(pentafluorophenyl)borane, where used as an activating cocatalyst is preferably employed in a molar ratio to the metal complex of from 0.5:1 to 10:1, more preferably from 1:1 to 6:1 most preferably from 1:1 to 5:1. The remaining activating cocatalysts are generally preferably employed in approximately equimolar quantity with the metal complex.

The metal complex—activator—support material combinations which result from combination of the metal complex with an activator and a support material and the metal complex—activator—catalyst modifier—support material combinations which result from combination of the metal complex with an activator, a catalyst modifier and a support material to yield the supported catalyst including the activated metal complex and a non-coordinating or poorly coordinating, compatible anion have not previously been used for homopolymerization reactions of conjugated dienes.

If the above-mentioned non-coordinating or poorly coordinating anion is used as the cocatalyst, it is preferable for the metal complex according to the invention to be alkylated (that is, one of the R′ groups of the metal complex is an alkyl or aryl group). Cocatalysts comprising boron are preferred. Most preferred are cocatalysts comprising tetrakis(pentafluorophenyl)borate, tris(pentafluorophenyl)borane, tris(o-nonafluorobiphenyl)borane, tetrakis(3,5-bis(trifluoromethyl)phenyl)borate, tris(pentafluorophenyl)alumane, tris(o-nonafluorobiphenyl)alumane.

The molar ratio of the cocatalyst relative to the metal center in the metal complex in the case an organometallic compound is selected as the cocatalyst, usually is in a range of from about 1:10 to about 10,000:1, more preferably from 1:10 to 5000:1 and most preferably in a range of from about 1:1 to about 2,500:1. If a compound containing or yielding a non-coordinating or poorly coordinating anion is selected as cocatalyst, the molar ratio usually is in a range of from about 1:100 to about 1,000:1, and preferably is in range of from about 1:2 to about 250:1.

In addition to the metal complex according to the invention and the cocatalyst the catalyst composition optionally also contains a transition metal halide compound component that is used as a so-called polymerization accelerator and as a molecular weight regulator. Therefore, the transition metal halide compound is added to enhance the activity of the diene polymerization and enables a regulation of the average molecular weight of the resulting polydiene. This effect of the enhancement of the polymerization activity and the possibility to regulate the molecular weight of the resulting polymer can be achieved in homopolymerization reactions of dienes and copolymerization reactions of dienes with ethylenically unsaturated dienes such as for example but not limited to styrene. In particular the average molecular weight is reduced when transition metal halide compounds are used as components of the catalyst system.

The transition metal halide compound contains a metal atom of group 3 to 10 or a lanthanide or actinide metal connected to at least one of the following halide atoms: fluorine, chlorine, bromine or iodine. Preferably, the transition metal halide compound contains one of the following metal atoms: scandium, yttrium, titanium, zirconium, hafnium, vanadium, niobium, chromium, molybdenum, manganum, iron or a lanthanide metal and the halide atom is fluorine, chlorine or bromine. Even more preferably the transition metal halide compounds used for the synthesis of homopolymers are based on scandium, titanium, zirconium, hafnium, vanadium or chromium and the halide atom is chlorine. Even more preferably, the metal atom has the oxidation state of two, three, four, five or six. Further examples are all compounds resulting from the reaction of titanium or zirconium tetrachloride or vanadium trichloride, tetrachloride or pentachloride or scandium trichloride with Lewis bases such as but not limited to hydrocarbyl lithium, hydrocarbyl potassium, dihydrocarbyl magnesium or zinc or hydrocarbyl magnesium halide that contain titanium, zirconium, vanadium or scandium connected to one or more halide atoms.

Exemplary, but not limiting, transition metal halide compounds of the invention are: ScCl3, TiCl2, TiCl3, TiCl4, TiCl2*2 LiCl, ZrCl2, ZrCl2*2 LiCl, ZrCl4, VCl3, VCl5, CrCl2, CrCl3, CrCl5 and CrCl6.

Further examples are all compounds resulting from the reaction of the aforementioned transition metal halide compounds with Lewis bases such as but not limited to hydrocarbyl lithium, hydrocarbyl potassium, dihydrocarbyl magnesium or zinc or hydrocarbyl magnesium halide that contain titanium, zirconium, vanadium, chromium or scandium connected to one or more halide atoms wherein preferably the Lewis basis is selected from the group consisting of n-butyllithium, t-butyllithium, methyllithium, diethylmagnesium, ethylmagnesium halide.

The molar ratio of the transition metal halide compound relative to the metal center in the metal complex in the case that an organometallic compound is selected as the transition metal halide compound usually is in a range of about 1:100 to about 1,000:1, and preferably is in a range of about 1:2 to about 250:1.

In addition to the metal complex according to the invention and the cocatalyst cocatalyst and optionally the transition metal halide compound, the catalyst composition can also contain a small amount of another organometallic compound that is used as a so-called scavenger agent. The scavenger agent is added to react with impurities in the reaction mixture. It may be added at any time, but normally is added to the reaction mixture before addition of the metal complex and the cocatalyst. Usually organoaluminum compounds are used as scavenger agents. Examples of scavengers are trioctylaluminum, triethylaluminum and tri-isobutylaluminum. As a person skilled in the art would be aware, the metal complex as well as the cocatalyst can be present in the catalyst composition as a single component or as a mixture of several components. For instance, a mixture may be desired where there is a need to influence the molecular properties of the polymer, such as molecular weight distribution.

The metal complex according to the invention can be used for the (homo)polymerization of olefin monomers. The olefins envisaged in particular are dienes, preferably conjugated dienes. The metal complex according to the invention is particularly suitable for a process for the polymerization of one or more conjugated diene(s). Preferably the diene monomer(s) are chosen from the group comprising 1,3-butadiene, isoprene (2-methyl-1,3-butadiene), 2,3-dimethyl-1,3-butadiene, 1,3-pentadiene, 2,4-hexadiene, 1,3-hexadiene, 1,4-hexadiene, 1,3-heptadiene, 1,3-octadiene, 2-methyl-2,4-pentadiene, cyclopentadiene, 2,4-hexadiene, 1,3-cyclooctadiene, norbornadiene, ethylidenenorbornene. More preferably butadiene, isoprene and cyclopentadiene are used as the conjugated diene. The monomers needed for such products and the processes to be used are known to the person skilled in the art.

With the metal complex according to the invention, amorphous or rubber-like or rubber polymers can be prepared depending on the monomer or monomers used.

Polymerization of the diene monomer(s) can be effected in a known manner, in the gas phase as well as in a liquid reaction medium. In the latter case, both solution and suspension polymerization are suitable. The supported catalyst systems according to the invention are used mainly in gas phase and slurry processes and unsupported catalyst systems are used mainly in solution and gas phase processes. The quantity of metal to be used generally is such that its concentration in the dispersion agent amounts to 10⁻⁸-10⁻³ mol/l, preferably 10⁻⁷-10⁻⁴ mol/l. The polymerization process can be conducted as a gas phase polymerization (e.g. in a fluidized bed reactor), as a suspension/slurry polymerization, as a solid phase powder polymerization or as a so-called bulk polymerization process, in which an excess of olefinic monomer is used as the reaction medium. Dispersion agents may suitably be used for the polymerization, which be chosen from the group comprising, but not limited to, cycloalkanes such as cyclohexane; saturated, straight or branched aliphatic hydrocarbons, such as butanes, pentanes, hexanes, heptanes, octanes, pentamethyl heptane or mineral oil fractions such as light or regular petrol, naphtha, kerosine or gas oil. Also fluorinated hydrocarbon fluids or similar liquids are suitable for that purpose. Aromatic hydrocarbons, for instance benzene and toluene, can be used, but because of their cost as well as safety considerations, it is preferred not to use such solvents for production on a technical scale. In polymerization processes on a technical scale, it is preferred therefore to use low-priced aliphatic hydrocarbons or mixtures thereof, as marketed by the petrochemical industry as solvent. If an aliphatic hydrocarbon is used as solvent, the solvent may optionally contain minor quantities of aromatic hydrocarbon, for instance toluene. Thus, if for instance methyl aluminoxane (MAO) is used as cocatalyst, toluene can be used as solvent for the MAO in order to supply the MAO in dissolved form to the polymerization reactor. Drying or purification of the solvents is desirable if such solvents are used; this can be done without problems by one skilled in the art.

In the polymerization process the metal complex and the cocatalyst are used in a catalytically effective amount, i.e., any amount that successfully results in the formation of polymer. Such amounts may be readily determined by routine experimentation by the worker skilled in the art.

Those skilled in the art will easily understand that the catalyst compositions used in accordance with this invention may also be prepared in situ.

If a solution or bulk polymerization is to be used it is preferably carried out, typically, but not limited to, temperatures between 0° C. and 200° C.

The polymerization process can also be carried out under suspension or gasphase polymerization conditions which typically are at, but not limited to, temperatures below 150° C.

The polymer resulting from the polymerization can be worked up by a method known per se. In general the catalyst is deactivated at some point during the processing of the polymer. The deactivation is also effected in a manner known per se, e.g. by means of water or an alcohol. Removal of the catalyst residues can mostly be omitted because the quantity of catalyst in the homo- or copolymer, in particular the content of halogen and metal, is very low now owing to the use of the catalyst system according to the invention. If desired, however, the level of catalyst residues in the polymer can be reduced in a known manner, for example, by washing. The deactivation step can be followed by a stripping step (removal of organic solvent(s) from the (homo)polymer).

Polymerization can be effected at atmospheric pressure, at sub-atmospheric pressure, or at elevated pressures of up to 500 MPa, continuously or discontinuously. Preferably, the polymerization is performed at pressures between 0.01 and 500 MPa, most preferably between 0.01 and 10 MPa, in particular between 0.1-2 MPa. Higher pressures can be applied. In such a high-pressure process the metal complex according to the present invention can also be used with good results. Slurry and solution polymerization normally take place at lower pressures, preferably below 10 MPa.

The polymerization can also be performed in several steps, in series as well as in parallel. If required, the catalyst composition, temperature, hydrogen concentration, pressure, residence time, etc., may be varied from step to step. In this way it is also possible to obtain products with a wide property distribution, for example, molecular weight distribution. By using the metal complexes according to the present invention for the polymerization of olefins polymers are obtained with a polydispersity (Mw/Mn) of 1.0-50.

### EXAMPLES

It is understood that the present invention is operable in the absence of any component which has not been specifically disclosed. The following examples are provided in order to further illustrate the invention and are not to be constructed as limiting. Unless stated to the contrary, all parts and percentages are expressed on a weight basis. The term “overnight”, if used, refers to a time of approximately 16-18 hours, “room temperature”, if used, refers to a temperature of about 20-25° C.

All tests in which organometallic compounds were involved were carried out in an inert nitrogen atmosphere, using standard Schlenk equipment and techniques or in a glovebox. In the following ‘THF’ stands for tetrahydrofuran, ‘DME’ stands for 1,2-dimethoxyethane, ‘Me’ stands for ‘methyl’, ‘Et’ stands for ‘ethyl’, ‘Bu’ stands for ‘butyl’, ‘Ph’ stands for ‘phenyl’, ‘MMAO’ or ‘MMAO-3a’ stands for ‘modified methyl alumoxane’ and ‘PMAO-IP’ stands for ‘polymeric methyl alumoxane with improved performance’ both purchased from AKZO Nobel. ‘IBAO’ stands for ‘isobutylalumoxane’ and ‘MAO’ stands for ‘methylalumoxane’ both purchased from Albemarle. Pressures mentioned are absolute pressures. The polymerizations were performed under exclusion of moisture and oxygen in a nitrogen atmosphere. The products were characterized by means of SEC (size exclusion chromatography), Elemental Analysis, NMR (Avance 400 device (¹H=400 MHz; ¹³C=100 MHz) of Bruker Analytic GmbH) and IR (IFS 66 FT-IR spectrometer of Bruker Optics GmbH). The IR samples were prepared using CS₂ as swelling agent and using a two or fourfold dissolution. DSC (Differential Scanning Calorimetry) was measured using a DSC 2920 of TA Instruments.

Mn and Mw are molecular weights and were determined by universal calibration of SEC.

The ratio between the 1,4-cis-, 1,4-trans- and 1,2-polydiene content of the butadiene or isoprenepolymers was determined by IR and ¹³C-NMR-spectroscopy.

The glass transition temperatures of the polymers were determined by DSC determination.

### Example I

### 1. Preparation of Metal Complexes

### 1.1 Preparation of Neodymium Complex 1

The preparation of neodymium complex 1 was carried out according to D. C. Bradley, J. S. Ghotra, F. A. Hart, J. Chem. Soc., Dalton Trans. 1021 (1973)

### 1.2 Preparation of Neodymium Complex 4

### 1.2.1 Preparation of Neodymium Trichloride Tris(Tetrahydrofuran) 2

3.8 g (15.2 mmol) of neodymium trichloride was allowed to stand over THF. Atferwards the solid powder was extracted using THF solvent. The remaining THF solvent was removed under reduced pressure and 6.2 g (13.3 mmol) of the light blue neodymium trichloride tetrahydrofuran adduct 2 (NdCl₃*3 THF) were recovered.

### 1.2.2 Preparation of Disodium N,N′-diphenyl-1,2-diamido-ethane 3

10 g of N,N′-diphenylethylenediamine purchased from Merck KGaA (25 g bottle, purity 98%) were purified by extraction using n-pentane as solvent. 5.85 g (27.5 mmol) of the purified diamine were dissolved in 150 mL of THF. 0.72 g (27.5 mmol) of sodium hydride were added at 0° C. The reaction mixture was allowed to warm up to ambient temperature and stirred for approximately one week. The THF solvent was removed under reduced pressure. The solid residue was stirred for one day in 150 mL of hexane, and then the solution was filtered using an inert glass frit. The clear colorless solution was evaporated under reduced pressure. 6.3 g (24.5 mmol) of disodium N,N′-diphenyl-1,2-diamido-ethane 3 were obtained.

¹H-NMR (360.1 MHz, d⁸-THF): δ=6.81 (m, 4H, H-Ph); 6.33 (m, 4H, H-Ph); 5.86 (m, 2H, H-Ph); 3.26 (s, 4H, H—(CH₂)₂-bridge).

¹³C-NMR (90.5 MHz, d⁸-THF): δ=162.9 (q, 2C, C-Ph); 129.6 (d, 4C, C-Ph); 112.8 (d, 4C, C-Ph); 109.5 (d, 2C, C-Ph); 50.9 (t, 2C, C—(CH₂)₂-bridge)

### 1.2.3 Preparation of Neodymium Complex 4

3.64 g (7.8 mmol) of 2 were suspended in 15 mL of DME and cooled to −78° C. 2 g (7.8 mmol) of 3 were dissolved in 50 mL of DME, cooled down to −30° C. and added to the suspension of 2 in THF. This resulting suspension was allowed to warm up to ambient temperature within three hours and stirred for one further day. As result of the subsequent filtration, a solid light blue powder remained on the filter. This crude product was washed with 20 mL of DME and then dried under reduced pressure. 5.4 g of complex 4 were obtained.

### 1.3 Preparation of Neodymium Complex 5

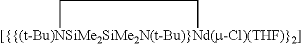

The preparation of neodymium complex 5 was carried out according to Shah S. A. A., Dom, H., Roesky H. W., Lubini P., Schmidt H.-G., Inorg. Chem., 36 (1997) 1102-1106.

### 1.4 Preparation of Neodymium tris[bis(phenyldimethylsilyl)amide] 6 [Nd{N(SiPhMe₂)₂}₃]

### 1.4.1 Preparation of Lithium bis(phenyldimethylsilyl)amide [LiN(SiPhMe₂)₂] 6a

A solution of 31.3 mL (1.6 M, 50.0 mmol) of n-butyl lithium in n-hexane was added to a solution of 11.4 g (40.0 mmol) of bis(phenyldimethylsilyl)amine in about 500 mL of n-hexane. The reaction mixture was stirred for about 48 hours. The resulting lithium salt was filtered off and the volatiles were removed under reduced pressure. The resulting white solid was washed with n-pentane and then dried under reduced pressure to give 10.0 g (34.4 mmol, 86.1%) of 6a.

### 1.4.2 Preparation of Neodymium tris[bis(phenyldimethylsilyl)amide] 6 [Nd{N(SiPhMe₂)₂}₃]

The preparation of neodymium complex 6 was carried analogous to that of [Nd{N(SiMe₃)₂}₃] described in D. C. Bradley, J. S. Ghotra, F. A. Hart, J. Chem. Soc., Dalton Trans. 1021 (1973).

using lithium bis(phenyldimethylsilyl)amid (LiN(SiPhMe₂)₂ instead of lithium bis(trimethylsilyl)amide (LiN(SiMe₃)₂) in combination with neodymium trichloride tris(tetrahydrofuran)(NdCl₃ 3 THF).

2.65 g (6.7 mmol) Neodymium trichloride tetrahydrofuran adduct (NdCl₃*3 THF) were combined with about 300 mL of THF and the resulting slurry was stirred for two hours. 5.8 g (20.0 mmol) of lithium bis(phenyldimethylsilyl)amid (LiN(SiPhMe₂)₂ 6a dissolved in 100 mL THF were added under rapid formation of a dark blue color. After stirring for several days, the THF solvent was removed under reduced pressure and the remaining oil was redissolved in n-hexane two times and dried under reduced pressure. Finally all volatiles were removed under reduced pressure using a high vacuum device.

The resulting product proved to be clean according to ¹H-NMR.

Yield of 6 was 6.2 g (6.2 mmol, 92%) in the form of a dark blue oil 6.

¹H-NMR (360.1 MHz, C₆D₆): δ=7.54 (m, 2H, H-Ph); 7.22 (m, 3H, H-Ph); 0.26 (s, 6H, CH₃).

### 1.5 Preparation of Neodymium tris[(2-(N,N-dimethylamino)ethyl)(methyl)-amide]

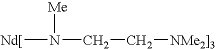

The preparation of neodymium complex 7 was carried out analogous to that of Nd{N(SiMe₃)₂}₃ described in D. C. Bradley, J. S. Ghotra, F. A. Hart, J. Chem. Soc., Dalton Trans. 1021 (1973)^{e}

using lithium (2-(N,N-dimethylamino)ethyl)(methyl)amide (LiN(CH₃)((CH₂)₂N(CH₃)₂) instead of lithium bis(trimethylsilyl)amide (LiN(SiMe₃)₂) in combination with neodymium trichloride tris(tetrahydrofuran)(NdCl₃ 3 THF).

1.3 g, (2.2 mmol) of neodymium trichloride tris(tetrahydrofuran) adduct (NdCl₃*3 THF) were combined with about 200 mL of THF and the resulting slurry was stirred for two hours. 0.7 g (6.7 mmol) of lithium (2-(N,N-dimethylamino)ethyl)(methyl)amide (LiN(CH₃)((CH₂)₂N(CH₃)₂) dissolved in 100 mL THF was added under rapid formation of a light blue color. After stirring for one week, the THF solvent was removed under reduced pressure and the solid was washed two times with pentane and dried under reduced pressure. The solid compound was then dissolved in toluene and subsequently crystallized by diffusion of pentane into toluene. The blue microcrystals obtained were filtered off and all volatiles were removed under reduced pressure.

0.6 g (1.4 mmol, 64%) of the blue product 7 were obtained.

### 1.6 Preparation of tris(2-N,N-dimethylaminobenzyl)neodymium 9

### 1.61 Preparation of [2-N,N-dimethylaminobenzyl)lithium 8

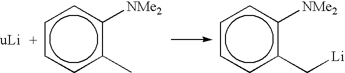

A solution of 75.44 mL (1.6 M, 120.7 mmol) of butyl lithium in n-hexane was added to a solution of 15.544 g (115.0 mmol) of N,N-dimethyl-o-toluidine in 250 mL of n-hexane. 30 mL of diethyl ether were added and the reaction solution was heated to reflux for 20 hours. The resulting yellow slurry was filtered, the solid was washed with n-hexane and dried under reduced pressure to give 11.7 g (72.1%) of the product as a lemon-yellow powder.

### 1.62 Preparation of tris(2-N,N-dimethylaminobenzyl)neodymium 9

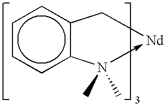

Neodymium chloride (2.0204 g, 8.06 mmol) was combined with 100 mL of THF and the resulting slurry was refluxed overnight. After cooling to ambient temperature, 3.584 g (25.40 mmol) of solid (2-N,N-dimethylaminobenzyl)lithium 8 were added under rapid formation of a dark color. After stirring for several days, the resulting brown-orange solution was filtered. The volatiles were removed under reduced pressure. The residue was extracted with toluene, filtered and again the volatiles were removed under reduced pressure to give 1.7710 g (40.2%) of a deep brown powder which is insoluble in n-hexane.

### 1.7 Neodymium Versatate 10

Neodymium versatate (NEO CEM 250, neodymium salt of 2-ethylhexanoic acid) was obtained from OMG as a solution of the neodymium complex (12% neodymium) in mineral oil.

### 2. Polymerization Using Unsupported Catalysts

### 2.1 Description of the Polymerization Procedure

### 2.1.1 Description of the Polymerization Procedure—Method 1

The polymerizations were performed in a double wall 2 L steel reactor, which was purged with nitrogen before the addition of organic solvent, metal complex, activator(s), optional Lewis acids, optional transition metal halide compounds or other components. The polymerization reactor was tempered to 80° C. if not stated otherwise. The following components were then added in the following order: organic solvent, a portion of the activator 1, conjugated diene monomer(s) and the mixture was allowed to stir for one hour.

In a separate 200 mL double wall steel reactor, which was tempered to the same temperature as the polymerization reactor if the temperature value did not exceed 80° C. (if higher temperatures were chosen for the polymerization process, the 200 mL reactor was still tempered to 80° C.), the following components were added in the following order: organic solvent and a portion of the activator 1 and the mixture was stirred for 0.5 hours. Then optionally a second activator component and/or Lewis acid and/or transition metal halide and subsequently the metal complex were added and the resulting mixture was allowed to stir for an additional 30 minutes. The polymerization was started through addition of the contents of the 200 mL steel reactor into the 2 L polymerization vessel. The polymerization was performed at a 80° C. unless stated otherwise. The polymerization time varied depending on the experiment.

For the termination of the polymerization process, the polymer solution was transferred into a third double wall steel reactor containing 50 mL of methanol containing lonol as stablizer for the polymer (1 L of methanol contains 2 g of lonol). This mixture was stirred for 15 minutes. The recovered polymer was then stripped with steam for 1 hour to remove solvent and other volatiles and dried in an oven at 45° C. for 24 hours.

### 2.1.2 Description of the Polymerization Procedure—Method 2

The polymerizations were performed in a double wall 2 L steel reactor, which was purged with nitrogen before the addition of organic solvent, metal complex, activator(s), Lewis acids or other components. The polymerization reactor was tempered to 80° C. unless stated otherwise. The following components were then added in the following order: organic solvent, the activator 1, conjugated diene monomer(s) and the mixture was allowed to stir for one hour. Then the following components were added in the following order into the 2 L steel reactor: optionally a second activator component and/or Lewis acid and subsequently the metal complex was added to start the polymerization.

The polymerization was performed at 80° C. unless stated otherwise. The polymerization time varied depending on the experiment.

For the termination of the polymerization process, the polymer solution was transferred into a third double wall steel reactor containing 50 mL of methanol containing lonol as stablizer for the polymer (1 L of methanol contains 2 g of lonol). This mixture was stirred for 15 minutes. The recovered polymer was then stripped with steam for 1 hour to remove solvent and other volatiles and dried in an oven at 45° C. for 24 hours.

### 3 Polymerization Examples Using Unsupported Catalysts

### 3.1 Polymerization of 1,3-butadiene

### 3.1.1 Polymerization of 1,3-butadiene Giving High Cis Polybutadiene

A) Polymerization of 1,3-butadiene Using Complex 4 and MMAO-3a (Run 1)

The experiment was carried out according to the general polymerization procedure described above (2.1.1). The polymerization was carried out in 510 g of cyclohexane solvent. Thus 409 g of cyclohexane, 54.1 g (1.0 mol) of 1,3-butadiene monomer and MMAO (5.9 g of a heptane solution containing 15.0 mmol of MMAO) were added into the polymerization reactor. 101 g of cyclohexane and 5.9 g of a heptane solution containing 15.0 mmol of MMAO were mixed with 156 mg (0.40 mmol) of the metal complex 4 in a separate reaction vessel and stirred for 10 minutes.

Afterwards the resulting mixture was transferred into the polymerization reactor to start the polymerization reaction.

After one hour and 45 minutes the polymerization reaction was terminated as described above (see 2.1.1). At this point, the conversion level of the monomers into polybutadiene was 79.5%. 43.0 g of polybutadiene were recovered as result of the stripping process.

The polymer contained 94.8% cis-1,4-; 4.3% trans-1,4-, 0.9% 1,2-polybutadiene according to ¹³C-NMR determination.

The molecular weight of the polymer amounted to 630,500 g/mol and the polydispersity (molecular weight distribution) amounted to 13.25. (Mₙ=47,500; M_{z}=2,645,000).

The Mooney value amounted to 35.9 and the glass transition temperature amounted to −106.9° C.

B) Polymerization Using Metal Complex 1 and MMAO-3a (Run 2)

The experiment was carried out according to the general polymerization procedure described above (2.1.1). The polymerization was carried out in 511.2 g of cyclohexane solvent. Thus 410.5 g of cyclohexane, 54.1 g (1.0 mol) of 1,3-butadiene monomer and MMAO (5.9 g of a heptane solution containing 15.0 mmol of MMAO) were added into the polymerization reactor. 100.8 g of cyclohexane and 5.8 g of a heptane solution containing 15.0 mmol of MMAO were mixed with 64.1 mg (0.1 mmol) of the metal complex 1 in a separate reaction vessel and stirred for 10 minutes.

Afterwards the resulting mixture was transferred into the polymerization reactor to start the polymerization reaction.

After 10 minutes the conversion level of the monomers into polybutadiene was 15.0% (polymerization activity: 0.49 kg [BR]/mmol [Cat] hr), after 20 minutes 21.1% (0.34 kg [BR]/mmol [Cat] hr), after 30 minutes 27.7% (0.30 kg [BR]/mmol [Cat] hr) and after 45 minutes 31.6% % (0.23 kg [BR]/mmol [Cat] hr).

After 1 hour and 20 minutes the polymerization reaction was terminated as described above (see 2.1.1). At this point, the conversion level of the monomers into polybutadiene was 47.6%. 25.7 g of polymer were recovered as result of the stripping process.

The polymer contained 97.0% cis-1,4-; 1.2% trans-1,4-, 1.8% 1,2-polybutadiene according to ¹³C-NMR determination.

The molecular weight of the polymer amounted to 863,000 g/mol and the polydispersity (molecular weight distribution) amounted to 7.85. (Mₙ=110,000; M_{z}=2,450,000). The glass transition temperature amounted to −106.9° C.

C) Polymerization Using Metal Complex 1 and MMAO-3a (Run 3)

The experiment was carried out according to the general polymerization procedure described above (2.1.1). The polymerization was carried out in 533.6 g of cyclohexane solvent. Thus, 430.6 g of cyclohexane, 54.6 g (1.01 mol) of 1,3-butadiene monomer and MMAO (12.0 g of a heptane solution containing 30.4 mmol of MMAO) were added into the polymerization reactor. 103.0 g of cyclohexane, 11.9 g of a heptane solution containing 30.4 mmol of MMAO and 2.13 g (8.6 mmol) of triethylaluminumsesquichloride (Et₃Al₂Cl₃) were mixed with 64.1 mg (0.1 mmol) of the metal complex 1 in a separate reaction vessel and stirred for 10 minutes. Afterwards the resulting mixture was transferred into the polymerization reactor to start the polymerization reaction.

After 3 hours and 5 minutes the polymerization reaction was terminated as described above (see 2.1.1). At this point, the conversion level of the monomers into polybutadiene was 18.9%. 10.3 g of polymer were recovered as result of the stripping process.

The polymer contained 94.5% cis-1,4-; 3.5% trans-1,4-, 2.0% 1,2-polybutadiene according to ¹³C-NMR determination.

The molecular weight of the polymer amounted to 246,000 g/mol and the polydispersity (molecular weight distribution) amounted to 2.73. (Mₙ=90,000; M_{z}=634,000).

D) Polymerization Using Metal Complex 1 and PMAO-IP and Diethylaluminum Chloride

(Run 4)

The experiment was carried out according to the general polymerization procedure described above (2.1.1). The polymerization was carried out in 606.4 g of toluene solvent at 30° C. Thus 450.6 g of toluene, 54.1 g (1.0 mol) of 1,3-butadiene monomer and PMAO-IP (1.05 g of a toluene solution containing 5.0 mmol of PMAO-IP) were added into the polymerization reactor. 155.8 g of toluene, 1.05 g of a toluene solution containing 5.0 mmol of PMAO-IP and 27.6 mg (0.23 mmol) diethylaluminum chloride were mixed with 64.1 mg (0.1 mmol) of the metal complex 1 in a separate reaction vessel and stirred for 1 hour.

Afterwards the resulting mixture was transferred into the polymerization reactor to start the polymerization reaction.

After 2 hours the polymerization reaction was terminated as described above (see 2.1.1). At this point, the conversion level of the monomers into polybutadiene was 27.0%. 14.6 g of polymer were recovered as result of the stripping process. The polymer contained 92.5% cis-1,4-; 6.0% trans-1,4-, 1.5% 1,2-polybutadiene according to ¹³C-NMR determination.

The molecular weight of the polymer amounted to 1,074,000 g/mol and the polydispersity (molecular weight distribution) amounted to 2.51. (Mₙ=428,000; M_{z}=1,814,000).

E) Polymerization Using Metal Complex 1 and MMAO-IP and Diethylaluminum Chloride (Run 5)

The experiment was carried out according to the general polymerization procedure described above (2.1.1). The polymerization was carried out in 605.4 g of toluene solvent at 30° C. Thus, 451.4 g of toluene, 52.9 g (0.98 mol) of 1,3-butadiene monomer and MMAO-3a (2.9 g of a heptane solution containing 7.5 mmol of MMAO) were added into the polymerization reactor. 154.0 g of toluene, 2.8 g of a heptane solution containing 7.5 mmol of MMAO and 27.6 mg (0.23 mmol) of diethylaluminum chloride were mixed with 64.1 mg (0.1 mmol) of the metal complex 1 in a separate reaction vessel and stirred for 1 hour.

Afterwards the resulting mixture was transferred into the polymerization reactor to start the polymerization reaction.

After 2 hours the polymerization reaction was terminated as described above (see 2.1.1). At this point, the conversion level of the monomers into polybutadiene was 16.8%. 8.9 g of polymer were recovered as result of the stripping process.

The polymer contained 96.7% cis-1,4-; 2.6% trans-1,4-, 0.7% 1,2-polybutadiene according to ¹³C-NMR determination.

The molecular weight of the polymer amounted to 1,050,000 g/mol and the polydispersity (molecular weight distribution) amounted to 2.42. (Mⁿ=433,000; M_{z}=1,752,000).

F) Polymerization Using Metal Complex 6 and MMAO-3a and tris(pentafluorophenyl)borane [B(C₆F₅)₃] (Run 20)

The experiment was carried out according to the general polymerization procedure described above (2.1.1). The polymerization was carried out in 603.4 g of cyclohexane solvent at 80° C. Thus 500.3 g of cyclohexane, 55.4 g (1.01 mol) of 1,3-butadiene monomer and MMAO (2.9 g of a heptane solution containing 7.25 mmol of MMAO) were added into the polymerization reactor. 103.1 g of cyclohexane, 2.9 g of a heptane solution containing 7.25 mmol of MMAO and 52.2 mg (0.1 mmol) of tris(pentafluorophenyl)borane [B(C₆F₅)₃] were mixed with 99.0 mg (0.0993 mmol) of the metal complex 6 in a separate reaction vessel and stirred for 30 minutes.

Afterwards the resulting mixture was transferred into the polymerization reactor to start the polymerization reaction.

After two hours the polymerization reaction was terminated as described above (see 2.1.1). At this point, the conversion level of the monomers into polybutadiene was 53.1%. 29.4 g of polymer were recovered as result of the stripping process. The polymer contained 97.3% cis-1,4-; 1.4% trans-1,4-, 1.3% 1,2-polybutadiene according to ¹³C-NMR determination.

The molecular weight of the polymer amounted to 772,500 g/mol and the polydispersity (molecular weight distribution) amounted to 3.27. (Mₙ=236,500; M_{z}=1,908,000). The Mooney value amounted to 115.5.

G) Polymerization Using Metal Complex 7 and MMAO- MMAO-3a and tris(pentafluorophenyl)borane [B(C₆F₅)₃] (Run 21)

The experiment was carried out according to the general polymerization procedure described above (2.1.1). The polymerization was carried out in 605.6 g of cyclohexane solvent at 80° C. Thus 498.3 g of cyclohexane, 55.6 g (1.01 mol) of 1,3-butadiene monomer and MMAO-3a (5.9 g of a heptane solution containing 15 mmol of MMAO) were added into the polymerization reactor. 107.3 g of cyclohexane, 5.9 g of a heptane solution containing 15 mmol of MMAO and 53.2 mg (0.102 mmol) of tris(pentafluorophenyl)borane [B(C₆F₅)₃] were mixed with 40.7 mg (0.1005 mmol) of the metal complex 7 in a separate reaction vessel and stirred for 30 minutes.

Afterwards the resulting mixture was transferred into the polymerization reactor to start the polymerization reaction.

After three hours the polymerization reaction was terminated as described above (see 2.1.1). At this point, the conversion level of the monomers into polybutadiene was 60.4%. 33.0 g of polymer were recovered as result of the stripping process. The polymer contained 94.0% cis-1,4-; 3.0% trans-1,4-, 3.0% 1,2-polybutadiene according to ¹³C-NMR determination.

The molecular weight of the polymer amounted to 601,500 g/mol and the polydispersity (molecular weight distribution) amounted to 4.42. (Mₙ=136,000; M_{z}=2,131,000). The Mooney value amounted to 53.4.

H) Polymerization Using Metal Complex 1 and IBAO and tris(pentafluorophenyl)borane [B(C₆F₅)₃] (Run 22)

The experiment was carried out according to the general polymerization procedure described above (2.1.1). The polymerization was carried out in 606.2 g of cyclohexane solvent at 30° C. Thus 503.8 g of cyclohexane, 56.5 g (1.04 mol) of 1,3-butadiene monomer and IBAO (4.4 g of a heptane solution containing 7.25 mmol of MMAO) were added into the polymerization reactor. 102.4 g of cyclohexane, 4.4 g of a heptane solution containing 15 mmol of IBAO and 51.2 mg (0.100 mmol) of tris(pentafluorophenyl)borane [B(C₆F₅)₃] were mixed with 63.7 mg (0.0994 mmol) of the metal complex 1 in a separate reaction vessel and stirred for one hour.

Afterwards the resulting mixture was transferred into the polymerization reactor to start the polymerization reaction.

After one hour the polymerization reaction was terminated as described above (see 2.1.1). At this point, the conversion level of the monomers into polybutadiene was 89.6%. 50.6 g of polymer were recovered as result of the stripping process. The polymer contained 95.7% cis-1,4-; 3.6% trans-1,4-, 0.7% 1,2-polybutadiene.

The molecular weight of the polymer amounted to 829,000 g/mol and the polydispersity (molecular weight distribution) amounted to 2.54. (Mₙ=326,000; M_{z}=1,368,000). The Mooney value amounted to 120.4.

### 3.1.2 Polymerization of 1,3-butadiene Giving High Trans Content Polybutadiene

A) Polymerization Using Metal Complex 1 and MMAO-3a and B(C₆F₅)₃ (Run 6)

The experiment was carried out according to the general polymerization procedure described above (2.1.1). The polymerization was carried out in 512.7 g of toluene solvent at 30° C. Thus 400.2 g of toluene, 54.0 g (1.0 mol) of 1,3-butadiene monomer and MMAO (2.8 g of a heptane solution containing 7.25 mmol of MMAO) were added into the polymerization reactor. 112.5 g of toluene, 2.8 g of a heptane solution containing 7.25 mmol of MMAO and 52.2 mg (0.1 mmol) of tris(pentafluorophenyl)borane [B(C₆F₅)₃] were mixed with 64.1 mg (0.1 mmol) of the metal complex 1 in a separate reaction vessel and stirred for 50 minutes. Afterwards the resulting mixture was transferred into the polymerization reactor to start the polymerization reaction.

After 40 minutes the polymerization reaction was terminated as described above (see 2.1.1). At this point, the conversion level of the monomers into polybutadiene was 83.5%. 45.1 g of polymer were recovered as result of the stripping process. The polymer contained 50.0% trans-1,4-, 46.0% cis-1,4-; 4.0% 1,2-polybutadiene according to ¹³C-NMR determinationR.

The molecular weight of the polymer amounted to 279,000 g/mol and the polydispersity (molecular weight distribution) amounted to 3.1. (Mₙ=90,000; M₂=895,000). The Mooney value amounted to 33.2.

B) Polymerization Using Metal Complex 1 and Trioctylaluminum and B(C₆F₅)₃ (Run 7)

The experiment was carried out according to the general polymerization procedure described above (2.1.1). The polymerization was carried out in 692.5 g of toluene solvent at 30° C. Thus 550.2 g of toluene, 53.8 g (0.99 mol) of 1,3-butadiene monomer and trioctylaluminum (8.15 g of a hexane solution containing 5.62 mmol of trioctylaluminum) were added into the polymerization reactor. 142.3 g of toluene, 8.15 g of a hexane solution containing 5.62 mmol of trioctylaluminum and 156.6 mg (0.3 mmol) of tris(pentafluorophenyl)borane [B(C₆F₅)₃] were mixed with 64.1 mg (0.1 mmol) of the metal complex 1 in a separate reaction vessel and stirred for 40 minutes.

Afterwards the resulting mixture was transferred into the polymerization reactor to start the polymerization reaction.

After 4 hours and 30 minutes the polymerization reaction was terminated as described above (see 2.1.1). At this point, the conversion level of the monomers into polybutadiene was 75.3%. 40.5 g of polymer were recovered as result of the stripping process.

The polymer contained 57.5% trans-1,4-, 39.5% cis-1,4-; 3.0% 1,2-polybutadiene according to ¹³C-NMR determination.

The molecular weight of the polymer amounted to 80,000 g/mol and the polydispersity (molecular weight distribution) amounted to 2.96. (Mₙ=27,000; M_{z}=192,000).

### 3.1.3 Polymerization of 1,3-butadiene Using Different Neodymium Complexes

A) Polymerization of 1,3-butadiene Using Metal Complex 1 and MMAO-3a (Run 8)

The experiment was carried out according to the general polymerization procedure described above (2.1.1). The polymerization was carried out in 692.0 g of cyclohexane solvent. Thus 600.5 g of cyclohexane, 56.6 g (1.1 mol) of 1,3-butadiene monomer and MMAO (6.0 g of a heptane solution containing 15.2 mmol of MMAO) were added into the polymerization reactor. 91.5 g of cyclohexane and 5.9 g of a heptane solution containing 15.1 mmol of MMAO were mixed with 64.1 mg (0.1 mmol) of the metal complex 1 in a separate reaction vessel and stirred for 10 minutes.

Afterwards the resulting mixture was transferred into the polymerization reactor to start the polymerization reaction.

After 2 hours and 10 minutes the polymerization reaction was terminated as described above (see 2.1.1). At this point, the conversion level of the monomers into polybutadiene was 85.5%. 48.4 g of polymer were recovered as result of the stripping process.

The polymer contained according to ¹³C-NMR determination 84.0% cis-1,4-; 14.5% trans-1,4-, 1.5% 1,2-polybutadiene according to ¹³C-NMR determination.

The molecular weight of the polymer amounted to 839,000 g/mol and the polydispersity (molecular weight distribution) amounted to 3.66. (Mₙ=229,000; M_{z}=1,695,000). The Mooney value amounted to 89.7.

B) Polymerization Using Metal Complex 5 in Combination with MMAO-3a (Run 9)

The experiment was carried out according to the general polymerization procedure described above (2.1.1). The polymerization was carried out in 538.0 g of cyclohexane solvent. Thus 450.5 g of cyclohexane, 55.7 g (1.03 mol) of 1,3-butadiene monomer and MMAO (11.6 g of a heptane solution containing 30 mmol of MMAO) were added into the polymerization reactor. 87.5 g of cyclohexane, 11.6 g of a heptane solution containing 30 mmol of MMAO and 102.4 mg (0.20 mmol) of tris(pentafluorophenyl)borane [B(C₆F₅)₃] were mixed with 99.6 mg (0.2 mmol) of the metal complex 5 in a separate reaction vessel and stirred for 10 minutes. Afterwards the resulting mixture was transferred into the polymerization reactor to start the polymerization reaction.

After 3 hours and 20 minutes the polymerization reaction was terminated as described above (see 2.1.1). At this point, the conversion level of the monomers into polybutadiene was 34.5%. 19.2 g of polymer were recovered as result of the stripping process.

The polymer contained 73.0% cis-1,4-; 23.5% trans-1,4-, 3.5% 1,2-polybutadiene according to ¹³C-NMR determination.

The molecular weight of the polymer amounted to 257,000 g/mol and the polydispersity (molecular weight distribution) amounted to 8.57. (Mn=30,000; M=1,530,000). The Mooney value amounted to 53.7.

C) Polymerization Using Metal Complex 9 in Combination with PMAO-IP (Run 10)

The experiment was carried out according to the general polymerization procedure described above (2.1.2). The polymerization was carried out in 500 g of cyclohexane solvent at 40° C. Thus 500 g of cyclohexane, 50 g (0.9 mol) of 1,3-butadiene monomer and PMAO-IP (6.22 g of a toluene solution containing 30 mmol of PMAO-IP) were added into the polymerization reactor. The addition of 54.7 mg (0.1 mmol) of the metal complex 9 into the polymerization reactor started the polymerization reaction.

After 3 hours the polymerization reaction was terminated as described above (see 2.1.2). At this point, the conversion level of the monomers into polybutadiene was 18.2%. 9.1 g of polymer were recovered as result of the stripping process.

The polymer contained 84.5% cis-1,4-; 9.0% trans-1,4-, 6.5% 1,2-polybutadiene according to ¹³C-NMR determination.

The molecular weight of the polymer amounted to 2,587,000 g/mol and the polydispersity (molecular weight distribution) amounted to 13.9. (Mₙ=186,000; M_{z}=6,768,000).

D) Polymerization Using Metal Complex 6 in Combination with MMAO-3a/B(C₆F₅)₃ (Run 11)

The experiment was carried out according to the general polymerization procedure described above (2.1.2). The polymerization was carried out in 600 g of toluene solvent. Thus 600 g of toluene, 54.3 g (1.0 mol) of 1,3-butadiene monomer, MMAO-3a (5.8 g of a heptane solution containing 15 mmol of MMAO-3a) and 52.2 mg (0.10 mmol) of tris(pentafluorophenyl)borane [B(C₆F₅)₃] were added into the polymerization reactor. The addition of 99.7 mg (0.1 mmol) of the metal complex 6 into the polymerization reactor started the polymerization reaction.

After three hours and six minutes the polymerization reaction was terminated as described above (see 2.1.2). At this point, the conversion level of the monomers into polybutadiene was 44.8%. 24.3 g of polymer were recovered as result of the stripping process.

The polymer contained 62.0% cis-1,4-; 35.0% trans-1,4-, 3.0% 1,2-polybutadiene according to ¹³C-NMR determination.

The molecular weight of the polymer amounted to 127,000 g/mol and the polydispersity (molecular weight distribution) amounted to 2.89. (Mₙ=44,000; M_{z}=383,000).

E) Polymerization Using Metal Complex 7 in Combination with MMAO-3a/B(C₆F₅)₃ (Run 12)

The experiment was carried out according to the general polymerization procedure described above (2.1.2). The polymerization was carried out in 600 g of toluene solvent. Thus 600 g of toluene, 54.1 g (1.0 mol) of 1,3-butadiene monomer, MMAO-3a (5.8 g of a heptane solution containing 15 mmol of MMAO-3a) and 52%2 mg (0.10 mmol) of tris(pentafluorophenyl)borane [B(C₆F₅)₃] were added into the polymerization reactor. The addition of 40.5 mg (0.1 mmol) of the metal complex 7 into the polymerization reactor started the polymerization reaction.

After three hours and nine minutes the polymerization reaction was terminated as described above (see 2.1.2). At this point, the conversion level of the monomers into polybutadiene was 52.9%. 28.6 g of polymer were recovered as result of the stripping process.

The polymer contained 55.5% cis-1,4-; 41.0% trans-1,4-, 3.5% 1,2-polybutadiene according to ¹³C-NMR determination.

The molecular weight of the polymer amounted to 113,000 g/mol and the polydispersity (molecular weight distribution) amounted to 2.51. (Mₙ=45,000; M_{z}=368,000). The Mooney value amounted to 2.6.

F) Polymerization Using Metal Complex 4 in Combination with MMAO-3a (see Run 1 above)

### 3.1.4 Polymerization of 1,3-butadiene Using Different Cocatalysts or Cocatalyst Mixtures

A) Polymerization Using Metal Complex 1 in Combination with MAO (Run 13)

The experiment was carried out according to the general polymerization procedure described above (2.1.1). The polymerization was carried out in 557 g of cyclohexane solvent. Thus 459 g of cyclohexane, 82.0 g (1.52 mol) of 1,3-butadiene monomer and MAO (0.725 g of a toluene solution containing 3.75 mmol of MAO) were added into the polymerization reactor. 101 g of cyclohexane and 0.725 g of a toluene solution containing 3.75 mmol of MAO were mixed with 64.1 mg (0.1 mmol) of the metal complex 1 in a separate reaction vessel and stirred for 10 minutes.

Afterwards the resulting mixture was transferred into the polymerization reactor to start the polymerization reaction.

After one hour 45 minutes the polymerization reaction was terminated as described above (see 2.1.1). At this point, the conversion level of the monomers into polybutadiene was 83.0%. 60.3 g of polybutadiene were recovered as result of the stripping process.

The polymer contained 94.8% cis-1,4-; 14.0% trans-1,4-, 3.0% 1,2-polybutadiene according to ¹³C-NMR determination.

The molecular weight of the polymer amounted to 660,500 g/mol and the polydispersity (molecular weight distribution) amounted to 32. (Mₙ=206,000; M_{z}=1,520,000).

The Mooney value amounted to 59.6.

B) Polymerization Using Metal Complex 1 in Combination with MMAO-3a and (CPh₃][B(C₆F₅)₄] (Run 14)

The experiment was carried out according to the general polymerization procedure described above (2.1.1). The polymerization was carried out in 603.9 g of cyclohexane solvent. Thus 505.5 g of cyclohexane, 54.0 g (1.0 mol) of 1,3-butadiene monomer and MMAO (2.9 g of a heptane solution containing 7.5 mmol of MMAO) were added into the polymerization reactor. 98.4 g of cyclohexane, 2.9 g of a heptane solution containing 7.5 mmol of MMAO and and 92.2 mg (0.10 mmol) of triphenylcarbonium tetrakis(pentafluorophenyl)boranat [CPh₃][B(C₆F₅)₄] were mixed with 64.1 mg (0.1 mmol) of the metal complex 1 in a separate reaction vessel and stirred for 20 minutes.

Afterwards the resulting mixture was transferred into the polymerization reactor to start the polymerization reaction.

After 1 hours and 5 minutes the polymerization reaction was terminated as described above (see 2.1.1). At this point, the conversion level of the monomers into polybutadiene was 74.3%. 40.1 g of polymer were recovered as result of the stripping process.

The polymer contained 71.0% cis-1,4-; 26.0% trans-1,4-, 3.0% 1,2-polybutadiene according to ¹³C-NMR determination.

The molecular weight of the polymer amounted to 461,000 g/mol and the polydispersity (molecular weight distribution) amounted to 3.41. (Mₙ=135,000; M_{z}=1,165,000). The Mooney value amounted to 64.9.

C) Polymerization Using Metal Complex 1 in Combination with MMAO-3a and [B(C₆F₅)₃] (Run 15)

The experiment was carried out according to the general polymerization procedure described above (2.1.1). The polymerization was carried out in 600.4 g of toluene solvent. Thus 504.5 g of toluene, 52.6 g (0.97 mol) of 1,3-butadiene monomer and MMAO-3a (2.9 g of a heptane solution containing 7.5 mmol of MMAO-3a) were added into the polymerization reactor. 95.9 g of toluene, 2.8 g of a heptane solution containing 7.5 mmol of MMAO-3a and and 52.2 mg (0.10 mmol) of tris(pentafluorophenyl)borane [B(C₆F₅)₃] were mixed with 64.1 mg (0.1 mmol) of the metal complex 1 in a separate reaction vessel and stirred for 20 minutes.

Afterwards the resulting mixture was transferred into the polymerization reactor to start the polymerization reaction.

After 31 minutes the polymerization reaction was terminated as described above (see 2.1.1). At this point, the conversion level of the monomers into polybutadiene was 67.5%. 35.5 g of polymer were recovered as result of the stripping process. The polymer contained 63.0% cis-1,4-; 32.0% trans-1,4-, 5.0% 1,2-polybutadiene is according to ¹³C-NMR determination.

The molecular weight of the polymer amounted to 847,000 g/mol and the polydispersity (molecular weight distribution) amounted to 4.0. (Mₙ=212,000; M_{z}=1,947,000). The Mooney value amounted to 79.9.

D) Polymerization Using Metal Complex 1 in Combination with IBAO (Run 16)

The experiment was carried out according to the general polymerization procedure described above (2.1.1). The polymerization was carried out in 607.0 g of toluene solvent. Thus 500.5 g of toluene, 53.6 g (0.99 mol) of 1,3-butadiene monomer and isobutylalumoxane [IBAO] (4.5 g of a heptane solution containing 15.0 mmol of IBAO) were added into the polymerization reactor. 106.5 g of toluene and 4.5 g of a heptane solution containing 15.0 mmol of IBAO were mixed with 64.1 mg (0.1 mmol) of the metal complex 1 in a separate reaction vessel and stirred for one hour and 20 minutes.

Afterwards the resulting mixture was transferred into the polymerization reactor to start the polymerization reaction.

After 31 minutes the polymerization reaction was terminated as described above (see 2.1.1). At this point, the conversion level of the monomers into polybutadiene was 88.1%. 47.2 g of polymer were recovered as result of the stripping process. The polymer contained 78.0% cis-1,4-; 20.5% trans-1,4-, 1.5% 1,2-polybutadiene according to ¹³C-NMR determination.

The molecular weight of the polymer amounted to 633,000 g/mol and the polydispersity (molecular weight distribution) amounted to 5.55. (Mₙ=114,000; M_{z}=2,189000). The Mooney value amounted to 84.5.

E) Polymerization Using Metal Complex 1 and PMAO-IP and Diethylaluminum Chloride (See Run 4 Above)

F) Polymerization Using Metal Complex 1 and MMAO-IP and Diethylaluminum Chloride (See Run 5 Above)

### 3.1.5 COMPARATIVE EXAMPLES

### 3.1.5.1 Comparative Examples 1

### Homopolymerization of Butadiene Using Neodymium Versatate (Neo Cem 250)(C1/Run 17)

The experiment was carried out according to the general polymerization procedure described above (2.1.1). The polymerization was carried out in 506.2 g of cyclohexane solvent at 25° C. Thus 401.3 g of cyclohexane, 55.0 g (1.02 mol) of 1,3-butadiene monomer and MMAO (9.0 g of a heptane solution containing 23.1 mmol of MMAO-3a) were added into the polymerization reactor. 104.9 g of cyclohexane, 3.8 g (74 mmol) of 1,3-butadiene and 2.7 g of a heptane solution containing 6.9 mmol of MMAO were mixed with 660.0 mg of a mineral oil solution containing 0.549 mmol of the metal complex 10 in a separate reaction vessel and stirred for 10 minutes.

Afterwards the resulting mixture was transferred into the polymerization reactor to start the polymerization reaction.

After 1 hours and 30 minutes the polymerization reaction was terminated as described above (see 2.1.1). At this point, the conversion level of the monomers into polybutadiene was 12.3%. 7.2 g of polymer were recovered as result of the stripping process.

After 15 minutes the conversion level of the monomers into polybutadiene was 10.1% (polymerization activity: 0.045 kg [BR]/mmol [Cat] hr) and after 30 minutes 10.5% (0.02 kg [BR]/mmol [Cat] hr).

The polymer contained 90.3% cis-1,4-; 7.4% trans-1,4-, 2.3% 1,2-polybutadiene according to ¹³C-NMR determination.

The molecular weight of the polymer amounted to 132,500 g/mol and the polydispersity (molecular weight distribution) amounted to 3.78. (Mₙ=35,000; M_{z}=1,100,000).

### 3.1.5.2 Comparative Examples 2 (C2)

### Homopolymerization of Butadiene Using neodymium(III) Versatate (DE 197 46 266)

A 20 mL Schlenk vessel was feeded with 2 mmol of neodymium(III) versatate in 5.7 mL of n-hexane, 0.23 mL (2 mmol) of indene, 36.1 mL of a methylalumoxane (MAO) solution in toluene (1.66 M) and 5.33 g of 1,3-butadiene at a temperature of 25° C. Subsequently toluene was added to approach the total volume of 50 mL. The catalyst solution was stirred with an magnetic stirrer and the aging temperature of 50° C. was adjusted with an external bath. The aging time of the catalyst solution was chosen to be 1 hr in the case of example 5.

The polymerization was carried out in a 500 mL polymerization bottle with integrated septa. First 150 mL hexane were given into the bottle followed by 24.14 g of 1,3-butadiene and one tenth of the catalyst solution containing 0.2 mmol of neodymium metal (see above). The polymerization temperature of 60° C. was adjusted using a water bath for 3 hrs and 30 minutes. 21.04 g of polybutadiene were recovered which corresponds to a catalyst activity of 0.03 kg [polybutadiene]/mmol [Nd] [hr].

The polymer contained 40% cis-1,4-; 56% trans-1,4- and 4% 1,2-polybutadiene.

### 3.2 Polymerization of Isoprene

### 3.2.1 Polymerization of Isoprene Using Metal Complex 1 (Run 18)

The experiment was carried out according to the general polymerization procedure described above (2.1.1). The polymerization was carried out in 496.7 g of cyclohexane solvent. Thus, 360.0 g of cyclohexane, 68.1 g (1.0 mol) of isoprene monomer and MMAO (5.8 g of a heptane solution containing 15.0 mmol of MMAO) were added into the polymerization reactor. 136.7 g of cyclohexane and 5.8 g of a heptane solution containing 15.0 mmol of MMAO were mixed with 64.1 mg (0.1 mmol) of the metal complex 1 in a separate reaction vessel and stirred for 10 minutes.

Afterwards the resulting mixture was transferred into the polymerization reactor to start the polymerization reaction.

After 2 hours and 45 minutes the polymerization reaction was terminated as described above (see 2.1.1). At this point, the conversion level of the monomers into polyisoprene was 88.1%. 60.0 g of polymer were recovered as result of the stripping process.

The polymer contained according to ¹³C-NMR determination 95.0% cis-1,4-; 1.0% trans-1,4-, 4.0% 3,4- and no (below detection level) 1,2-polyisoprene.

The molecular weight of the polymer amounted to 232,000 g/mol and the polydispersity (molecular weight distribution) amounted to 2.61. (Mₙ=89,000; M_{z}=566,000). The glass transition temperature amounted to −64.2° C.

### 3.2.2 Polymerization of Isoprene Using Metal Complex 4 (Run 19)

The experiment was carried out according to the general polymerization procedure described above (2.1.1). The polymerization was carried out in 472.0 g of cyclohexane solvent. Thus 360.0 g of cyclohexane, 68.1 g (1.0 mol) of isoprene monomer and MMAO (17.4 g of a heptane solution containing 44.0 mmol of MMAO) were added into the polymerization reactor. 112.0 g of cyclohexane and 5.8 g of a heptane solution containing 15.0 mmol of MMAO were mixed with 95.8 mg (0.20 mmol) of the metal complex 4 in a separate reaction vessel and stirred for 10 minutes.

Afterwards the resulting mixture was transferred into the polymerization reactor to start the polymerization reaction.

After 3 hours and 30 minutes the polymerization reaction was terminated as described above (see 2.1.1). At this point, the conversion level of the monomers into polyisoprene was 8.4%. 5.7 g of polymer were recovered as result of the stripping process.

The molecular weight of the polymer amounted to 611,000 g/mol and the polydispersity (molecular weight distribution) amounted to 6.87. (Mₙ=89,000; M_{z}=2,067,000).

3.3 Polymerization activity - Comparison

| | Activity |
|---|---|
| Run | [kg {polymer}/mmol {Nd}[hr]] |
| 1 | 0.10* |
| 2 | 0.49** |
| 3 | 0.14** |
| 4 | 0.07* |
| 5 | 0.05(5)* |
| 6 | 0.25** |
| 7 | 0.02** |
| 8 | 1.35** |
| 9 | 0.03** |
| 10 | 0.11** |
| 11 | 0.14** |
| 12 | 0.17** |
| 13 | 1.44** |
| 14 | 1.02** |
| 15 | 0.74** |
| 16 | 1.24** |
| | (3.08 after 4 min) |
| 17/C1 | 0.04* |
| 18 | 0.48* |
| 19 | 0.03* |
| C2 | (0.03 after 3.5 hr's) |
| 20 | 0.28* |
| 21 | 0.32 |
| 22 | 1.1 |

C . . . comparative example;
*measured after 15 minutes;
**measured after 10 minutes;

3.4 Molecular weight - Comparison

| Run | Mw | Mn | Mz |
|---|---|---|---|
| 1 | 630,500 | 47,500 | 2,645,000 |
| 2 | 863,000 | 110,000 | 2,450,000 |
| 3 | 246,000 | 90,000 | 634,000 |
| 4 | 1,074,000 | 428,000 | 1,814,000 |
| 5 | 1,050,000 | 433,000 | 1,752,000 |
| 6 | 279,000 | 90,000 | 895,000 |
| 7 | 80,000 | 27,000 | 192,000 |
| 8 | 839,000 | 229,000 | 1,695,000 |
| 9 | 257,000 | 30,000 | 1,530,000 |
| 10 | 2,587,000 | 186,000 | 6,768,000 |
| 11 | 127,000 | 44,000 | 383,000 |
| 12 | 113,000 | 45,000 | 368,000 |
| 13 | 660,000 | 208,000 | 1,520,000 |
| 14 | 461,000 | 135,000 | 1,165,000 |
| 15 | 847,000 | 212,000 | 1,947,000 |
| 16 | 633,000 | 114,000 | 2,189,000 |
| 17/C1 | 132,500 | 35,000 | 1,100,000 |
| 18 | 232,000 | 89,000 | 566,000 |
| 19 | 611,000 | 89,000 | 2,067,000 |
| C2 | ? | ? | ? |
| 20 | 772,500 | 236,500 | 1,908,000 |
| 21 | 601,500 | 136,000 | 2,131,000 |
| 22 | 829,000 | 326,000 | 1,368,000 |

3.5 Molecular weight distribution (MWG) &
Mooney viscosity - Comparison

| Run | Mw/Mn | Mooney | Tg in ° C. |
|---|---|---|---|
| 1 | 13.25 | 35.9 | −106.9 |
| 2 | 7.85 | 81.2. | −106.9 |
| 3 | 2.73 | not det. | not det. |
| 4 | 2.51 | not det. | not det. |
| 5 | 2.42 | not det. | not det. |
| 6 | 3.1 | 33.2 | not det. |
| 7 | 2.96 | not det. | not det. |
| 8 | 3.66 | 89.7 | not det. |
| 9 | 8.57 | 53.7 | not det. |
| 10 | 13.9 | not det. | not det. |
| 11 | 2.89 | not det. | not det. |
| 12 | 2.51 | 2.6 | not det. |
| 13 | 3.2 | 59.6 | not det. |
| 14 | 3.41 | 64.9 | not det. |
| 15 | 4.0 | 79.9 | not det. |
| 16 | 5.55 | 84.5 | not det. |
| 17/C1 | 3.78 | ? | ? |
| 18 | 2.61 | not det. | −64.2 |
| 19 | 6.87 | not det. | not det. |
| C2 | ? | ? | ? |
| 20 | 3.27 | 115.5 | not det. |
| 21 | 4.42 | 53.4 | not det. |
| 22 | 2.54 | 120.4 | not det. |

3.6 Microstructure - Comparison

| | Cis-1,4- | Trans- | 1,2- |
|---|---|---|---|
| Run | PB | 1,4-PB | Polymer |
| 1 | 94.8 | 4.4 | 0.9 |
| 2 | 97.0 | 1.2 | 1.8 |
| 3 | 94.5 | 3.5 | 2.0 |
| 4 | 92.5 | 6.0 | 1.5 |
| 5 | 96.7 | 2.6 | 0.7 |
| 6 | 50.0 | 46.0 | 4.0 |
| 7 | 57.5 | 39.5 | 3.0 |
| 8 | 84.0 | 14.5 | 1.5 |
| 9 | 73.0 | 23.5 | 3.5 |
| 10 | 84.5 | 9.0 | 6.5 |
| 11 | 62.0 | 35.0 | 3.0 |
| 12 | 55.5 | 41.0 | 3.5 |
| 13 | 83.0 | 14.0 | 3.0 |
| 14 | 71.0 | 26.0 | 3.0 |
| 15 | 63.0 | 32.0 | 5.0 |
| 16 | 78.0 | 20.5 | 1.5 |
| 17/C1 | 90.3 | 7.4 | 2.3 |
| 18 | 95.0 | 1.0 | 4.0 |
| 19 | not det. | not det. | not det. |
| C2 | 40 | 56 | 4 |
| 20 | 97.3 | 1.4 | 1.3 |
| 21 | 94.0 | 3.0 | 3.0 |
| 22 | 95.7 | 3.6 | 0.7 |

### 4 Polymerization Using Supported Catalysts

### 4.1 Supporting Technique/Preparation of the Support Material

Different carrier materials such as activated carbon (Merck; catalog number 109624, activated coal for gas-chromatography, particle size 0.5-1.0 mm, surface area (BET) 900-1100 m²), expanded graphite (Sigma-Aldrich, catalog number 332461, 160-50 N, expanded magadiite (Arquad 2HAT [bis(hydrogenated tallowalkyl)dimethyl quaternary ammonium] expander), kieselguhr (Riedel-de Haen, catalog number 18514, calcined) in combination with MAO (Albemarle, 30 wt % in toluene) and silica supported MAO (Albemarle Europe SPSL, 13.39 wt % Al, Lot. Number 8531/099) were used to support neodymium complex 1.

The pore dry method described intensively in reference¹⁴ was applied to the preparation of the supported catalysts. Before supporting the MAO and metal complex 1 the carrier material was heated under vacuum to eliminate physically bonded water and to reduce the amount of chemically bonded water. Therefore, activated charcoal and expanded graphite were warmed up to 320° C. for 4 hrs, Magadiite was heated up to 320° C. for 6 hours to remove most of the bis(hydrogenated tallowalkyl)dimethyl quaternary ammonium expander and kieselguhr was exposed to a temperature ranging from 180° C. to 240° C. for 3 hrs. There was no additional treatment of the silica supported MAO from Albemarle.

### 4.2 Preparation of the Supported Catalysts

### 4.2.1 Preparation of the Activated Carbon/MAO/Neodymium Complex 1 Catalyst 1

2.5 g (22.0 mmol) triethylalumium were diluted in 40 mL of toluene and added to 10 g of activated carbon. The resulting suspension was shaken for one day and filtered. Subsequently the filter cake was dried under vacuum at 25° C. 10 g of MAO in toluene (13.64 wt % Al, 30.1 wt % MAO, 53.4 mmol MAO) were added to the free flowing solid and shaken for 12 hrs. Afterwards the solvent was removed under vacuum at 30° C. giving 13.1 g of activated carbon supported MAO. 100 μmol of 1 were dissolved in 1 mL of hexane and added to 6.55 g of activated carbon supported MAO. This suspension was shaken for 1 hr and afterwards dried under vacuum at 24° C.

4.6 g of the resulting activated carbon supported catalyst were used for the polymerization of about 1 mol of butadiene (see 1.5.1) at 80° C. Accordingly the catalyst consisted of 3.5 g of activated carbon, 1.09 g of MAO (18.75 mmol) and 70.2 μmol of 1.

### 4.2.2 Preparation of the Graphite/MAO/Neodymium Complex 1 Catalyst II

0.83 g (7.3 mmol) of triethylalumium were diluted in 40 mL of toluene and added to 1 g of expanded graphite. The resulting suspension was shaken for one day. Subsequently the suspension was dried under vacuum at 25° C. 2.06 g of MAO in toluene (13.64 wt % Al, 30.1 wt % MAO, 10.7 mmol MAO) were added to the free flowing solid and shaken for 12 hrs. Afterwards the solvent was removed under vacuum at 30° C. giving 2.45 g graphite supported MAO. Subsequently, 83 μmol of 1 dissolved in 1 mL of hexane were added. This suspension was shaken for 10 hrs and afterwards dried under vacuum at 24° C.

2.23 g of the resulting activated carbon supported catalyst were used for the polymerization of about 1 mol of butadiene (see 1.5.2) at 80° C. Accordingly the catalyst consisted of 0.91 g of activated carbon, 0.83 g (7.3 mmol) of triethylalumium 0.56 g (9.7 mmol) of MAO and 75.5 μmol of 1.

### 4.2.3 Preparation of the in Situ Prepared Graphite/MMAO/Neodymium Complex 1 Catalyst III

3 g of expanded graphite were suspended in 30 mL of trimethylsilyl chloride (Me₃SiCl). This suspension was warmed to 55° C. for 12 hrs and shaken for an additional 12 hrs. Subsequently, trimethylsilyl chloride was removed under vacuum at 50° C. The resulting inert graphite was added into the polymerization reactor together with 668 g of cyclohexane solvent, 30 mmol of MMAO, 100 μmol of 1 and about 1 mol of butadiene (see 1.5.3). The polymerization reaction was carried out at 80° C.

### 4.2.4 Preparation of the Magadiite/MMAO/Neodymium Complex 1 Catalyst IV

4 g of MAO in toluene (13.64 wt % Al, 30.1 wt % MAO, 21.4 mmol of MAO, 0.58 g of aluminum) were added to 1 g of magadiite and shaken for one day. Afterwards the solvent was removed under vacuum at 30° C. giving 2.24 g of magadiite supported MAO containing 25.8 wt % aluminum. 100 μmol of 1 were dissolved in 1 mL of hexane and added to the magadiite supported MAO. This suspension was shaken for 1 hr and afterwards dried under vacuum at 20° C. 5.26 g of the resulting magadiite supported catalyst were used for the polymerization of about 1 mol of butadiene (see 1.5.4) in cyclohexane at 80° C. Accordingly the catalyst consisted of 1 g of magadiite, 1.24 g of MAO (21.4 mmol) and 100 μmol of 1.

### 4.2.5 Preparation of the in Situ Prepared Magadiite/MMAO/Neodymium Complex 1 Catalyst V

4.56 g (40 mmol) triethylalumium were diluted in 20 mL of hexane and added to 3 g of magadiite. This suspension was shaken for one day and filtered. Subsequently, the filter cake was dried under vacuum at 25° C. The resulting inert magadiite was added into the polymerization reactor together with 608 g of cyclohexane solvent, 30 mmol of MMAO, 100 μmol of 1 and 1 mol of butadiene (see 1.5.5). The polymerization reaction was carried out at 80° C.

### 4.2.6 Preparation of the Silica/MAO/Neodymium Complex 1 Catalyst VI

The pore volume of 1 g of silica supported MAO containing 13.39 wt % aluminum amounts to 2 mL of hexane. Hence, 100 μmol of 1 dissolved in 2 mL of hexane were added to 1 g of silica supported MAO. The resulting suspension was shaken for 10 minutes. Afterwards the solvent was removed under vacuum at 25° C. The solid free flowing solid was suspended in 15 mL of hexane and then introduced into the polymerization reactor. The polymerization reaction was carried out at 80° C. using 1 mol of butadiene and 500.8 g of cyclohexane (see 1.5.6).

### 4.2.7 Preparation of the Kieselguhr/MAO/Neodymium Complex 1 Catalyst VII

20.34 g of MAO in toluene (13.64 wt % Al, 30.1 wt % MAO, 105 mmol of MAO, 2.85 g aluminum) were added to 9.86 g of kieselguhr and shaken for 16 hrs. Afterwards the solvent was removed under vacuum at 24° C. 50 mL of toluene were added to the kieselguhr supported MAO and shaken for 1 hr. Subsequently, this suspension was filtered and washed twice with 50 mL of toluene. The filtrate was dried for 1 hr at 120° C. Then 100 μmol of 1 in 2.4 mL of hexane were added to the kieselguhr supported MAO and shaken for 1 hr. The suspension was dried under vacuum at 20° C.

The resulting kieselguhr supported catalyst were used for the polymerization of about 1 mol of butadiene in cyclohexane at 80° C. (see 1.5.7).

### 4.3 Polymerization

### 4.3.1 Description of the Polymerization Procedure

### 4.3.1.1 In Situ Catalyst Formation

The polymerizations were performed in a double wall 2 L steel reactor, which was purged with nitrogen before the addition of organic solvent, metal complex, activator(s) or other components. The following components were added in the following order: cyclohexane, the MMAO activator, followed by inert carrier material and butadiene. The polymerization reactor was tempered to 80° C. This mixture was allowed to stir for 30 minutes.

In a separate 200 mL double wall steel reactor, which was tempered to 70° C., the following components were added in the following order: cyclohexane and neodymium complex 1. The resulting mixture was allowed to stir for ten minutes.

The polymerization was started through addition of the contents of the 200 mL steel reactor into the 2 L polymerization vessel. The polymerization was performed at 80° C. The polymerization time varied depending on the experiment.

For the termination of the polymerization process, the polymer solution was transferred into a third double wall steel reactor containing 50 mL of methanol solution. The methanol solution contained Jonol as stabilizer for the polymer (1 L of methanol contains 2 g of Jonol). This mixture was stirred for 15 minutes. The recovered polymer was then stripped with steam for 1 hour to remove solvent and other volatiles and dried in an oven at 45° C. for 24 hours.

### 4.3.1.2 Support/Alumoxane/1 as Catalyst

The polymerization reactions were performed in a double wall 2 L steel reactor, which was purged with nitrogen before the addition of organic solvent, supported catalyst or other components. The following components were added in the following order: cyclohexane, the support/alumoxane/1 catalyst and butadiene. The polymerization started immediately. The reactor temperature increased from 25° C. to 80° C. within 10 minutes. The polymerization time varied depending on the experiment.

For the termination of the polymerization process, the polymer solution was transferred into a third double wall steel reactor containing 50 mL of methanol solution. The methanol solution contained Jonol as stabilizer for the polymer (1 L of methanol contains 2 g of Jonol). This mixture was stirred for 15 minutes. The recovered polymer was then stripped with steam for 1 hour to remove solvent and other volatiles and dried in an oven at 45° C. for 24 hours.

### 4.4 Polymerization Reactions

### 4.4.1 Polymerization of Butadiene Using Catalyst 1

The experiment was carried out according to the general polymerization procedure described above in 4.3.1.2. The polymerization was carried out using 512.2 g of cyclohexane solvent, 54.7 g (1.01 mol) of 1,3-butadiene and 4.6 g of catalyst 1 (see 4.2.1).

After 33 minutes the polymerization reaction was terminated as described above (see 4.3.1.2). At this point, the conversion level of the monomers into copolymer was 98.4%. 53.8 g of polybutadiene were recovered as a result of the stripping process.

The polybutadiene contained according to ¹³C-NMR determination 96.0% cis-1,4-; 3.0% trans-1,4- and 1.0% 1,2-polybutadiene.

The glass transition temperature amounts to −106.3° C.

The molecular weight of the polymer amounts to 940,000 g/mol, the polydispersity (molecular weight distribution) amounts to 3.58. (Mₙ=262,500; M_{z}=1,782,000) and the Mooney value to 78.5.

### 4.4.2 Polymerization of Butadiene Using Catalyst II

The experiment was carried out according to the general polymerization procedure described above in 4.3.1.2. The polymerization was carried out using 507.0 g of cyclohexane solvent, 53.5 g (0.99 mol) of 1,3-butadiene and 2.23 g of catalyst II (see 4.2.2).

After 45 minutes the polymerization reaction was terminated as described above (see 4.3.1.2). At this point, the conversion level of the monomers into copolymer was 98.3%. 52.6 g of polybutadiene were recovered as a result of the stripping process.

The polybutadiene contained according to ¹³C-NMR determination 72.5% cis-1,4-; 24.5% trans-1,4- and 3.0% 1,2-polybutadiene.

The glass transition temperature amounts to −106.0° C.

The molecular weight of the polymer amounts to 339,000 g/mol, the polydispersity (molecular weight distribution) amounts to 4.98. (Mₙ=68,000; M_{z}=1,450,000) and the Mooney value to 16.7.

### 4.4.3 Polymerization of Butadiene Using Catalyst III

The experiment was carried out according to the general polymerization procedure described above in 4.3.1.1. The polymerization was carried out using 668 g of cyclohexane solvent, 61.1 g (1.13 mol) of 1,3-butadiene and of catalyst III (see 4.2.3).

Therefore, 550 g of cyclohexane, the inert graphite, 1,3-butadiene and MMAO (5.8 g of a heptane solution containing 15 mmol of MMAO) were added into the polymerization reactor. 118 g of cyclohexane and 2.9 g of a heptane solution containing 7.5 mmol of MMAO were mixed with 64 mg (0.1 mmol) of the metal complex 1 in a separate reaction vessel and stirred for 10 minutes. Afterwards the resulting mixture was transferred into the polymerization reactor to start the polymerization reaction.

After 15 minutes the polymerization reaction was terminated as described above (see 4.3.1.1). At this point, the conversion level of the monomers into copolymer was 99.4%. 60.9 g of polybutadiene were recovered as a result of the stripping process.

The polybutadiene contained according to ¹³C-NMR determination 95.0% cis-1,4-; 4.0% trans-1,4- and 1.0% 1,2-polybutadiene.

The glass transition temperature amounts to −106.0° C.

The molecular weight of the polymer amounts to 492,000 g/mol, the polydispersity (molecular weight distribution) amounts to 3.46. (Mₙ=142,000; M_{z}=1,150,000) and the Mooney value to 34.6.

### 4.4.4 Polymerization of Butadiene Using Catalyst IV

The experiment was carried out according to the general polymerization procedure described above in 4.3.1.2. The polymerization was carried out using 628.0 g of cyclohexane solvent, 53.8 g (0,99 mol) of 1,3-butadiene and 5.26 g of catalyst IV (see 4.2.4).

After 30 minutes the polymerization reaction was terminated as described above (see 4.3.1.2). At this point, the conversion level of the monomers into copolymer was 81.4%. 43.8 g of polybutadiene were recovered as a result of the stripping process.

The polybutadiene contained according to ¹³C-NMR determination 93.0% cis-1,4-; 4.5% trans-1,4- and 2.5% 1,2-polybutadiene.

The glass transition temperature amounts to −105.7° C.

The molecular weight of the polymer amounts to 1,010,000 g/mol, the polydispersity (molecular weight distribution) amounts to 3.52. (Mₙ=287,000; M_{z}=1,970,000) and the Mooney value to 89.1.

### 4.4.5 Polymerization of Butadiene Using Catalyst V

The experiment was carried out according to the general polymerization procedure described above in 4.3.1.1. The polymerization was carried out using 608.3 g of cyclohexane solvent, 54.4 g (1.01 mol) of 1,3-butadiene and the complete amount of catalyst V prepared according to paragraph 4.2.5.

Therefore, 510 g of cyclohexane, the inert magadiite (see 4.2.5), 1,3-butadiene and MMAO (5.8 g of a heptane solution containing 15 mmol of MMAO) were added into the polymerization reactor. 91.7 g of cyclohexane and 2.9 g of a heptane solution containing 7.5 mmol MMAO were mixed with 64 mg (0.1 mmol) of the metal complex 1 in a separate reaction vessel and stirred for 10 minutes.

Afterwards the resulting mixture was transferred into the polymerization reactor to start the polymerization reaction.

After 15 minutes the polymerization reaction was terminated as described above (see 4.3.1.1). At this point, the conversion level of the monomers into copolymer was 99.9%. 54.3 g of polybutadiene were recovered as a result of the stripping process.

The polybutadiene contained according to ¹³C-NMR determination 86.0% cis-1,4-; 12.5% trans-1,4- and 1.5% 1,2-polybutadiene.

The glass transition temperature amounts to −107.3° C.

The molecular weight of the polymer amounts to 414,000 g/mol, the polydispersity (molecular weight distribution) amounts to 5.59. (Mₙ=2,117,000; M_{z}=1,150,000) and the Mooney value to 37.2.

### 4.4.6 Polymerization of Butadiene Using Catalyst VI

The experiment was carried out according to the general polymerization procedure described above in 4.3.1.2. The polymerization was carried out using 500.8 g of cyclohexane solvent, 53.6 g (0.99 mol) of 1,3-butadiene and 1.0 g of catalyst VI (see 4.2.6).

After 40 minutes the polymerization reaction was terminated as described above (see 4.3.1.2). At this point, the conversion level of the monomers into copolymer was 6.6%. 3.6 g of polybutadiene were recovered as a result of the stripping process.

The polybutadiene contained according to ¹³C-NMR determination 845% cis-1,4-; 7.5% trans-1,4- and 5.5% 1,2-polybutadiene.

The molecular weight of the polymer amounts to 558,000 g/mol and the polydispersity (molecular weight distribution) amounts to 2.05. (Mₙ=272,000; M_{z}=1,395,000).

### 4.4.7 Polymerization of Butadiene Using Catalyst VII

The experiment was carried out according to the general polymerization procedure described above in 4.3.1.2. The polymerization was carried out using 503.0 g of cyclohexane solvent, 54.0 g (1,0 mol) of 1,3-butadiene and the complete amount of catalyst VII prepared according to paragraph 4.2.6.

After 60 minutes the polymerization reaction was terminated as described above (see 4.3.1.2). At this point, the conversion level of the monomers into copolymer was 4.4%. 2.4 g of polybutadiene were recovered as a result of the stripping process.

### 4.5 Comparative Example

### Homopolymerization of Butadiene Using Metal Complex 1

The experiment was carried out according to the general polymerization procedure described above (2.1.1). The polymerization was carried out in 500.5 g of cyclohexane solvent. Therefore, 400.5 g of cylohexane, 54.3 g (1.0 mol) of 1,3-butadiene monomer and MMAO (2.9 g of a heptane solution containing 7.5 mmol of MMAO) were added into the polymerization reactor. 102 g of cyclohexane and 2.9 g of a heptane solution containing 7.5 mmol of MMAO was mixed with 320 mg (0.5 mmol) of the metal complex 1 in a separate reaction vessel and stirred for 10 is minutes.

Afterwards the resulting mixture was transferred into the polymerization reactor to start the polymerization reaction.

After 0.5 hours the polymerization reaction was terminated as described above (see 2.2.1). At this point, the conversion level of the monomers into copolymer was 98.7%. 53.6 g of polymer were recovered as a result of the stripping process.

The polymer contained according to ¹³C-NMR determination 78.7% cis-1,4-; 16.7% trans-1,4-, 4.0% 1,2-polybutadiene.

The molecular weight of the polymer amounts to 551,500 g/mol and the polydispersity (molecular weight distribution) amounts to 3.98. (Mₙ=138,500; M_{z}=1,384,000).

The glass transition temperature amounts to −108.6° C.

### 5 Polymerization Examples Using Transition Metal Halide Compounds

### 5.1 Polymerization of 1,3-Butadiene

A) Polymerization Using Metal Complex 1 and MMAO-3a and Titanium Dichloride Lithium Chloride Adduct [TiCl₂*2 LiCl] (Run 23)

The experiment was carried out according to the general polymerization procedure described above (2.1.1). The polymerization was carried out in 570 g of cyclohexane solvent at 80° C. Thus 499 g of cyclohexane, 54.3 g (1.0 mol) of 1,3-butadiene monomer and MMAO (5.8 g of a heptane solution containing 15 mmol of MMAO) were added into the polymerization reactor. 71 g of cyclohexane, 5.8 g of a heptane solution containing 15 mmol of MMAO and 10.2 mg (0.05 mmol) of titanium dichloride lithium chloride adduct [TiCl₂*2 LiCl] were stirred for 30 minutes and subsequently mixed with 64 mg (0.10 mmol) of the metal complex 1 in a separate reaction vessel and stirred for 38 minutes.

After 5 minutes the conversion level of the monomers into polybutadiene was 69.5% (polymerization activity: 4.5 kg [BR]/mmol [Cat] hr), after 10 minutes 81.2% (2.6 kg [BR]/mmol [Cat] hr), after 15 minutes 83.6% (1.8 kg [BR]/mmol [Cat] hr) and after 20 minutes 96.1% % (1.55 kg [BR]/mmol [Cat] hr).

Afterwards the resulting mixture was transferred into the polymerization reactor to start the polymerization reaction.

After 22 minutes the polymerization reaction was terminated as described above (see 2.1.1). At this point, the conversion level of the monomers into polybutadiene was 98.1%. 53.2 g of polymer were recovered as result of the stripping process. The polymer contained 95.0% cis-1,4-; 4.0% trans-1,4-, 1.0% 1,2-polybutadiene according to ¹³C-NMR determination.

The molecular weight of the polymer amounted to 360,000 g/mol and the polydispersity (molecular weight distribution) amounted to 3.14. (Mₙ=114,500; M_{z}=890,000). The Mooney value amounted to 39.2.

B) Polymerization Using Metal Complex 1 and MMAO-3a and Titanium Dichloride Lithium Chloride Adduct [TiCl₂*2 LiCl] (Run 24)

The experiment was carried out according to the general polymerization procedure described above (2.1.1). The polymerization was carried out in 4570 g of cyclohexane solvent at 80° C. in a 10 L polymerization reactor. Thus 4501 g of cyclohexane, 432.8 g (8.0 mol) of 1,3-butadiene monomer and MMAO (46.9 g of a heptane solution containing 120 mmol of MMAO) were added into the polymerization reactor. 69 g of cyclohexane, 46.9 g of a heptane solution containing 120 mmol of MMAO and 81.6 mg (0.40 mmol) of titanium dichloride lithium chloride adduct [TiCl₂*2 LiCl] were stirred for 30 minutes and subsequently mixed with 496 mg (0.80 mmol) of the metal complex 1 in a separate reaction vessel and stirred for 38 minutes.

After 10 minutes the conversion level of the monomers into polybutadiene was 71.4% (polymerization activity: 2.32 kg [BR]/mmol [Cat] hr), after 20 minutes 92.0% (1.49 kg [BR]/mmol [Cat] hr), after 30 minutes 94.3% (1.02 kg [BR]/mmol [Cat] hr) and after 40 minutes 97.0% % (0.79 kg [BR]/mmol [Cat] hr).

Afterwards the resulting mixture was transferred into the polymerization reactor to start the polymerization reaction. After 45 minutes the polymerization reaction was terminated as described above (see 2.1.1). At this point, the conversion level of the monomers into polybutadiene was 98.1%. 424.0 g of polymer were recovered as result of the stripping process. The polymer contained 76.5% cis-1,4-; 20.5% trans-1,4-, 3.0% 1,2-polybutadiene according to ¹³C-NMR determination.

The molecular weight of the polymer amounted to 195,000 g/mol and the polydispersity (molecular weight distribution) amounted to 2.34. (Mₙ=83,000; M_{z}=500,000). The Mooney value amounted to 15.4.

### C) Comparative Example

### Polymerization Using Metal Complex 1 and MMAO-3a (C3/Run 2; see Chapter 3.1.1 Section B))

After 10 minutes the conversion level of the monomers into polybutadiene was 150% (polymerization activity: 0.49 kg [BR]/mmol [Cat] hr), after 20 minutes 21.1% (0.34 kg [BR]/mmol [Cat] hr), after 30 minutes 27.7% (0.30 kg [BR]/mmol [Cat] hr) and after 45 minutes 31.6% % (0.23 kg [BR]/mmol [Cat] hr).

After 1 hours and 20 minutes the polymerization reaction was terminated as described above (see 2.1.1). At this point, the conversion level of the monomers into polybutadiene was 47.6%. 25.7 g of polymer were recovered as result of the stripping process.

### D) Comparative Example 3

### Homopolymerization of Butadiene Using Neodymium Versatate 10 (Neo Cem 250)(C1/Run 17; see 3.1.5.1)

After 15 minutes the conversion level of the monomers into polybutadiene was 10.1% (polymerization activity: 0.045 kg [BR]/mmol [Cat] hr) and after 30 minutes 10.5% (0.02 kg [BR]/mmol [Cat] hr).

After 1 hours and 30 minutes the polymerization reaction was terminated as described above (see 2.1.1). At this point, the conversion level of the monomers into polybutadiene was 12.3%. 7.2 g of polymer were recovered as result of the stripping process.

### E) Comparative Example

### (C2): Homopolymerization of Butadiene Using Neodymium(III) Versatate (DE 197 46 266); see Chapter 3.1.5.2

21.04 g of polybutadiene were recovered which corresponds to a catalyst activity of 0.03 kg [polybutadiene]/mmol [Nd] [hr].

5.2 Polymerization activity - Comparison

| | Activity |
|---|---|
| Run | [kg {polymer}/mmol {Nd}[hr]] |
| 23 | 2.2** |
| 24 | 1.9 |
| 2/C3 | 0.49** |
| 17/C1 | 0.04* |
| C2 | (0.03 after 3.5 hrs) |

C . . . comparative example;
*measured after 15 minutes;
**measured after 10 minutes;

5.3 Molecular weight - Comparison

| Run | Mw | Mn | Mz |
|---|---|---|---|
| 23 | 360,000 | 114,500 | 890,000 |
| 24 | 195,000 | 83,000 | 500,000 |
| 2/C3 | 863,000 | 110,000 | 2,450,000 |
| 17/C1 | 132,500 | 35,000 | 1,100,000 |
| C2 | ** | ** | ** |

5.4 Molecular weight distribution (MWG) &
Mooney viscosity - Comparison

| Run | Mw/Mn | Mooney | Tg in ° C. |
|---|---|---|---|
| 23 | 3.14 | 39.2 | −106.4 |
| 24 | 2.34 | 15.4 | not det. |
| 2/C3 | 7.85 | not det. | −106.9 |
| 17/C1 | 3.78 | * | * |
| C2 | ** | ** | ** |

* values not determind;
** values not given in patent DE 197 46 266

5.5 Microstructure - Comparison

| | Cis-1,4- | Trans- | 1,2- |
|---|---|---|---|
| Run | PB | 1,4-PB | Polymer |
| 23 | 95.0 | 4.0 | 1.0 |
| 24 | 76.5 | 20.5 | 3.0 |
| 2/C3 | 97.0 | 1.2 | 1.8 |
| 17/C1 | 90.3 | 7.4 | 2.3 |
| C2 | 40 | 56 | 4 |

An advantage of the supported or unsupported metal catalysts of the invention, which are the result of a defined combination of the metal complex with an activator compound and optionally a transition metal halide compound component and optionally a catalyst modifier and optionally a support material is the production of tailor-made polymers. In particular, the choice of the activator, the choice and the amount of the optional transition metal component, the choice and the amount of the optional catalyst modifier, the choice of the optional support material and the choice of the metal complex and also the manner of preparation of supported and unsupported catalyst, as well as the solvent used for the polymerization reaction (nonaromatic or aromatic), the concentration of the diene and the polymerization temperature enable an adjustment of the polymer microstructure (ratio of cis-, trans- and vinyl content) and of the molecular weight of the resulting polydiene using a given metal complex. In a non-limiting example, the microstructure can be regulated in a wide range just by exchanging activator compounds or by the use of a suitable activator mixture without the need to exchange the metal complex component. For example 96.7% cis-1,4-polybutadiene was recovered (Run 5) when metal complex 1 was used in combination with MMAO and diethylaluminum chloride or 57.5% trans-1,4-polybutadiene was obtained when metal complex 1 was used in combination with tris(pentafluorophenyl)boran and trioctylaluminum (Run 7) and the average molecular weight amounted to 1,074,000 (Run 4) when metal complex 1 was combined with PMAO-IP while the average molecular weight amounted to 461,000 (Run 14) when metal complex 1 was combined with MMAO-3a and [CPh₃][B(C₆F₅)₄].

Another advantage of the invention is that the microstructure and also the molecular weight of the polybutadiene can be regulated in a wide range just by exchanging the metal complex component without the need to exchange the activator compound. In a non-limiting example 94.8% cis-1,4-polybutadiene was recovered (Run 1) when metal complex 4 was used in combination with MMAO or 41.0% trans-1,4-polybutadiene were obtained when metal complex 7 was used in combination with tris(pentafluorophenyl)borane and MMAO (Run 12) and the average molecular weight amounted to 2,587,000 (Run 10) when metal complex 9 was combined with PMAO-IP while the average molecular weight amounted to 257,000 (run 9) when metal complex 5 was combined with MMAO-3a. The suitable combination of both the metal complex and the activator therefore leads to desired or tailor-made polymers. As result of the invention a wide range of polymers can be produced.

Another advantage of the invention for diene polymerization reactions is that the use of the optional transition metal halide compound component according to the invention can favorably influence the polymer properties such as the molecular weight and Mooney viscosity. In an non-limiting example the molecular weight and the Mooney viscosity of the resulting polybutadiene is much reduced in comparison with the polybutadiene which is formed using a catalyst without an additional transition metal halide compound. In particular, polymers with Mooney viscosities lower than 60 can be processed much more easily than polymers in the high Mooney range (Mooney values higher than 60). In a non-limiting example the combination of Nd{N[Si(Me)₃]₂}₃, a titanium compound prepared from TiC₄ and two equivalents of n-butyllithium in toluene and MMAO-3a gives high-cis polybutadiene with an average molecular weight of about 360,000 g/mol and a Mooney value of 39.2 (see Run 23). In comparison, the combination of Nd{N[Si(Me)₃]₂}₃ and MMAO-3a (same amounts and reaction conditions as in the aforementioned reaction) gives polybutadiene with an average molecular weight of about 863,000 g/mol and an Mooney value of 81.2 (see C3/Run 2).

Another advantage of the invention is that the molecular weight can be regulated in a wide range just by exchanging or modifying carrier materials without the need to exchange the metal complex component. Therefore, a wide range of polymers with desired properties can be produced with a single metal complex.

Though a few patents describe supported catalysts for diene polymerization, the support material was limited to silica. Accordingly, it was not noticed for diene polymerization before that not only does the choice of the support material but also the manner of preparation of the support catalyst have a strong influence on polymer properties such as the molecular weight which represents another advantage of the invention. In a non-limiting example clay supported catalysts, such as Magadiite supported catalysts, and also charcoal (activated carbon) supported catalysts give polydienes with a rather high molecular weight and high cis-contents, while graphite supported catalysts give rather low molecular weights and, depending of the preparation of the supported catalyst, variable cis-contents. This difference becomes very obvious, when the microstructure of polymers made with catalysts comprising different support materials but the same metal complex component is compared with the microstructure of polymers made with the unsupported homologue.

A further advantage of the invention is that different types of supported catalysts lead to different microstructures and molecular weights of the obtained polydienes than can be obtained with the unsupported homologues. Therefore, the range of possible polymer microstructures and polymer molecular weights is widened. Supported catalysts such as, but not limited to, magadiite, activated carbon and graphite supported catalysts can lead to a considerably increased cis-1,4 content of higher than 90% of the obtained polybutadiene rubber when compared to their unsupported homologues. The use of supported catalysts such as, but not limited to, magadiite and activated carbon supported catalysts led to considerably increased average molecular weights of the polybutdienes of for example but not limited to more than 800,000 g/mol. The use of other supported catalysts such as, but not limited to, graphite supported catalysts can result in lower molecular weights such as but not limited to 339,000 g/mol and also lower Mooney values such as but not limited to 16.7 when compared with their unsupported homologues.

Another advantage of the invention for diene polymerization reactions is that the manner of preparation of the catalyst (e.g. order of addition of the catalyst components and catalyst aging) can favorably influence the polymer properties such as the molecular weight.

A further advantage of the invention is greatly increased catalytic activity towards polymerization. Some of the neodymium-based catalysts of the invention demonstrated below give activities about ten times higher than the classical neodymium carboxylate-based catalysts (see 3.3 Polymerization activity—Comparison Examples, especially Runs 17/C1 and C2 in comparison with other experiments). Additionally, the use of the transition metal halide compound component leads to a further enhancement of the polymerization activity (see 4.2 Polymerization activity—Run 2/C3 in comparison with Runs 23 and 24). The polymerization activity can be as high as for example but not limited to 32 kg polybutadiene per gram of neodymium per hour when a titanium chloride component was used as polymerization accelerator (measurement of the polymerization activity was done after 5 minutes; after this time high butadiene conversions such as, but not limited to, 70% may be achieved (see Run 23).

A further advantage of the invention is that the catalyst precursors according to the invention can be stored at room temperature or even at elevated temperatures such as, for example, but not limited to, 50° C. in the solid state for days. In addition, the catalyst solution also can be stored at room temperature at least for hours.

A further advantage of the invention is that the catalysts of the invention often do not require a separate aging step (see Runs 10, 11 and 12) and if it is desirable to employ an optional aging step, it advantageously does not require long aging times. Therefore, it is possible to start the polymerization reaction just by adding the catalyst components in the desired order into the polymerization reactor. The polymerization can be started for example either by addition of the catalyst precursor as the last component (see Runs 10, 11 and 12) or by the addition of butadiene as the last component. If an optional aging step is incorporated into the catalyst preparation/polymerization procedure, the aging time is short, such as, but not limited to, 30 (see Run 20) minutes, 20 minutes (see Run 14 or 15) or 10 minutes (see Run 9 or 13) and can be performed in a broad temperature range, such as, but not limited to, 0° C. to 150° C. with high catalyst activity. The temperature ranges of the catalyst aging and polymerization are independently selected and is between −50° C. and +250° C., preferably between −5 and +160° C., more preferably between 10° C. and 110° C. For example the catalyst activity of polymerization Run 16 (polymerization temperature 80° C., aging temperature 80° C.) amounts to 3.08 kg polybutadiene per mmol neodymium per hour. A Further advantage of the invention is that aging the catalyst does not require extreme temperatures. It is beneficial that the polymerization reaction can be induced without or without substantial waiting period (delay) upon addition of the last catalyst component into the polymerization reactor.

The catalysts according to the invention can be used for solution polymerization processes, slurry polymerization processes and also for gas phase polymerization using the appropriate techniques such as, but not limited to, spray techniques. Especially in the case of a gas phase polymerization in a typical gas phase polymerisation reactor, reaction solvent can be avoided, thus saving energy costs to remove organic solvents after termination of the polymerization process.

1. Metal complex catalyst compositions comprising
a) at least one metal complex according to formula I) or formula II)
b) at least one activator compound
c) optionally a transition metal halide compound component
d) optionally a catalyst modifier
e) optionally one (or more) inorganic or polymeric support material(s)
in which formulae I) and II) of compound a) are
MR′ₐ[N(R¹R²)]_{b}[P(R³R⁴)]_{c}(OR⁵)_{d}(SR⁶)ₑX_{f}[(R⁷N)₂Z]_{g}[(R⁸P)₂Z₁]ₕ[(R⁹N)Z₂(PR¹⁰)]ₗ[ER″ₚ]_{q}[(R¹³N)Z₂(NR¹⁴R¹⁵)]ᵣ[(R¹⁶P)Z₂(PR¹⁷R¹⁸)]ₛ[(R¹⁹N)Z₂(PR²⁰R²¹)]ₜ[(R²²P)Z₂(NR²³R²⁴)]ᵤ[(NR²⁵R²⁶)Z₂(CR²⁷R²⁸)]ᵥ I)
M′_{z}{MR′ₐ[N(R¹R²)]_{b}[P(R³R⁴)]_{c}(OR⁵)_{d}(SR⁶)ₑX_{f}[(R⁷N)₂Z]_{g}[(R⁸P)₂Z₁]ₕ[(R⁹N)Z₂(PR¹⁰)]ₗ[ER″ₚ]_{q}[(R¹³N)Z₂(NR¹⁴R¹⁵)]ᵣ[(R¹⁶P)Z₂(PR¹⁷R¹⁸)]ₛ[(R¹⁹N)Z₂(PR²⁰R²¹)]ₜ[(R²²P)Z₂(NR²³R²⁴)]ᵤ[(CR²⁷R²⁸)Z₂(NR²⁵R²⁶)]ᵥ}_{w}X_{y,} II)
wherein
M is a lanthanide or vanadium;
Z, Z₁, and Z₂ are divalent bridging groups joining two groups each of which comprise P or N, wherein Z, Z₁, and Z₂ independently selected are (CR¹¹₂)ⱼ or (SiR¹²₂)ₖ. or (CR²⁹₂)ₗO(CR³⁰₂)ₘ or (SiR³¹₂)ₙO(SiR³²₂)ₒ or a 1,2-disubstituted aromatic ring system wherein R¹¹, R¹², R²⁹, R³⁰, R³¹ and R³² independently selected are hydrogen, or are a group having from 1 to 80 nonhydrogen atoms which is hydrocarbyl, halo-substituted hydrocarbyl or hydrocarbylsilyl;
R′, R¹, R², R³, R⁴, R⁵, R⁶, R⁷, R⁸, R⁹, R¹⁰, R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸ independently selected are all R groups and are hydrogen, or are a group having from 1 to 80 nonhydrogen atoms which is hydrocarbyl, halo-substituted hydrocarbyl, hydrocarbylsilyl or hydrocarbylstannyl;
[ER″ₚ] is a neutral Lewis base ligating compound wherein
E is oxygen, sulfur, nitrogen, or phosphorus;
R″ is hydrogen, or is a group having from 1 to 80 nonhydrogen atoms which is hydrocarbyl, halo-substituted hydrocarbyl or hydrocarbylsilyl;
p is 2 if E is oxygen or sulfur; and p is 3 if E is nitrogen or phosphorus;
q is a number from zero to six;
X is halide (fluoride, chloride, bromide, or iodide);
M′ is a metal from Group 1 or 2;
N, P, O, S are elements from the Periodic Table of the Elements;
b, c are zero, 1, 2, 3, 4, 5 or 6;
a, d, e, f are zero, 1 or 2;
g, h, i, r, s, t, u, v are zero, 1, 2 or 3;
j, k, l, m, n, o are 1 or 2;
w, y, z are numbers from 1 to 1000;
the sum of a+b+c+d+e+f+g+h+i+r+s+t+u+v is less than or equal to 6 and the the sum of a+b+c+d+e+g+h+i+r+s+t+u+v is 3, 4 or 5;
the oxidation state of the metal atom M is 0 to +6; and
the metal complex may contain no more than one type of ligand selected from the following group: R′, (OR5), and X and may not contain an allyl, benzyl or carboxylate ligand and
the at least one activator compound b) is selected from:
1) a fluorinated or perfluorinated tri(aryl)boron or -aluminum compound chosen from tris(pentafluorophenyl)boron, tris(pentafluorophenyl)-aluminum, tris(o-nonafluorobiphenyl)boron, tris(o-nonafluorobiphenyl)-aluminum, tris[3,5-bis(trifluoromethyl)phenyl]boron, and tris[3,5-bis(trifluoromethyl)phenyl]aluminum; 2) polymeric alumoxanes; 3) oligomeric alumoxanes; and 4) nonpolymeric, compatible, noncoordinating, ion-forming compounds (including the use of such compounds under oxidizing conditions).

2. The metal catalyst compositions according to claim 1, wherein the at least one activator compound comprises a nonpolymeric compatible, noncoordinating, ion-forming compound which is an ammonium-, a phosphonium-, an oxonium-, a carbonium-, a silylium-, a sulfonium-, or a ferrocenium-salt of a compatible, noncoordinating anion.

3. The metal catalyst compositions according to claim 1, wherein the activator compound b) comprises a nonpolymeric, compatible, noncoordinating, ion-forming compound selected from the group consisting of an activator compound:
(A) represented by the following general formula:
(L*−H)_{d}⁺A^{d-} or
(B) which is a salt of a cationic oxidizing agent and a noncoordinating, compatible anion represented by the formula:
(Ox^{e+})_{d}(A^{d-})ₑ, or
(C) which is a salt of a silylium ion and a noncoordinating, compatible anion represented by the formula:
R₃Si⁺A⁻
wherein:
L* is a neutral Lewis base;
(L*−H)⁺ is a Bronsted acid;
Ox^{e+} is a cationic oxidizing agent having a charge of e+;
d is an integer from 1 to 3;
e is an integer from 1 to 3;
A^{d-} is a noncoordinating, compatible anion having a charge of d−R is C₁₋₁₀ hydrocarbyl; and
A− is a noncoordinating, compatible anion having a charge of −1; and combinations of the foregoing activating compounds.

4. The metal catalyst compositions according to claim 1, wherein the metal complex according formulas I) and II) contains one of the following metal atoms: lanthanide metal.

5. The metal catalyst compositions according to claim 4, wherein the metal complex according formulas I) and II) contains neodymium.

6. The metal catalyst compositions according to claim 1, wherein only one of a, b, c, d, e, g, h, i, r, s, t, u, v is not equal to zero and R¹ is identical to R²; R³ is identical to R⁴; R¹⁴ is identical to R¹⁵; R²⁵ is identical to R²⁶; R²⁷ is identical to R²⁸.

7. The metal catalyst compositions according to claim 1, wherein the metal complex is one of the following:
Nd[N(R)₂]₃; Nd[P(R)₂]₃; Nd[(OR)₂(NR₂)]; Nd[(SR)₂(NR₂)]; Nd[(OR)₂(PR₂)]; Nd[(SR)₂(PR₂)]; Nd[(RN)₂Z]X; Nd[(RP)₂Z]X; Nd[(RN)Z(PR)]X; M′{Nd[(RN)₂Z]₂}; M′{Nd[(RP)₂Z]₂}; M′{Nd[(RN)Z(PR)]₂}; M′₂{NdR₂X₂}X; M′₂{Nd[N(R)₂]_{b}X₁}X; M′₂{Nd[P(R)₂]_{c}X_{f}}X; M′₂{Nd[(RN)₂Z]X_{f}}X; M′₂{Nd[(RP)₂Z]X_{f}}X; M′₂{Nd[(RN)Z(PR)]X_{f}}X; M′₂{Nd[(RN)₂Z]₂}X; M′₂{Nd[(RP)₂Z]₂}X; M′₂{Nd[(RN)Z(PR)]₂}X, Nd[(RN)Z(NR¹⁴₂)]₃; Nd[(RP)Z(PR¹⁷₂)]₃; Nd[(RN)Z(PR²⁰₂)]₃; Nd[(RP)Z(NR²³₂)]₃; Nd[(CR²⁷₂)Z(NR₂)]₃,
wherein
Z is (CR₂)₂, (SiR₂)₂, (CR₂)O(CR₂), (SiR₂)O(SiR₂) or a 1,2-disubstituted aromatic ring system; R, R¹⁴, R¹⁷, R²⁰, R²³, R²⁷ independently selected is hydrogen, alkyl, benzyl, aryl, silyl, stannyl; X is fluoride, chloride or bromide; b, c, is 1 or 2; f is 1 or 2; M′ is Li, Na, K and wherein M, R, X, Z, are as previously defined.

8. The metal catalyst compositions according to claim 1, wherein the metal complex is one of the following:
Nd[N(SiMe₃)₂]₃, Nd[P(SiMe₃)₂]₃, Nd[N(SiMe₂Ph)₂]₃, Nd[P(SiMe₂Ph)₂]₃, Nd[N(Ph)₂]₃, Nd[P(Ph)₂]₃, Nd[N(SiMe₃)₂]₂F, Nd[N(SiMe₃)₂]₂Cl, Nd[N(SiMe₃)₂]₂Cl(THF)ₙ, Nd[N(SiMe₃)₂]₂Br, Nd[P(SiMe₃)₂]₂F, Nd[P(SiMe₃)₂]₂Cl, Nd[P(SiMe₃)₂]₂Br, {Li{Nd[N(SiMe₃)₂]Cl₂}Cl}ₙ, {Li{Nd[N(SiMe₃)₂]Cl₂}Cl(THF)ₙ}ₙ, {Na{Nd[N(SiMe₃)₂]Cl₂}Cl}ₙ, {K{Nd[SiMe₃)₂]Cl₂}Cl}ₙ, {Mg{{Nd[N(SiMe₃)₂]Cl₂}Cl}₂}ₙ, {Li{Nd[P(SiMe₃)₂]Cl₂}Cl}ₙ, {Na {Nd[P(SiMe₃)₂]Cl₂}Cl}ₙ, {K{Nd[P(SiMe₃)₂]Cl₂}Cl}ₙ, {Mg{{Nd[P(SiMe₃)₂]Cl₂}Cl}₂}ₙ, {K₂{Nd[PhN(CH₂)₂NPh]Cl₂}Cl}ₙ, {K₂{Nd[PhN(CH₂)₂NPh]Cl₂}Cl (O(CH₂CH₃)₂)ₙ}ₙ, {Mg{Nd[PhN(CH₂)₂NPh]Cl₂}Cl}ₙ, {Li₂{Nd[PhN(CH₂)₂NPh]Cl₂}Cl}ₙ, {Na₂{Nd[PhN(CH₂)₂NPh]Cl₂}Cl}ₙ, {Na₂{Nd[PhN(CH₂)₂NPh]Cl₂}Cl(NMe₃)ₙ}ₙ, {Na₂{Nd[Me₃SiN(CH₂)₂NSiMe₃]Cl₂}Cl}ₙ, {K₂{Nd[Me₃SiN(CH₂)₂NSiMe₃]Cl₂}Cl}ₙ, {Mg{Nd[Me₃SiN(CH₂)₂NSiMe₃]Cl₂}Cl}ₙ, {Li₂{Nd[Me₃SiN(CH₂)₂NSiMe₃]Cl₂}Cl}, {K₂{Nd[PhP(CH₂)₂PPh]Cl₂}Cl}ₙ, {Mg{Nd[PhP(CH₂)₂PPh]Cl₂}Cl}ₙ, {Li₂{Nd[PhP(CH₂)₂PPh]Cl₂}Cl}_{n,}. {Na₂{Nd[PhP(CH₂)₂PPh]Cl₂}Cl}ₙ, {Na₂{Nd[Me₃SiP(CH₂)₂PSiMe₃]Cl₂}Cl}ₙ, {K₂{Nd[Me₃SiP(CH₂)₂P SiMe₃]Cl₂}Cl}ₙ, {Mg{Nd[Me₃SiP(CH₂)₂PSiMe₃]Cl₂}Cl}ₙ, {Li₂{Nd[Me₃Si P(CH₂)₂P SiMe₃]Cl₂}Cl}ₙ, Nd[N(Ph)₂]₂F, Nd[N(Ph)₂]₂Cl, Nd[N(Ph)₂]₂Cl(THF)ₙ, Nd[N(Ph)₂]₂Br, Nd[P(Ph)₂]₂F, Nd[P(Ph)₂]₂Cl, Nd[P(Ph)₂]₂Br, {Li{Nd[N(Ph)₂]Cl₂}Cl}ₙ, {Na{Nd[N(Ph)₂]Cl₂}Cl}ₙ, {K{Nd[N(Ph)₂]Cl₂}Cl}ₙ, {Mg{{Nd[N(Ph)₂]Cl₂}Cl}₂}ₙ, {Li{Nd[P(Ph)₂]Cl₂}Cl}ₙ, {Na{Nd[P(Ph)₂]Cl₂}Cl}ₙ, {K{Nd[P(Ph)₂]Cl₂}Cl}ₙ, {Mg{{Nd[P(Ph)₂]Cl₂}Cl}₂}ₙ, {K₂(Nd[PhN(Si(CH₃)₂)₂NPh]Cl₂}Cl}ₙ, {Mg{Nd[PhN(Si(CH₃)₂)₂NPh]Cl₂}Cl}ₙ, {Li₂{Nd[PhN(Si(CH₃)₂)₂NPh]Cl₂}Cl}ₙ, {Na₂{Nd[PhN(Si(CH₃)₂)₂NPh]Cl₂}Cl}ₙ, {Na₂{Nd[Me₃SiN(Si(CH₃)₂)₂NSiMe₃]Cl₂}Cl}ₙ, {K₂{Nd[Me₃SiN(Si(CH₃)₂)₂NSiMe₃]Cl₂}Cl}ₙ, {Mg{Nd[Me₃SiN(Si(CH₃)₂)₂NSiMe₃]Cl₂}Cl}ₙ, {Li₂{Nd[Me₃SiN(Si(CH₃)₂)₂NSiMe₃]Cl₂}Cl}, {K₂{Nd[PhP(Si(CH₃)₂)₂PPh]Cl₂}Cl}ₙ, {Mg{Nd[PhP(Si(CH₃)₂)₂PPh]Cl₂}Cl}ₙ, {Li₂ {Nd[PhP(Si(CH₃)₂)₂PPh]Cl₂}Cl}ₙ, {Na₂{Nd[PhP(Si(CH₃)₂)₂PPh]Cl₂}Cl}ₙ, K₂{Nd[PhN(CH₂)₂NPh]₂}Cl; Na₂{Nd[PhN(CH₂)₂NPh]₂}Cl; Li₂{Nd[PhN(CH₂)₂NPh]₂}Cl; K₂{Nd[((CH₃)₃Si)N(CH₂)₂N(Si(CH₃)₃)]₂}Cl; Na₂{Nd[((CH₃)₃Si)N(CH₂)₂N(Si(CH₃)₃)]₂}Cl; Li₂{Nd[((CH₃)₃Si)N(CH₂)₂N(Si(CH₃)₃)]₂}Cl; K₂{Nd[PhN(Si(CH₃)₂)₂NPh]₂}Cl; Na₂{Nd[PhN(Si(CH₃)₂)₂NPh]₂}Cl; Li₂{Nd[PhN(Si(CH₃)₂)₂NPh]₂}Cl; K₂{Nd[((CH₃)₃Si)N(Si(CH₃)₂)₂N(Si(CH₃)₃)]₂}Cl; Na₂{Nd[((CH₃)₃Si)N(Si(CH₃)₂)₂N(Si(CH₃)₃)]₂}Cl; Li₂(Nd[((CH₃)₃Si)N(Si(CH₃)₂)₂N(Si(CH₃)₃)]₂}Cl; K₂{Nd[PhP(CH₂)₂PPh]₂}Cl; Na₂{Nd[PhP(CH₂)₂PPh]₂}Cl; Li₂{Nd[PhP(CH₂)₂PPh]₂}Cl; K₂{Nd[((CH₃)₃Si)P(CH₂)₂P(Si(CH₃)₃)]₂}Cl; Na₂{Nd[((CH₃)₃Si)P(CH₂)₂P(Si(CH₃)₃)]₂}Cl; Li₂{Nd[((CH₃)₃i)P(CH₂)₂P(Si(CH₃)₃)]₂}Cl; K₂{Nd[PhP(Si(CH₃)₂)PPh]₂}Cl; Na₂{Nd[PhP(Si(CH₃)₂)PPh]₂}Cl; Li₂{Nd[PhP(Si(CH₃)₂)PPh]₂}Cl; K₂{Nd[((CH₃)₃Si)P(Si(CH₃)₂)₂P(Si(CH₃)₃)]₂}Cl; Na₂{Nd[((CH₃)₃Si)P(Si(CH₃)₂)P(Si(CH₃)₃)]₂}Cl; Li₂{Nd[((CH₃)₃Si)P(Si(CH₃)₂)P(Si(CH₃)₃)]₂}Cl; Nd[((CH₃)N)(CH₂)₂(N(CH₃)₂)]₃; Nd[(PhN)(CH₂)₂(N(CH₃)₂)]₃; Nd[((CH₃)N)(CH₂)₂(N(CH₃)(Ph))₃; Nd[((CH₃)N)(CH₂)₂(N(Ph)₂)]₃; Nd[((CH₃CH₂)N)(CH₂)₂(N(CH₃)₂)]₃; Nd[((CH₃CH₂)N)(CH₂)₂(N(CH₃)(Ph))]₃; Nd[((CH₃CH₂)N)(CH₂)₂(N(Ph)₂)]₃; Nd[((CH₃)P)(CH₂)₂(P(CH₃)₂)]₃; Nd[(PhP)(CH₂)₂(P(CH₃)₂)]₃; Nd[((CH₃)P)(CH₂)₂(P(CH₃)(Ph))]₃; Nd[((CH₃)P)(CH₂)₂(P(Ph)₂)]₃; Nd[((CH₃CH₂)P)(CH₂)₂(P(CH₃)₂)]₃; Nd[((CH₃CH₂)P)(CH₂)₂(P(CH₃)(Ph))]₃; Nd[((CH₃CH₂)P)(CH₂)₂(P(Ph)₂)]₃; Nd[2-((CH₃)₂N)(C₆H₄)-1-(CH₂)]₃, Nd[2-((CH₃CH₂)₂N)(C₆H₄)-1-(CH₂)]₃, Nd[2-((CH₃)₂CH)₂N)(C₆H₄)-1-(CH₂)]₃, Nd[(2-Ph₂N)(C₆H₄)-1-(CH₂)]₃, Nd[2-((CH₃))N(C₆H₄)1-1(CH₂)]₃, Nd[2-(((CH₃)(CH₂)₁₇)(CH₃)N)(C₆H₄)-1-(CH₂)]₃, Nd[2-((CH₃)₂N)-3-((CH₃)(CH₂)₁₇)(C₆H₄)-1-(CH₂)]₃, Nd[2-((CH₃)₂N)-4-((CH₃)(CH₂)₁₇)(C₆H₄)-1-(CH₂)]₃, 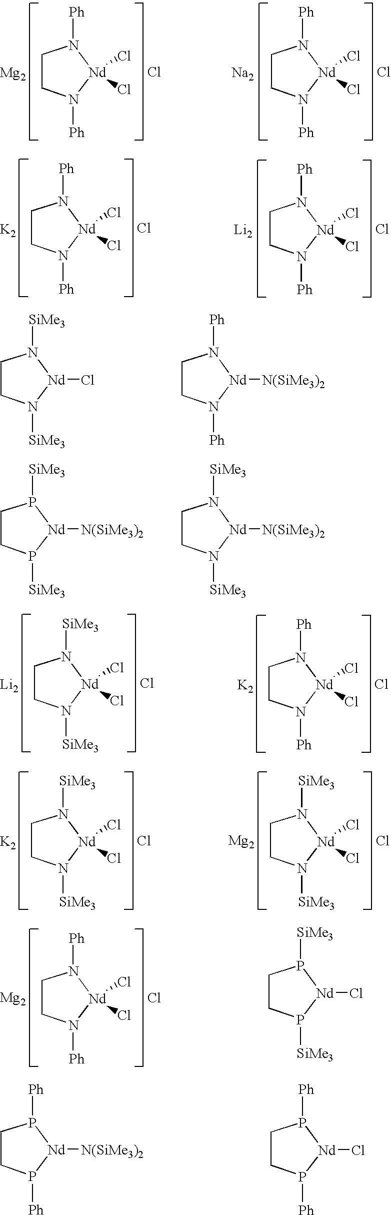
wherein
(C₆H₄) is an 1,2-substituted aromatic ring and Me is methyl, Ph is phenyl, THF is tetrahydrofuran and n is a number from 1 to 1000.

9. The metal catalyst compositions according to claim 1, wherein the metal complex results from the reaction of neodymium trichloride, neodymium trichloride dimethoxyethane adduct, neodymium trichloride triethylamine adduct or neodymium trichloride tetrahydrofuran adduct with one of the following metal compounds:
Na₂[PhN(CH₂)₂NPh], Li₂[PhN(CH₂)₂NPh], K₂[PhN(CH₂)₂NPh], Na₂[PhP(CH₂)₂PPh], Li₂[PhP(CH₂)₂PPh], K₂[PhP(CH₂)₂PPh], Mg[PhN(CH₂)₂NPh], (MgCl)₂[PhN(CH₂)₂NPh], Mg[PhP(CH₂)₂PPh]Na₂[PhN(CMe₂)₂NPh], Li₂[PhN(CMe₂)₂NPh], K₂[PhN(CMe₂)₂NPh], Na₂[PhP(CMe₂)₂PPh], Li₂[PhP(CMe₂)₂PPh], K₂[PhP(CMe₂)₂PPh], Mg[PhN(CMe₂)₂NPh], (MgCl)₂[PhN(CMe₂)₂NPh], Mg[PhP(CMe₂)₂PPh]Na₂[Me₃SiN(CH₂)₂NSiMe₃], Li₂[Me₃SiN(CH₂)₂NSiMe₃], K₂[Me₃SiN(CH₂)₂NSiMe₃], Mg[Me₃SiN(CH₂)₂NSiMe₃], (MgCl)₂[Me₃SiN(CH₂)₂NSiMe₃], Na₂[Me₃SiP(CH₂)₂PSiMe₃], Li₂[Me₃SiP(CH₂)₂PSiMe₃], K₂[Me₃SiP(CH₂)₂PSiMe₃], Mg[Me₃SiP(CH₂)₂PSiMe₃], (MgCl)₂[Me₃SiP(CH₂)₂PSiMe₃]Na₂[Me₃SiN(CMe₂)₂NSiMe₃], Li₂[Me₃SiN(CMe₂)₂NSiMe₃], K₂[Me₃SiN(CMe₂)₂NSiMe₃], Mg[Me₃SiN(CMe₂)₂NSiMe₃], (MgCl)₂[Me₃SiN(CMe₂)₂NSiMe₃]Na₂[Me₃SiP(CMe₂)₂PSiMe₃], Li₂[Me₃SiP(CMe₂)₂PSiMe₃], K₂[Me₃SiP(CMe₂)₂PSiMe₃], Mg[Me₃SiP(CMe₂)₂PSiMe₃], (MgCl)₂[Me₃SiP(CMe₂)₂PSiMe₃], Li[2-((CH₃)₂N)(C₆H₄)-1-(CH₂)], Li[2-((CH₃CH₂)₂N)(C₆H₄)-1-(CH₂)], Li[2-((CH₃)₂CH)₂N)(C₆H₄)-1-(CH₂)], Li[2-(Ph₂N)(C₆H₄)-1-(CH₂)], Li[2-((CH₃))N(C₆H₄)-1-(CH₂)], Li[2-(((CH₃)(CH₂)₁₇)(CH₃)N)(C₆H₄)-1-(CH₂)], Li[2-((CH₃)₂N)-3-((CH₃)(CH₂)₁₇)(C₆H₄)-1-(CH₂)]₃ᵢ, Li[2-((CH₃)₂N)-4-((CH₃)(CH₂)₁₇)(C₆H₄)-1-(CH₂)], MgCl[2-((CH₃)₂N)(C₆H₄)-1-(CH₂)], MgCl[2-((CH₃CH₂)₂N)(C₆H₄)-1-(CH₂)], MgCl[2-((CH₃)₂CH)₂N)(C₆H₄)-1-(CH₂)], MgCl[2-(Ph₂N)(C₆H₄)-1-(CH₂)], MgCl[₂-((CH₃))N(C₆H₄)-1-(CH₂)], MgCl[₂-(((CH₃)(CH₂)₁₇)(CH₃)N)(C₆H₄)-1-(CH₂)], MgCl[2-((CH₃)₂N)-3-((CH₃)(CH₂)₁₇)(C₆H₄)-1-(CH₂)]₃ᵢ, MgCl[₂-((CH₃)₂N)-4-((CH₃)(CH₂)₁₇)(C₆H₄)-1-(CH₂)].

10. The metal catalyst compositions according to claim 1, wherein the activator compound comprises a methylalumoxane (MAO), or a triisobutyl aluminum-modified methylalumoxane, or isobutylalumoxane.

11. The metal catalyst compositions according to claim 3, wherein the activator compound is represented by the following general formula:
(L*−H)_{d}⁺A^{d-}
wherein A^{d-} corresponds to the formula:
[M*Q₄]
wherein M* is boron or aluminum in the +3 formal oxidation state; and Q is a hydrocarbyl-, hydrocarbyloxy-, fluorinated hydrocarbyl-, fluorinated hydrocarbyloxy-, or fluorinated silylhydrocarbyl-group of up to 20 nonhydrogen atoms, with the proviso that in not more than one occasion is Q hydrocarbyl or
the activator compound is represented by a salt of a cationic oxidizing agent and a noncoordinating, compatible anion represented by the formula:
(Ox^{e+})_{d}(A^{d-})ₑ,
wherein Ox^{e+}, d, and e are the same as defined in claim 2 and A^{d-} is tetrakis (pentafluorophenyl)borate.

12. The metal catalyst according to claim 11, wherein each occurrence of Q is a fluorinated aryl group.

13. The metal catalyst compositions according claim 1, wherein the transition metal halide compound component c) is present and contains a metal atom of group 3 to 10, a lanthanide metal or an actinide metal connected to one to six halide atoms chosen from the group comprising fluorine, chlorine, bromine or iodine atoms.

14. The metal catalyst compositions according to claim 13, wherein the transition metal halide compound component c) is one of the following, ScCl₃, TiCl₂, TiCl₃, TiCl₄, TiCl₂*2 LiCl, ZrCl₂, ZrCl₂*2 LiCl, ZrCl₄, VCl₃, VCl₅, CrCl₂, CrCl₃, CrCl₅ and CrCl₆.

15. The metal catalyst compositions according claim 13, wherein the transition metal halide compound component c) is a compound resulting from a reaction of a Lewis base with one of ScCl₃, TiCl₂, TiCl₃, TiCl₄, TiCl₂*2 LiCl ZrCl, ZrCl₂*2 LiCl, ZrCl₄, VCl₃, VCl₅, CrCl₂, CrCl₃, CrCl₅ and CrCl₆.

16. The metal catalyst compositions according to claim 15, wherein the Lewis base is one of n-butyllithium, t-butyllithium, methyllithium, diethylmagnesium or ethylmagnesium halide.

17. The metal catalyst compositions according to claim 1, wherein the optional catalyst modifier d) is present and is a neutral Lewis acid chosen from C₁₋₃₀ hydrocarbyl substituted Group 13 compounds or a halogenated (including perhalogenated) derivative thereof.

18. The metal catalyst compositions according to claim 17, wherein catalyst modifier d) is selected from (hydrocarbyl)aluminum compounds and halogenated (including perhalogenated) derivatives thereof having from 1 to 20 carbons in each hydrocarbyl or halogenated hydrocarbyl group, wherein the (hydrocarbyl)aluminum compounds are selected from trialkyl aluminum compounds and alkyl aluminum hydrides.

19. The metal catalyst compositions according to claim 17, wherein the activator compound b) is a halogenated tri(hydrocarbyl)boron compound having from 1 to 20 carbons in each hydrocarbyl group and the catalyst modifier d) is a trialkyl aluminum compound having from 1 to 4 carbons in each alkyl group.

20. The metal catalyst compositions according to claim 1, wherein the support material e) is present and is clay, silica, charcoal, graphite, expanded clay, expanded graphite, carbon black, layered silicates or alumina.

21. A process to produce polydienes from a diolefin monomer characterized in that the production of polydienes is carried out using a metal catalyst composition according to claim 1.

22. The process to produce polydienes according to claim 21, wherein the molar ratio of activator compound b) relative to the metal center in metal complex a) is in a range of from 11:10 to 5000:1.

23. The process to produce polydienes according to claim 21, wherein a molar ratio of transition metal halide compound component c) relative to the metal center in metal complex a) is in a range of from 1:100 to 1,000:1.

24. The process to produce polydienes according to claim 21, wherein the diolefin monomer is selected from the group consisting of 1,3-butadiene, isoprene (2-methyl-1,3-butadiene), 2,3-dimethyl-1,3-butadiene, 1,3-pentadiene, 2,4-hexadiene, 1,3-hexadiene, 1,3-heptadiene, 1,3-octadiene, 2-methyl-2,4-pentadiene, cyclopentadiene, 2,4-hexadiene, 1,3-cyclooctadiene, norbornadiene.

25. The process to produce polydienes according to claim 24, wherein the ratio of the metal complex to the support material e) is in a range of from about 0.5 to about 100,000.
